(19) United States
(12) Patent Application Publication
(10) Pub. No.: US 2007/0097959 A1
(43) Pub. Date: May 3, 2007

(54) ADAPTIVE INFORMATION NETWORK

(76) Inventor: Stephen F. Taylor, Virginia Beach, VA (US)

Correspondence Address: STRATEGIC PATENTS P.C.., C/O PORTFOLIOIP, P.O. BOX 52050, MINNEAPOLIS, MN, 55402, US

(21) Appl. No.: 11/470,244

(22) Filed: Sep. 5, 2006

Related U.S. Application Data
(60) Provisional application No. 60/714,102, filed on Sep. 2, 2005.
(60) Provisional application No. 60/726,726, filed on Oct. 14, 2005.
(60) Provisional application No. 60/730,229, filed on Oct. 25, 2005.
(60) Provisional application No. 60/733,962, filed on Nov. 4, 2005.
(60) Provisional application No. 60/733,961, filed on Nov. 4, 2005.

(51) Int. Cl. H04L 12/66

(52) U.S. Cl. 370/352

(57) ABSTRACT

Provided herein are methods and systems for improved participation in and monetization of an information network such as a network for distributing, selling, and/or sharing a content library such as a plurality of media files.

### RELATED APPLICATION

This application claims the benefit of the following commonly owned U.S. Provisional Applications, each of which is incorporated herein by reference in its entirety: U.S. App. No. 60/714,102 filed on Sep. 2, 2005; U.S. App. No. 60/726,726 filed on Oct. 14, 2005; U.S. app. No. 60/730,229 filed on Oct. 25, 2005; U.S. App. No. 60/733,961 filed on Nov. 4, 2005; and U.S. App. No. 60/733,962 filed on Nov. 4, 2005.

### BACKGROUND

Numerous platforms have emerged for manipulating information and content in a global network such as the Internet or World Wide Web. These platforms address various aspects of network usage such as search, file sharing, and social networking. However, a need exists for an improved network platform that enhances user participation in an information network such as a network for sharing licensed and unlicensed media.

### SUMMARY

Provided herein are methods and systems for improved participation in and monetization of an information network such as a network for distributing, selling, and/or sharing a content library such as a plurality of media files.

In one aspect a system disclosed herein includes a plurality of clients interconnected in a peer-to-peer network; a plurality of files distributed among the plurality of clients, each file including one or more trading rules, an encrypted version of an audio segment, and a degraded quality, unencrypted version of the audio segment; and a server coordinating operation of the peer-to-peer network, the server responding to a purchase request for a selected audio segment from one of the clients by analyzing the one or more trading rules associated with the selected audio segment, determining a payment, processing the payment from the one of the clients, and providing a certificate to the one of the clients for rendering the selected audio segment.

The trading rules for each file specify a duration of use of the associated audio segment, the certificate limiting rendering of the audio segment to the duration.

In another aspect, a method disclosed herein includes providing a peer-to-peer media content user interface wherein a user may search for media content associated with a peer-to-peer network; and presenting, in the same peer-to-peer media content user interface, results retrieved from an Internet search engine, wherein the Internet search engine results are based on the user's interactions with the peer-to-peer media content user interface.

In another aspect, an adaptive information network as disclosed herein may be deployed as a data network interconnecting a plurality of nodes, at least two of the plurality of nodes including a client device operated by a user having a profile. The system may include a content library including a plurality of files, the content library residing on one or more of the nodes, the plurality of files including one or more of a sampler file comprising one or more trading rules, an encrypted version of a first audio segment, and a degraded quality, unencrypted version of the first audio segment, a purchase-only track comprising an encrypted version of a second audio segment and a free sample of the second audio segment, a try-before-you buy sampler file, a Sampler file, a limited functionality file, a degraded quality file, a file having an associated transactional rule, and a media file.

The system may include a classification scheme derived from at least one of a functional characteristic, an audio characteristic, a visual characteristic, and an objective characteristic of each one of the plurality of files, or from a knowledge representation scheme.

The system may include a subnetting infrastructure supported by at least one server coupled to the data network for addressing a subset of the plurality of nodes as a neighborhood, each neighborhood including a plurality of the client devices, and each neighborhood characterized by a metaprofile of the plurality of client devices.

The system may include a taste infrastructure supported by at least one server coupled to the data network for interrelating one or more of metaprofiles, profiles, and files according to one or more of the classification scheme, attributes of content of the files, user file consumption patterns, user searches, user file acquisition, user membership in neighborhoods, and explicit user input.

The system may include a search infrastructure supported by at least one server coupled to the data network for providing at least one search result in response to a search request from one of the client devices, the search infrastructure supporting at least one of a peer search, a web search, and an explore mode, the peer search initiating a local search at one or more of the plurality of nodes according to one or more attributes of audio content including at least one of a musical feature setting, an editorial setting, and a seed track of audio content for comparison to local content using the taste infrastructure, and the web search forwarding one or more search parameters to a search service that augments data in the search request and returns the search request to the client in a form for presentation to one or more commercial search engines, the explore mode for locating one or more additional files according to a peer search seeded with the at least one result.

The system may include a rights management infrastructure supported by at least one server coupled to the data network, the rights management infrastructure providing one or more of a certificate system for controlling rendering of one or more of the plurality of files including decryption of encrypted content, a rights management integration system for providing additional rights management functions to one or more third-party rights management systems that deliver files through the rights management infrastructure; a fingerprinting technology for providing unique fingerprints for one or more of the plurality of files according to one or more characteristics of the files and for identifying files according to a fingerprint associated therewith, a payment system for executing financial transactions associated with access to one or more of the files, a customer tracking system for tracking consumption behavior of the one or more client devices, and a network activity monitoring system for monitoring one or more of acquisition of files, use of files, and search for files.

The data network may include a media network for communicating content.

The data network may include a mobile network for communicating.

The data network may include a peer-to-peer network.

Each node may operate in one or more of a peer-to-peer mode in which it interacts with other like enabled modes, a hybrid mode in which it interacts with other nodes that are at least one of partially enabled and disabled, and a stand-alone mode in which the node is disconnected from other nodes.

Each node may operate in one or more of a node-specific mode related exclusively to that node, a node-relational mode related to at least one other one of the nodes, and a network control mode in which the node operates in a client-server relationship with at least one other one of the nodes.

The plurality of nodes may be self-organizing according to at least one of the taste infrastructure and the classification scheme.

The subnetting infrastructure may dynamically restructures the neighborhoods.

The nodes may adapt behavior according to one or more of user profiles and metaprofiles.

Each node may operate in one or more of an enabled mode, a disabled mode, a non-enabled mode, and a partially enabled mode.

One or more nodes may operate to attract one or more of the plurality of files according to at least one of the subnetting infrastructure and the taste infrastructure.

One of the plurality of nodes may communicate with one or more other ones of the plurality of nodes through one or more of a fixed layer and an adaptive layer, the adaptive layer including a process that is modified according to one or more of the taste infrastructure or the subnetting infrastructure.

The explore mode may be automatically invoked in response to one or more of playing a content object, viewing a content object, entering a query, searching a library of content objects, viewing a playlist of content objects, and viewing a set of search results.

In various embodiments, each aspect of the systems described above may be deployed as a method of performing steps associated with the aspect, or a computer program product for performing steps associated with the aspect.

### BRIEF DESCRIPTION OF FIGURES

The systems and methods described herein may be understood by reference to the following figures:

FIG. 1 shows the “Fixed and Adaptive” Layers of the Network;

FIG. 2 shows the Nodes within the Network as they may function as either Client or Server and shows how the Adaptive Elements may be integrated.

FIG. 3 shows the relationship between methods that may operate within the Node-Specific, Node-Relational and Network Control Levels within the Network.

FIG. 4 shows how processes that may reside on two or more Nodes may operate as a single process within the Network—these are termed “shared’ processes”.

FIG. 5 shows how data indexing techniques may operate as shared processes.

FIG. 6 shows how distributed data may be operated upon using shared indexing techniques.

FIG. 7 shows how Nodes may interoperate with Data referenced by shared indexing techniques.

FIG. 8 shows how such techniques create, within the Network, a global database.

FIG. 9 shows how methods within the Network may interact with a global database.

FIG. 10 shows how the Network may subsume Data Objects with the Layers.

FIG. 11 shows how the Network may subsume Data Objects within Levels.

FIG. 12 shows how methods operate within Layers and levels.

FIG. 13 shows the elements of the Data Object Set.

FIG. 14 shows the elements Network Object set.

FIG. 15 shows how the elements within the data Object and network Objects sets may be interconnected within the Network.

FIG. 16 shows an example implementation of how Data Objects may be assigned indices.

FIG. 17 shows an example implementation of how Attribute Matrices associated with Data objects may be generated.

FIG. 18 shows how indices related to Data Objects may be correlated with associated Attribute Matrices.

FIG. 19 shows one example implementation of Attribute Matrix derivation.

FIG. 20 shows an example implementation of “chained” Attribute Matrix derivation.

FIG. 21 shows an example implementation of how diverse Data objects and Activities may contribute to the creation of Attribute Matrices.

FIG. 22 shows an example implementation of how Attribute matrices derived from music files may be derived.

FIG. 23 shows how Attribute Matrices may be used to correlate and and/or group Data Objects.

FIG. 25 shows how one or more processes within the Network that may be related to information control and which may adapt and evolve may be instantiate within Nodes.

FIG. 26 shows an example implementation wherein one or more Nodes may search or acquire Data objects based on the associated Attribute Files.

FIG. 27 shows an example implementation of context-based and profile web search.

FIG. 28 shows an example implementation of context and profile based information flow.

FIG. 29 shows an example implementation of the graphical presentation of web search related information.

FIG. 30 shows an example implementation of the graphical presentation of web search related information that may change as the Nodal activity changes.

FIG. 31 shows how objective criteria may contribute to the creation of Adaptive elements in the network.

FIG. 32 shows how the flow of Data Objects to and from Nodes may be executed based on the Normative Relational Matrices for those objects.

FIG. 33 shows how Normative Relational Matrices may associated with Data Objects by means of indices.

FIG. 34 an example implementation of the derivation of Normative Relational Matrices.

FIG. 35 shows an example implementation of the derivation of Meta-Profiles based on Normative Relational Matrices.

FIG. 36 shows an example implementation of the derivation of Neighborhood sub-nets based on the Meta-Profiles based on Normative Relational Matrices.

FIG. 37 shows an example implementation of how information with a network may be controlled based on the derivation of 3 Neighborhood sub-nets.

FIG. 38 shows elements that may be included in a “Taste Channel”.

### DETAILED DESCRIPTION

While the invention is described in connection with certain preferred embodiments, other embodiments will be readily appreciated by one of ordinary skill in the art and all such embodiments are intended to fall within the scope of this disclosure.

The term “Network” (when used in the form of a proper noun) may be used hereafter to encompass the hybrid adaptive/non-Adaptive functionality described in this document. In the present invention, Network(s) may be understood to embrace one or more “Nodes” where a Node may be a memory-enabled digital computing device. As noted below, in the Network, Nodes may function as Clients and/or as Servers and/or as both (variously and/or at any time, depending on the context and requirements of particular implementations).

The term “Data” and/or “Data Objects” (when used in the form of a proper noun) may hereafter encompass (but may not be limited to) discrete Data Objects which may reside in a discrete whole or in sections in one or more physical locations and/or which may reside as a discrete whole and/or in sections in one or more logical locations—but such that this Data may be located within a Node within the Network and/or may (in part and/or in whole) may exist in devices outside the Network.

Such Data Objects may include (but may not be limited to) data that composes and/or represents media content, and/or data that may be used to compose and/or to derive one or more variable(s) and/or may be used to compose and/or derive one or more parameter(s) which may be used by processes and/or software programs within the Network.

“Data” may also include and/or may encompass indices that may reference other Data and/or users and/or computational Nodes and/or groups of Nodes, and/or may encompass indices that may be related to processes and/or representation of events (which events may be either internal and/or external to the Network and where “events” may include input from users and/or groups of users and/or sequences of user inputs and/or sequences of inputs from groups of users, where such sequences may be sequential and/or which may be discontinuous in time and/or in location), and/or may refer to any entity related to and/or which may be used by any element in the Network which may be used to execute a computation and/or process.

Note that the terms “method” and “process” (used interchangeably without loss of generality) may be understood to encompass (but may not be limited to) software programs and/or sections of such programs where such programs and/or sections of programs may be embedded in one or more computing device or platform (“Nodes”) and/or where such programs and/or sections of programs may be embedded in one or more computing device or platform such that these sections may be distributed among one or more such platforms (“Nodes”) such that all of part of those sections may be executed discretely and/or in concert, variously and at any time. Note also that the term “Component” (when used in the form of a proper noun) may refer to one of more such methods and/or processes.

Note further that the terms “Layer(s)” and Level(s)” are used to convey a descriptive and/or modeled distinction and may not imply a functional and/or physical and/or logical distinction. Thus, for example, in the following descriptions of the present invention, a function may be described as belonging to and/or as being modeled within a certain Level and/or within a certain Layer, but this should not be understood as a “black box” separation as one would see in certain environments, such as the OSI communication structure wherein (for instance) the elements that compose the Data Link Layer are functionally separate from and do not directly interact with those subsumed in the Presentation Layer (where the latter resides several Layers higher in that model). Rather, a function may cooperate variously with functions associated with other layers, or within the same layer, or some combination of these, or may operate as a stand alone functional unit.

Note also that in the context of the present invention, the term “Network” may additionally apply whenever any and/or all of the Components associated with (and/or derived by and/or utilized by) elements within Layers and/or within Levels are instantiated in at least one Node, whether or not that Node is connected to other Nodes. Nodes that instantiate these Components are considered in the present invention to be “enabled”.

Note that in the present invention, the term “disabled” may be considered distinct from “non-enabled”. A Node (and/or groups of Nodes) may be considered “disabled” when any or all of the Components and/or Data Objects that may be used by (and/or accessed by and/or modified by and/or otherwise acted upon) within Layers and Levels that compose the Network are instantiated, but wherein, under manual (i.e. user) control, and/or under any combination of Node-Specific, and/or Node-Relational and/or Network Control, those components are rendered non-operational. Note, however, that this “non-operational” status may be temporary; thus, a Node (and/or groups of Nodes) may variously and at any time be rendered “disabled” depending on the context and/or requirements of an implementation, and may be re-enabled at any time by any of the means described. Note also that a Node (and/or groups of Nodes) may be considered “partially enabled” in the case where only some subset (that is, one or more, but less than all) of the aspects described in the foregoing is disabled. Note also that a Node (and/or group of Nodes) may be rendered “partially-enabled” variously and at any time, depending on the context and/or requirements of an implementation.

In contrast, a Node (or group of Nodes) may be considered “non-enabled” when a Node (or groups of Nodes) is permanently “disabled”, a condition that may result from any condition, including but not limited to those wherein the Network has not been instantiated.

There are at least three cases that may proceed from these configurations. In the first instance, the term “Network” (and all of its subsidiary components) may apply (in the context of the present invention) when a Node is “enabled” whether or not that Node is engaged with and/or connected with another Node. This instance may be considered the “Standalone” Mode.

In the second instance, the term “Network” (and all of its subsidiary components) may apply when two or more Nodes are logically and physically connected (and where, as a consequence of this connection, may interact through some set of communication protocols), but wherein at least one connected Node is “partially-enabled”. This instance may be considered the “Hybrids” Mode.

In the third instance, the term “Network” (and all of its subsidiary components) may apply when two or more Nodes are logically and physically connected (and where, as a consequence of this connection, may interact through some set of communication protocols), but wherein all the connected Nodes are “enabled”. This instance may be considered the “Pure” Mode.

Note again, however, that Nodes may pass into and/or out of any or all of the Standalone, Hybrid and Pure Modes, variously and at any time, depending on the context and requirements of an implementation.

The term “Adaptive” may be used in the following descriptions—and indeed may be used in implementations cited herein and in those which may constitute obvious extensions to those cited—to embrace (but may not be limited to) either or both of these meanings:

An “Adaptive method” or “Adaptive process” (which may compose one or more “Adaptive components) may embrace (but may not be limited to) a collection of one or more processes that (individually and/or in conjunction, and/or in a computationally continuous and/or in computationally disjoint fashion) perform computations (and/or execute processes that perform computations) on Data wherein, by virtue of that computation, the process (and/or processes) itself may be modified and/or changed (either permanently and/or temporarily). In this sense, Adaptive methods cited herein may be interpreted as being similar to Adaptive signal-processing systems (wherein the parameters that govern the operation of a filter are affected by the data and/or by the results of a computation on that data).

Alternatively and/or in manner that may be supplemental to and/or adjunctive to the above, “adaptive” may also encompass the evolution and/or transformation of Data Object(s) and/or mathematical structures that may be used to operate upon those Data Objects. In some implementations, the transformative nature of a process and/or Data Object may be understood to be “content-emergent”, a term-of-the-art that may embrace (but may not be limited to) a class of processes and/or Data Objects defined by those processes wherein the characteristic content of a Data Object may determine and/or may influence and/or may define abstracted data structures associated with that Object. That is, the “meaning” of the content itself is inferred according to some defined ontology or set of ontologies and/or according to some normative criteria. (These “adaptive” processes are distinguished from processes that treat Data and/or representations of that Data without reference to the actual data itself. Thus, the data may define itself in some ways.) Content-emergent processes become Adaptive in the present invention since Data Objects within the Network may be changed and/or may be transformed by any number of means, including but limited to user interactions and/or process-based revisions. In this manner, for example, in one or more implementations, certain activities of Nodes within the Network may be monitored and characterized by some ontology (which defines the emergent behavior), and the Network may be re-organized and/or optimized according to that activity.

One consequence of content-emergent processes and methods may be the creation and/or facilitation of “self-organization”, a result that, in the present invention may be evident in any or all Data Objects and/or Components within the Network, and/or may become evident in the processes that compose and/or control and/or operate the Network and/or its constituent Nodes. Self-organization based on content emergent processing may also become instantiated and/or may affect and/or may be used as factor in the methods and/or processes and/or Data that may control and/or which may be referenced in arbitrating the organization and/or operation of the Network, and/or in the organization and processing of information that may flow and/or which may be made available by means of the Network.

Further, such results may become instantiated and/or may affect and/or may be used as factor in the methods and/or processes and/or Data that may control and/or which may be referenced in arbitrating the organization and/or operation of Node-to-Node functions, and/or in the organization and processing of information that may flow and/or which may be available by means of Node-to-Node functionality.

In addition, self-organization based on content emergent processing may become instantiated and/or may affect and/or may be used as factor in the Components and/or Data that may control and/or which may be referenced in arbitrating the organization of and/or operation of Node-level activity, and/or in the organization of, and/or in the graphical characteristics of the Node-level user interface, and/or in the organization and processing of information that may flow and/or which may be available by means of the Node-level activities.

Finally, self-organization based on content emergent processing may become instantiated and/or may affect and/or may be used as factor in the Components and/or Data as in the foregoing whenever a Node is in Standalone, and/or Hybrid and Pure Mode.

Further, the term “Adaptive Network” may encompass a collection of one or more Nodes that are connected by some suite of communication methods and wherein the methods and processes that may reside identically at each Node and/or groups of Nodes may possess and/or use Adaptive processes and/or may process Adaptive Data Objects. The adaptivity may be evident in the Network at Node-only level (referred to in the following as Node-Specific Adaptivity) and/or at the Node-to-Node Level (referred to in the following as Node-Relational Adaptivity) and/or at the Network Control Level (referred to in the following as Network Control Adaptivity).

In the following description of the present invention, it is useful to illustrate the Network and its Components and/or Data (using the definitions outlined in the foregoing and others may be developed) in the context of one or more models. This descriptive technique may provide the means to outline the details of the novel aspects of the Network, but should not be understood to compose and/or to imply instantiation of a particular implementation or set of implementations. Rather, the opposite is true—the model-based descriptions should be understood as a device by means of which the variety of implementations may be explicated. Thus, in the following descriptions, Components and/or Data that may compose the Network may be described as residing in and/or related to certain aspects of the model, but there is no loss of generality to implementations where such associations may not be explicit.

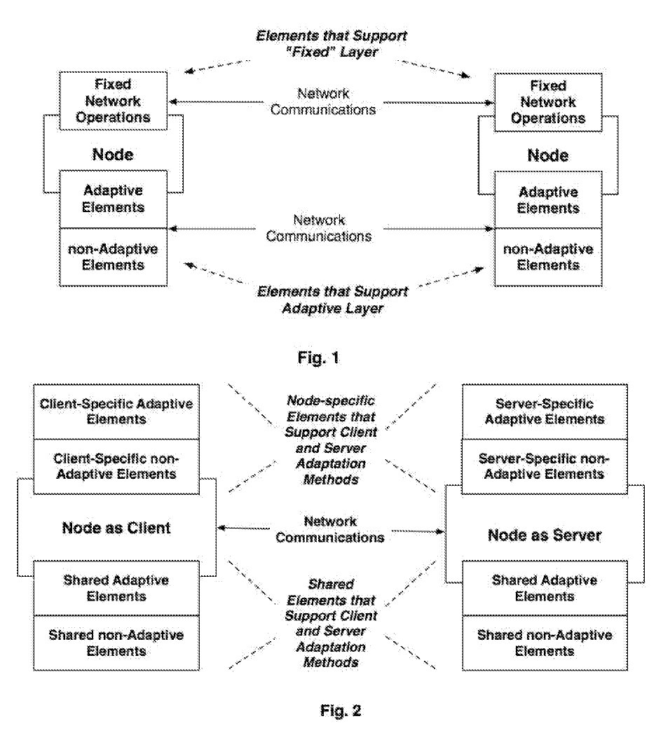

As shown in FIG. 1 an architecture and topology for use with the systems and methods described herein may bifurcate inter-nodal functionality between Adaptive and non-Adaptive methods and elements (where “Nodes” may refer to any computational element in the network such that a Node may variously and at times function as a Client, a Server and/or may function as both Client and Server). This model may provide a functional distinction between structures that support the non-Adaptive functionality on the one hand—these may be called “fixed network operations”—and those that support adaptation on the other. In this sense, the Network may be viewed as an additional layer of functionality to common networks within which nodal, inter-nodal and network-related adaptivity may be implemented.

Within an Adaptive Layer, there may be implementations in which elements are non-Adaptive, but provide support for Adaptive functions. Further, in some implementations, elements from the “Fixed” Layer may be used at the Adaptive Layer, and elements from the Adaptive Layer may be used in “Fixed” operations. In this sense, the Layers within this topology are not discrete or separate but may share functional elements. Thus in one aspect there is disclosed a system including an Adaptive layer overlying common network functions.

The descriptions of the various implementations of the Network and its constituent elements, structures, processes and/or Data Objects are best described in the context of mathematical and descriptive modeling. In modeling the Network, a fundamental extension of the concept of distributed data processing plays a central role; any or all of the methods, processes, elements and Data Objects within the Network may be interpreted (without loss of generality) within the context of the following distributed computation models.

As shown in FIG. 2, in implementations, there may be Node-Specific elements that support the Adaptive and/or non-Adaptive methods of that Node. Further, these Node-Specific elements may be used to execute Node-only functions and/or to execute functions related to inter-nodal operations and/or to execute network-related functions.

In addition, as shown in FIG. 2, there may be implementations wherein a Node may also operate as a Server, and implementations may provide Server-Specific methods (which may be Adaptive and/or non-Adaptive) to execute functions unique to a Server-based operation.

In this sense, the Adaptive behavior of the Network may be modeled to take place and/or may be instantiated at least three Adaptive Levels: Nodal-Specific Level; Nodal-Relational Level; Network Control Level.

Thus, without loss of generality, the Network may be modeled as composing one or more Nodes, which may integrate at least one “Fixed” Layer, and/or at least one Adaptive Layer (FIG. 1), but, when present, the Adaptive Layer may subsume one or more Levels 1-3 above.

The Components and/or Data that may reside in Level 1-3 may be inter-connected and/or may interact with and/or may be shared between Levels within its Node, and/or may be dependent on elements and/or methods and/or Data from other Levels.

Further, Components and/or Data that may reside in Level 1-3 (within the Adaptive Layer) may interact with and/or may share functionality and/or methods and/or Data with the “Fixed” Layer. The inter-relationship between Levels 1-3 may be seen in FIG. 3.

Finally, Components and/or Data that may reside in Level 1-3 (within the Adaptive Layer) may interact with, and/or may share functionality with, and/or may share methods with, and/or may share Data with elements and/or methods that may be modeled to reside within any and/or Layers 1-3 in other Nodes. In the case where an “enabled” Node interacts with one or more other “enabled” Nodes—the “Pure” case defined in the foregoing—any and/or all of the Components and/or Data that may reside in Level 1-3 within any or all of those “enabled” Nodes may be available to any and/or all other “enabled” Nodes. In the case where one or more Nodes is “disabled”—the so-called “Hybrid” case defined in the foregoing—Components and/or Data that may reside in Level 1-3 of “enabled” Nodes may incorporate and/or may process information from and/or about those “disabled” Nodes, and visa versa. Further, any of the “enabled” Nodes may bi-directionally exchange information and/or Data with “disabled” Nodes.

But note that within the Network (in any and/or all of the cases—Pure, Hybrid and/or Standalone), Adaptive methods and/or Data related to those methods may be interlocked with non-Adaptive methods within and/or between Levels, and/or within and between Layers.

Thus, regarding the references to and/or descriptions of implementations described herein, methods and associated descriptions may equally apply (without loss of generality) to the Node-Specific Level and/or to the Node-Relational Level and/or to the Network Control Level. Additionally, cited methods and implementations may be shared between the Adaptive Layer (where the Network exists) and the “Fixed” Layer.

In this sense, the architecture of the cited invention may be seen as embracing implementations of a hybrid adaptive/non-Adaptive system (the Network) that may co-exists and interact with and/or may share methods with a “Fixed” (non-Adaptive Layer) wherein any Node may variously and at any time may operate discretely (as Standalone Nodes); and/or within an “ad-hoc” network (where “ad hoc” may refer a temporary process-controlled and/or user-initiated grouping of one or more Nodes under some set of inter-nodal control elements); and/or in concert with other discrete Nodes and/or groups of Nodes in a “formal” network (where “formal” refers to semi-permanent or permanent process-controlled and/or user-initiated grouping of one or more Nodes wherein the Nodes may operate in concert or separately); and/or an elemental Node within the Network may as in operate above, variously and at any time as either Client and/or as Server and/or as in a “mixed” fashion as both Client and Server; and/or an elemental Node within the Network may operate as above, variously and at any time in Standalone Mode and/or in Hybrid Mode and/or in Pure Mode (as defined in the foregoing); and/or any Node may operate above to execute Components and/or Data that may be either Adaptive and/or non-Adaptive; and/or may operate using methods as above (Adaptive and/or non-Adaptive) that may be inter-locked either with Components and/or with Data within a Node; and/or may be inter-locked with Components and/or with Data in one or more external Nodes; and/or such that some Components and/or Data may be modeled as being subsumed within an Adaptive Layer and/or such that some Components and/or Data may be modeled as being subsumed within a “Fixed” Layer, but wherein, also, such Components and/or Data may variously and at any time be inter-locked and/or made to be inter-dependent, but that such inter-connection may also (variously and at any time) be “suspended” and/or “restored” (as defined in the foregoing); and/or such that these methods above wherein Components and/or Data within the Adaptive Layer (Adaptive Levels 1-3) may interact with and/or may influence one or more other Nodes at their respective Node-Specific Level and/or may influence one or more other Nodes at their respective Node-Relational Level and/or may influence one or more other Nodes at their respective Network Control Level.

These methods above may be instantiated such that the Components and/or Data within the Adaptive Layer (Adaptive Levels 1-3) may interact with and/or may influence one or more other Nodes at their respective Node-Specific Level and/or may influence one or more other Nodes at their respective Node-Relational Level and/or may influence one or more other Nodes at their respective Network Control Level.

Further, to extend this example, the execution of those Node-Specific non-Adaptive Components and/or Data executed at Node 1 may (or may not) influence that other Adaptive and/or non-Adaptive elements Components and/or Data residing at the “originating” Node (Node 1 in this case), and may (or may not) influence the Node-Specific Components and/or Data (Adaptive and/or non-Adaptive) of Node 2, and/or may (or may not) influence the Network Control Components and/or Data (Adaptive and/or non-Adaptive) used by one or more network control element(s), and/or may (or may not) influence Adaptive and/or non-Adaptive Components used by any or all of the inter-nodal functions within Nodes in the Network.

But note also that any or all of the foregoing combinations may be “enabled” and/or “disabled”, variously and at any time under control of elements that may be modeled as residing in the Node-Specific and/or Node-Relational and/or Network Control Levels and/or by means of user control, and/or by elements that my originate from the “Fixed” Layer, depending on the context and requirements of a particular implementation. In addition, any/and or all of Nodes within the Network may in any/and/or of the foregoing exist in any Mode—Standalone, Hybrid and/or Pure—variously and at any time.

For example, in one implementation, one possible Data structure that may be utilized by Components within the Node-Specific Level of Node 1 above could be a “profile” of the music contained in a media library attached to that Node and associated with a particular user. In such an implementation, the composition of that library may form one element in a derived profile of the associated user, and, since that library may change over time (as new material may ingested or deleted), the derived user profile may also change. Thus, the relevant Data Objects (the elements in the library and/or the profile of the library and/or the related user profile) may be modeled existing at the Node Specific Level within the Adaptive Layer of Node 1.

But note that in this example, this derived user profile may be used variously by Node 1 itself to execute certain Node-Specific functions (such as presenting information about elements in the Library, for example), but may also be used by the Node-Relational Level of Node 1 (by either or both Adaptive and non-Adaptive Components) to define a relationship between that Node (Node 1) and other Nodes that may be connected (say, for instance, Node 2).

Note that this relationship may be ad hoc (as defined above) where the users may exchange information about their respective libraries, but may be fixed (or semi-permanent, as defined above) according to some relational imperative, an imperative that may be mandated by the Nodes themselves (and thus, related to the Node-Relational Level of each Node) and/or by some network control structure (and thus, related to the Network Control Level).

If, in this example, however, the relational imperative (modeled as residing at the Node-Relational Level and/or at the Network Control Level) is such that certain changes in the user profiles associated with the respective Nodes (which profiles may be modeled to reside in the Node-Specific Level) influences the relationship between those Nodes (and the threshold of such changes and the relative impact on the relational connection between Nodes 1 and 2 may depend on the context and/or features in this example), then, as those profiles independently change over time, the relationship between Node 1 and Node 2 may also change.

But note also that in some implementations—and the Components that compose this aspect of the Network are cite below—while the Data that informs the profiles in the foregoing example may change (with the possible result cited above), the Components that may be involved in creating and/or maintaining those profiles (and/or which may operate upon those profiles) may themselves change, and/or be modified, such that these modifications and/or changes may be engendered by the change in the profile. This “recursion” between Data and processes may provide one element of the adaptivity that characterizes the present invention and its extensions.

Note further, however, that either Node 1 or Node 2 may, at any time, disconnect from the Network, and this may (or may not, depending on the context and the particular implementation) disable some or all associated Node-Specific and/or Node-Relational and/or Network Control processes at that Node.

Moreover, Node 1 or Node 2 may at any time, opt out of some or all of the Components (shared and/or non-shared, and/or Adaptive and non-Adaptive) that may be used by and/or which may influence Node-Specific and/or Node-Relational and/or Network Control Components—thus becoming either “disabled” or “partially disabled” Nodes—but in so doing, may (or may not, depending on the context and the particular implementation) disable some or all associated Node-Specific and/or Node-Relational and/or Network Control processes at connected Nodes.

Thus, in the foregoing example, the user at Node 1 may disconnect from Node 2, but may allow the evolution of the Node-level processes within their own Node (Node 1) to continue. Alternatively, depending on the context and particular features of the implementation, the user at Node 1 may disable the evolution of their own profile(s) but not disable the Node-Relational Elements that permit the arbitration of its relationship with Node 2.

But note that in the forgoing example, when Node 1 connects to and/or is re-connected to Node 2, the “Standalone” Network functionality that either Node may have executed in the period in which the Nodes were disconnected (and/or where some and all of the relevant aspects of the Network functionality in either Node were disabled), changes that may have occurred within Components and/or Data in either Node 1 and/or Node 2 may, at that time, be inter-connected with and/or may be re-inter-connected with any and/or all of the Components that may be modeled to reside in any of the Layers and/or Levels described in the foregoing.

In this sense, a “disconnection” may also be understood to be a “suspension” of any and/or all of the Components at any and/or all of the Levels and/or Layers wherein such a “suspension” may be invoked and/or revoked variously and at any time.

And, in the event that, upon that connection and/or re-connection, the Components and/or Data associated with any and/or all of the Levels and/or Layers in the now-connected Nodes has changed, and/or has evolved and/or may have otherwise been modified from the state they were in when the Node was disconnected, some or all of that functionality associated with those Components and/or Data may be integrated into any of the Components and/or Data that may be associated with any Level and/or Layer within any connected Nodes, omni-directionally.

It is axiomatic in distributed computation theory that discrete but interlocked processes executed across a network may be modeled as a singular process (though displaced in time and space). Moreover, some discrete processes may use and/or otherwise rely upon elements that may be instantiated in different physical and/or logical locations within a network.

In a refinement of this modeling technique (as it applies to the Network and its constituent elements), it is useful to extend this representation to embrace Network-associated Components and/or Data distributed within Nodes that compose the Network. But in the novel set of implementations embodied in the Network, the addition of Node-specific, Node-relational and Network Control Levels within the Adaptive Layer, and the methods by which these methods and the associated data may be inter-locked with both “Fixed” and Adaptive elements provides a set of extensions to this well-known distributed computation modeling practice. In any or all of the implementations cited herein and those that may become obvious, these extensions provide a basis for modeling the novel nature of the Components and/or Data that compose the Network.

Thus, to the degree that the Components and/or Data with which and/or upon which both the “Fixed” Layer and the Adaptive Layer operate (including but limited to the Adaptive and non-Adaptive Components and/or Data in the respective Layers) may be arbitrarily located within the Network, but may be understood as singular or unified processes.

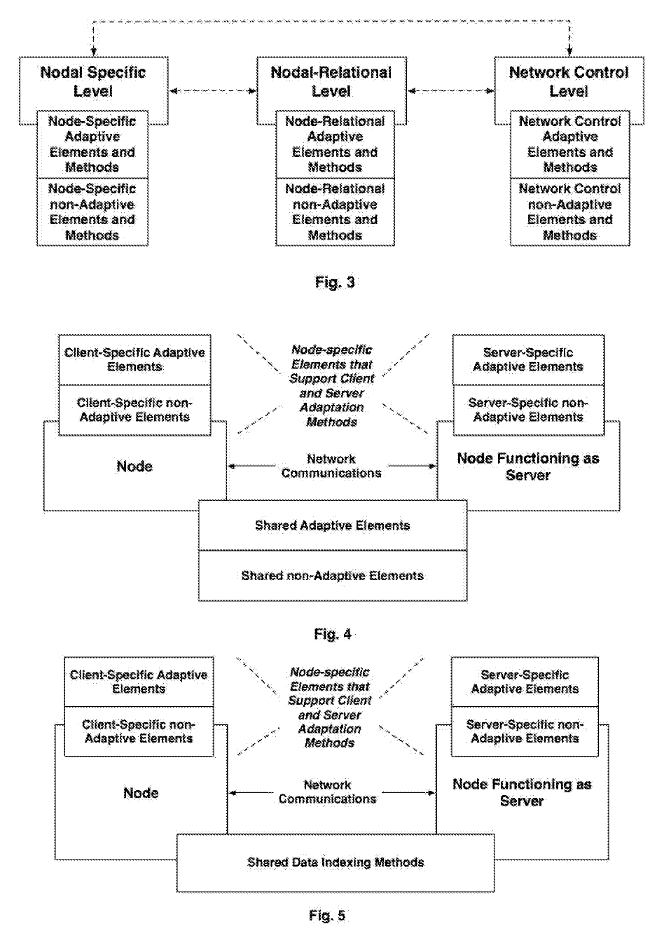

As shown in FIG. 4 (which represents an extension of FIGS. 2 and 3), within the Network there may be Node-only Components and/or Data (which may further be specific to Client-based activity and/or to Server based activity—noting that any or all of such Nodes may function variously and at times as either Clients or Servers and/or as both Client and Server), and there may be “Shared” Components and/or Data.

The term “Shared” should be understood to mean that the subject Components and/or Data may be instantiated (identically and/or in a fashion that is computationally compatible and/or which may be made functionally compatible by one or more processes) at different physical and/or logical locations in the Network.

But note that this definition may also include instances wherein the subject Components and/or Data composed at those locations may be discrete (in that the instantiation represents a functional whole) and/or wherein the subject Components and/or Data may be distributed (in that one or more elements that compose the subject Components and/or Data may also exist at different physical and/or logical locations).

In implementations of the Network, these “Shared” Components and/or Data include methods for indexing and/or accessing data structures within the Network. The functional unity is shown in FIG. 5. Where the indexing and access methods related to distributed Components and/or Data are “Shared”, those Components and/or Data upon which this shared indexing method operates may also be “Shared”.

Thus, since all the Nodes within the Network that share such methods and processes may access and operate upon data that may also be accessed and addressed using a common set of indexing techniques, the subject Data within the Network may be modeled as composing a single database, as shown in FIG. 6. Note that these indices may be made available at any time to (any and/or all) the components that may be associated with and/or that may be used by the “Fixed” and/or Adaptive Layers of the Network. Similarly, these indices may be made available at any time to (any and/or all) the components within the Adaptive Layer—both Adaptive and non-Adaptive components—within the Node-Specific Level, the Node-Relational Level and the Network Control Level. Note further that this global index may be refreshed and/or modified and/or augmented as Data is ingested and/or is deleted at any Node, and/or at any Server.

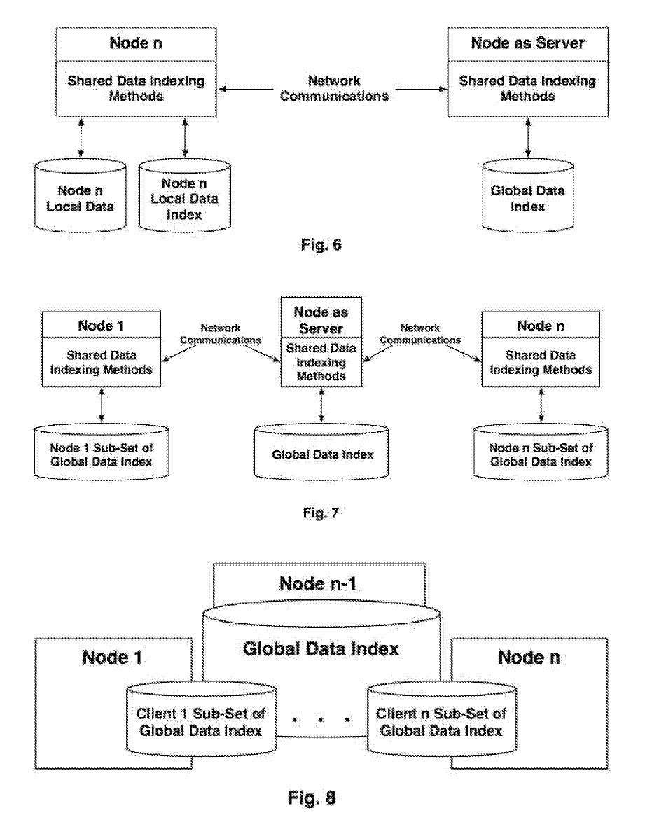

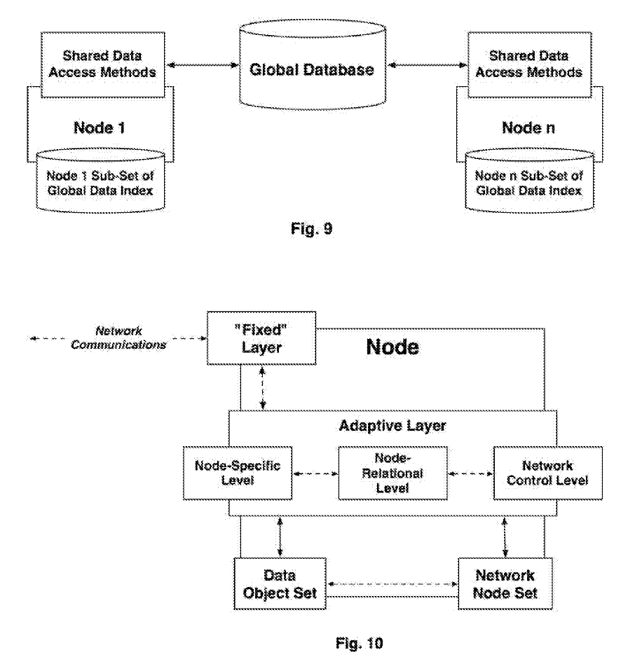

Thus, the data index possessed by each of the n Nodes may provide an index of its local Data to other Nodes, but this index at Node n is a sub-set of a global index possessed by and/or accessible to the Nodes within the Network. This “virtuality” model is illustrated in FIGS. 7 and 8. Therefore, since each Node in the Network may possess a common method of Data Object indexing, the Data Objects themselves may be modeled as composing a network-wide data store. As illustrated generally in FIG. 9, the network-wide data store may be realized using the Node-Specific, Node-Relational and Network Control Levels within the Adaptive Layers of the constituent Nodes within the Network. In general, the shared indexing for a data store may be realized across any combination of client-server, peer-to-peer, server-supported peer-to-peer, and other network configurations. Further, Shared indexing may be instantiated in Nodes within the Network, which may be in any one or more of the Modes defined herein—Standalone, Hybrid, and Pure. Indexing deployed in the systems described herein may employ any combination of indexing methods, including but not limited to those cited herein, and any modifications or variations thereto that would be apparent to one of ordinary skill in the art.

Equally, any data type may be indexed with an appropriately matched indexing method. Thus, using the techniques disclosed herein, any data indexing technique may be applied to any data stored within, or accessible by the Network, including data distributed across multiple Nodes.

The Network topology may deploy various shared data indexing methods. These methods may be modeled as residing in the two sets—the Data Object Set and Network Node Set. But note that, as mentioned, the elements within these sets and/or the Components associated with these sets may co-exist with and/or may be supplemented by and/or may be utilized by non-Network methods, including but not limited to those associated with the “Fixed” Layer of network operations. Note also that the foregoing descriptions of the variety of methods by which elements that may compose the Adaptive Layer may be interconnected (as espoused in the descriptions associated with FIGS. 1-9 above) apply without limit to these refinements.

Note that the Network may subsume and may apply any and/or all methods described herein to Data Objects of any type including (but not limited to) word processing documents, HTML files, hyperlinks, RSS feeds, Powerpoint documents (and similar presentation documents that may include one or more information formats (including, but not limited to text, photographs, images, graphical representations and such items as may be typically included in such presentation documents), video (encoded by means of any number of processes and into any format such as MPEG2, MPEG4, .avi, QuickTime, WMV, Real and so on), audio (encoded by means of any number of processes and into any format including MP3, AAC, WMA, OGG and so on), graphical representations (such as, but not limited to, GIFs, Graffles and so on), software executables (including but limited to consumer and professional computer programs, computer games).

Within the Network topology, there may be at least two categories within the group of methods related to data processing and indexing: The Data Object Set, which relates to content or information distributed across the Network; and the Network Node Set, which relates to the structure and operation of the Network.

The Data Object Set may (in general, but not exclusively) contain elements that are germane to the processing and/or indexing of Data within the network-wide database. By contrast, the Network Node Set may contain elements that relate to the network operation of the Nodes (as it applies to both the Network and “fixed’ elements). FIG. 10 illustrates the relationship that may exist between these Sets methods and/or Data Objects that may be modeled as residing within the Layers and/or Levels within Nodes in the Network.

Note that within this model, the Components and/or Data Objects associated with the Network Node Set may use and/or may process and/or may otherwise interact with elements from within the Data Object Set, and methods associated with the Data Object Set may use and/or process and/or otherwise interact with elements from within the Network Node Set.

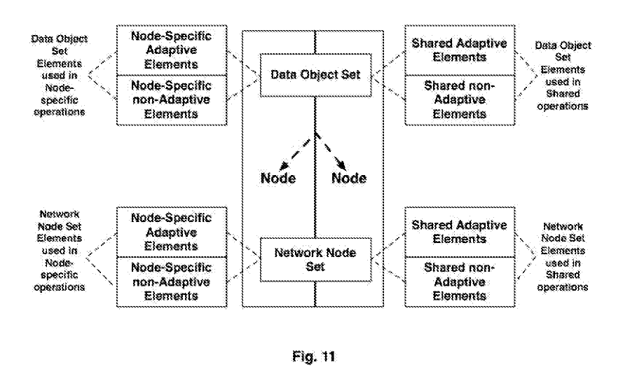

Recalling the description of Shared processes in the foregoing, the Data Object and Network Sets may have elements that may be shared by the Nodes in the Network and elements that may be specific to Node-Specific functions. This is illustrated in FIG. 11. Note that this model applies to any network topology.

Thus, the Data Object and Network Node Sets may exist within any Network topology as described, and, in a manner that reflects the nature of the Network, and may embed both an Adaptive component (which may co-exist with non-Adaptive components), but that there may be many elements, Data Objects and processes that are shared between this functionality.

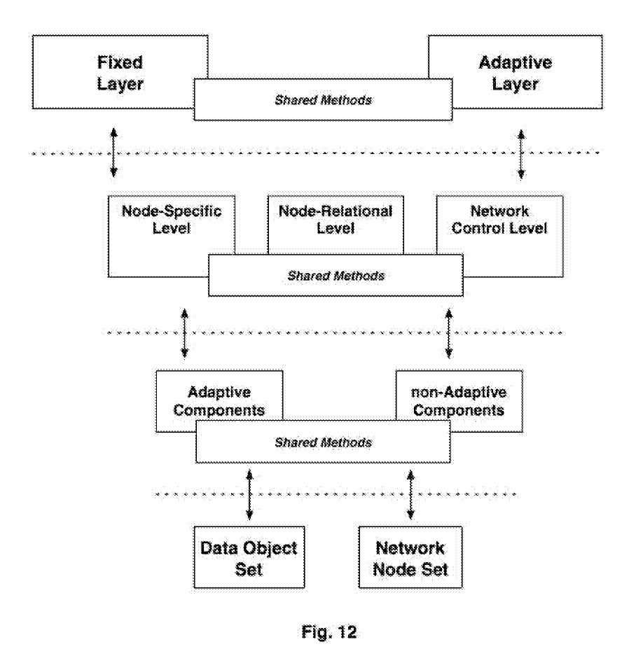

Another way to view and interpret this model may be seen in FIG. 12. Note that, as described in the foregoing, the Adaptive Layer may Share Components and/or Data with the Fixed Layer, but that within these Layers there may be Layer-specific methods and/or Data.

Note also that either the Fixed and/or Adaptive Layers may (variously and any time) access any of the Levels. Note further that any and/or all of the Components and/or Data that may be subsumed within the Levels may be Shared between those Levels (variously and any time), but that there may also be Level-Specific Components and/or Data.

Note also that any and/or of the Components and/or Data subsumed by and/or utilized by and/or accessed by any and/or all of the Layers and/or Levels may be either Adaptive or non-Adaptive, and that Components and/or Data germane to those process may (variously and at any time) be Shared. Note finally that the Data Object Set and the Network Node Set may be accessed by any and/or all (variously and any time) of the Components and/or Data that may be modeled as residing at any and/or of the Layers and/or Levels, and/or by any of the constituent methods that may be subsumed therein.

In the present invention and in various implementations, the Data Object Set may contain (but may not limited to) the following “Data Object Elements”. The elements that compose the Data Object Set may include: Data Object Identification Elements; Data Object Content-Specific Elements; Data Object Normative Elements; and Data Object Normative Relational Elements.

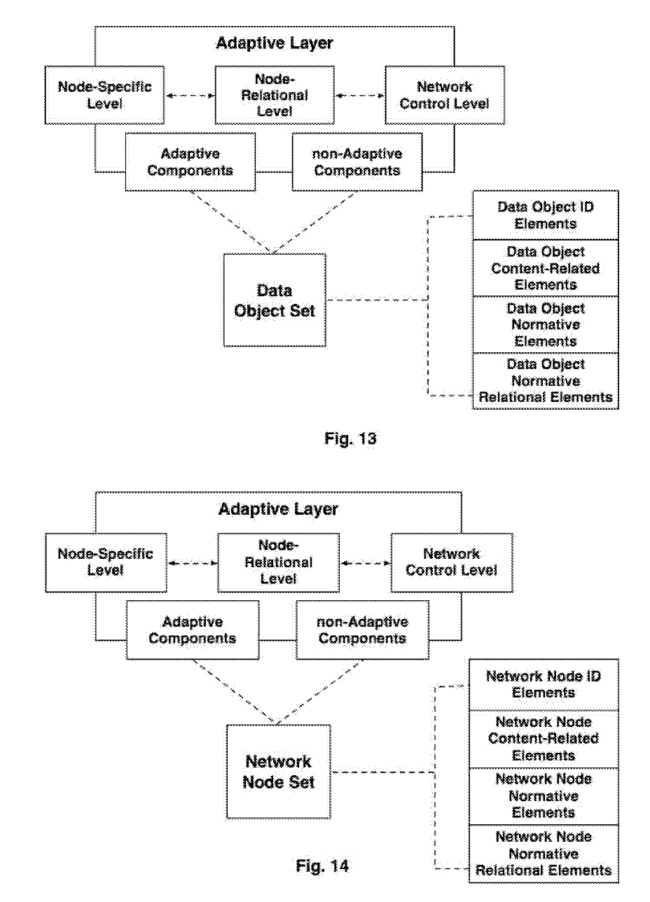

Note that any implementation of the Network may use and/or access and/or operate upon one or more of the Elements within this Set. The Elements that may be members of the Data Object Set may be associated with specific Data Objects in the Network, and/or may be used by, and/or may be accessed by, and/or may be operated upon by any and/or all of the Components within the Node-Specific and/or the Node-Relational Level and/or the Network Control Level. But note that as described in the foregoing, methods modeled to reside the “Fixed” Layer may also access and/or operate upon these Elements. Further, any and/or all of Nodes that nay access these elements may operate in any of the Modes described in the foregoing. Finally, note that the Elements that compose the Data Object Set and/or all of the Components that may be used by, and/or may be accessed by, and/or which may operate upon these Elements may be Shared, and thus may be considered “virtual across the Network. FIG. 13 illustrates one manner in which the Elements within this Set may be integrated within the Network.

The Network Node Set may provide elements that may not be directly connected to specific Data Objects in the system, but rather, may be connected to operational aspects of the Network that may affect and/or may be affected by and an/or may access and/or may be accessed by the Components and/or data that may be modeled as residing at the Node-Specific and/or Node-Relational Level and/or the Network Control Level.

Note that the Network Node Set and the Data Object Set are related in that they may be derived from and/or may utilize certain Data- and process-related Components that may reside in the Network, but differ in that the Elements within the Network Node Set may be additionally used to control the network disposition of those Data- and process-related components.

The Network Node Set may contain but may not be limited to the following “Network Node Elements”. As with the Data Object Set, note that any network topology and/or any functionality executed within that architecture may use any or all of these components variously and at any time, depending on the context), and that the functionality of the Network may not be affected if additional elements are included and/or if some are excluded in certain implementations and under some operating conditions: Network Node Identification Elements; Network Node Content-Specific Elements; Network Node Normative Elements; Network Node Normative Relational Elements.

As with the Data Object Set, processes and/or methods and/or data within the Network that access or are used by the shared and/or non-shared Node-Specific, and/or the shared and/or non-shared Node-Relational, and/or the shared and/or non-shared Network Control Level may also utilize any of all of the Network Node Set Elements 1-4, variously and at any time depending on the requirements and/or the context of an implementation. FIG. 14 illustrates these principles.

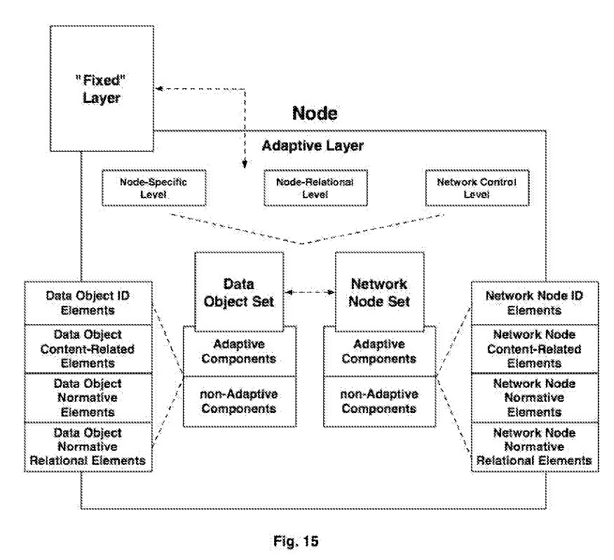

FIG. 15 illustrates the inter-connected nature of the constituents of the Adaptive Layer. As may be seen in FIG. 15, the “Fixed” Layer and the Adaptive Layer may Share Components and/or Data. In turn, as shown in FIG. 15, Components and/or Data that may be modeled as residing at the Node-Specific and/or the Node-Relational and/or the Network Control Levels may also be Shared between any and/or all of those Levels. Since the Node-Specific, Node-Relational and Network Control Levels may be modeled as residing within the Adaptive Layer, Share Components and/or Data that may be associated with those respective Levels may be shared with the “Fixed” Layer, and Share Components and/or Data that may be modeled as being associated with the “Fixed” Layer may likewise Share Components and/or Data that may be associated with any or all of the Levels that compose the Adaptive Layer. Finally, as shown in FIG. 15, any or all of the Elements that are associated with the Data Object Set and/or the Network Node Set may (without limit) may be Shared (as in the foregoing) by any and/or all of the Components and/or Data that may be associated with, and/or which operate upon and/or which are operated by Elements these Sets. And since these Sets may be instantiated within the Adaptive Layer and may be associated with and/or used by any or all of the Levels within that Layer, and since these Levels may be associated with and/or used by any or all of the components that comprise the “Fixed” Layer, any or all of the Elements within the Data Object and Network Node Sets may be associated with and/or used by any or all of the components of the “Fixed” Layer. Thus, any and/or all of the Elements of these sets may also be seen as “virtual” across the Network and variously and at any time be used by Nodes that may exist in any of the Modes-Standalone, Hybrid and or Pure. Finally, Nodes in any Mode may “enable” and/or “disable” and/or all of the foregoing functions variously and at any time.

The Data Object Set may be expressed mathematically as:
{Data_Object}={{O_{T}_{ᵢ}}, {OC_{T}_{ᵢ}}, {ON_{T}_{ᵢ}}, {OR_{T}_{ᵢ}}}
where the set {O_{T}_{ᵢ},} may contain Data Object Identification Elements, where the set {OC_{T}_{ᵢ}} may contain Data Object Content-Related Elements, where set {ON_{T}_{ᵢ}} may contain Data Object Normative Elements, and where the set {OR_{T}_{ᵢ}} may contain Data Object Normative Relational Elements

The set {O_{T}_{ᵢ}}, composed of the Data Object Identification Elements may provide the means to identify Data within the Network (but note again that the term “Data” may refer to (but may not be limited to) Data Objects (including but not limited to media content, and/or data that may be used by processes and/or executables within the Network), and/or to indices that reference Data, users, Nodes, Components and/or any entity related to and/or which may be used by any element in the Network to execute a computation and/or process).

(Note that a Data Object will be referenced in the following descriptions by means of the identifier O_{T}_{ᵢ}, where O designates the Object identifier, where T designates a Data Object and Tᵢ designates that this specific Object is the i^{th} Data Object.)

There are many commonly employed methods that may be used to accomplish identification of distributed Data Objects in the Network. In any and/or all implementations of the Network, any or all of these methods, and/or any other functionally equivalent (or similar) method or methods, may be employed to instantiate the Data Object Identification Elements within the Data Object Set {O_{T}_{ᵢ}}, either individually, in combination or sequentially in any order, variously and at any time (depending on the requirements of the implementation and/or the context).

Whichever technique or group of techniques may be deployed within any and/or implementations of the Network, the technique(s) may be common to the Nodes within the Network, and thus, the distributed data storage and distributed processing models (and/or any of the extensions unique to the Network) described in the foregoing may be applied.

In some implementations, one such method may assign one or more unique indices to a Data Object and may share those indices within the Network. Other methods that may be used in implementations associate an abstracted representation of the data within the Data Object to one or more indices. These methods are commonly employed in content-oriented search and acquisition networks (such as file-sharing peer-to-peer networks) wherein a cryptographic hash may be performed on a Data Object and the result itself may either serve as one index for that Object and/or may serve as the basis to derive one or more indices.

Other methods that may be employed in any and/or implementations of the Network may embed various types of visible and/or indelible watermarks within the Data Object and/or within representations of that Data Object (that is, in abstractions of the Data Object); these watermarks may be etched onto and/or into Data Objects and/or may be discrete Data Objects associated with a Data Object by Nodes within the Network and/or may be etched by a process outside the Network. In practice, (in some implementations) algorithms that may be instantiated within Nodes in the Network may detect the information contained in that watermark, and one or more embedded indices may be extracted and/or may be derived, using either local and/or remote processes and/or Data.

Some implementations of the Network may require an “absolute” identification of the Data Object, where the terms “absolute” may encompass requirements within the Network as defined by users and/or by providers of proprietary Data. These indexing methods may additionally and/or exclusively (variously and at any time, depending on the requirements of the implementation and the context) employ content-emergent algorithms to create one or more indices and/or the basis from which one or one or more indices may be derived. These methods may incorporate watermarking techniques (as described in the foregoing) and/or may employ any combination of signal processing techniques and statistical analysis algorithms to extract and/or evaluate one or more features maps derived from the data within a Data Object and/or which composes the Data Object. This result may, in some cases, be further processed and/or transformed by means of such methods as cryptographic hashing and/or other techniques that may create a unique index or set of indices.

One implementation of such a system is designed to provide a high degree of accuracy in the identification of music files. Such a system may deploy one or more signal processing algorithms to generate indices for those objects. Known in the art as “fingerprint” techniques, these methods may analyze the acoustical properties of digital musical files, thereby extracting a signature unique to the content within that file, a signature that may be independent of the specific encoding of the file and may provide some immunity from random variations in the data due to noise and other factors. Some variations of this approach may then further process that file, using for example, common cryptographic hashing methods such as MD5 to transform that signature into a format that may be used as an index.

On the basis of this identification, some systems may then associate one or more documents with such indices (and thus with the individual files from which the index is derived) such that these documents convey information related to that file. Such information may include the ownership of various rights and privileges associated with the subject file, and may convey rules and/or “terms of use” which govern the conditions under which the file may be accessed by Nodes and/or by users. Some systems additionally provide a Server from which these documents may be obtained, and others may additionally provide the means by which owners of subject files may assert claims of ownership and mandate the “terms of use” that should apply in enabled systems.

One such “term of use” may govern the ability of Nodes to access and/or obtain a file from another Node. Commonly known as “file-sharing”, this mode of content acquisition may be controlled in this manner. Thus, the Network may provide media file-sharing capability to users at Nodes by incorporating such techniques within Data Object Identification Set. A rights management infrastructure may be deployed using these techniques, and may incorporate any one or more third-party rights management systems, along with any supplemented services implemented at the Network level. Various embodiments of a such a rights management infrastructure are provided below.

Thus, the capabilities of one or more systems that provide fingerprint-based indices and control documents—capabilities that may be provided by one or more services available to the Network—may be seen as composing elements within the Data Object Identification Set. Note, however, that any of the elements of the Data Object Identification Set may be used by and/or accessed by components and processes throughout the Network, at any Level and Layer and in any mode, as described above. Since these service-provided elements may be integrated with other functions and/or components and/or processes which may be either internal to the Network—in the sense that those functions themselves compose new elements introduced by the teachings of the present invention—and/or which may be themselves be provided by other services but which are interconnected and/or made to be interoperable by virtue of their collective integration as elements within the Network, the Network may therefore provide an overarching control scheme built on a collection of existing services and new teachings such that some existing service-provided elements may be used to instantiate functionality beyond those provided by the integrated elements when used outside the integrated Network.

Thus, in some implementations, Nodes within the Network may incorporate one or more such techniques within Data Object Identification Set (and/or may combine techniques provided by one or more services) to process and index media files in this manner, and may, as a result, provide users in the Network the ability to access and/or to share such files. In these embodiments, a “service-provided control document” associated with the subject file may be consulted when a Node initiates certain activities related to that file if such activities are governed by the terms contained in the document. Services that provide and maintain these documents typically provide instructions as to how obtain and process such documents, but the implementation with respect to the networking protocols by means of which the file may be shred within the Network may vary, according to the requirements of the service.

Note that the methods that provide the “fingerprinting” techniques and/or associated control documents may be modeled as residing within the Fixed Layer of the Network in that the methods and/or the associated data generated by and/or used by such methods may not subsume Adaptivity (as defined in the foregoing) in response to user and/or Nodal and/or Node-Relational and/or Network-Control based stimuli, but that some or all of these methods and/or associated Data may be accessed by and/or used by other methods that may be modeled as residing within the Adaptive Layer. Further, note that service-provided “fingerprinting” techniques and/or associated control documents may be modeled as residing variously at any of the Node-Specific and/or the Node-Relational and/or the Network-Control Levels, and that these methods and data may be modeled as distributed in that the methods and indices may be shared by enabled Nodes. Thus, in embodiments, the Network may incorporate and embed methods and processes provided by such services, but may augment these implementations with additional the Node-Relational and/or Network-Control Level mechanisms and/or user interface mechanisms in manner that may be possible only in the context of the teachings embodied in the Network. Finally, note that since Nodes may be enabled, partially-enabled and disabled and/or may operate as pure and/or hybrid Node, variously and at any time, service-provided methods and/or associated documents and/or the additional processes integrated with those methods within the Network may also operate in this manner.)

One example embodiment that provides extensions to these services is expressed in the Mashboxx Network Rights Management System (NRM). In these and related implementations, the Network may integrate one or more “fingerprinting” services to index musical content and may additionally utilize the control documents some services offer, such that these control documents may be associated with the subject files. Note, however, that since there may be features and functions provided by the NRM in the context of an implementation of the Network that may not be supported by the referenced services, such extensions comprise unique expressions of the teachings of the present invention.

Similarly, the information, content, or other files or data management by the rights management infrastructure may include media (such as audio, video, still pictures, or other documents) in a variety of forms including files for direct use, encrypted files, degraded quality files, file and usage metadata, and so forth, and may be maintained as single files or combinations of files and or control data. In one embodiment, the rights management infrastructure may associate one or more additional and/or supplemental control documents to those provided by third party providers which extended functionality surrounding the subject files. One such embodiment may use such additional control documents and may instantiate related methods that use these documents to provide Node-Specific and Node-Relational and Network Control Level support for the variety of rules that may be embedded within the service-provided control document.

Rule sets may include, without limitation: network trading rules such as Network trading of the subject file not allowed; Network trading of the subject file allowed without limit; Network trading of the subject file allowed only with pre-purchase of the file with a preview (wherein a section of the subject file may be played prior to payment); Network trading of the subject file allowed only with pre-purchase of the file without a preview (wherein a section of the subject file may be played prior to payment); and Network trading of the subject file allowed with limited play “Sampler” usage (wherein a full-length version of the file may be made available prior to purchase but such that that file may be degraded (by a number of means) to a quality level that differs from that provided in the purchasable version). Note that any or all of the rule sets above (and those that may be included above) may require that the subject files be “locked” within a DRM encryption such that the file may only be re-played when a valid key is obtained. Such DRM methods and systems for dispensing license keys are commonly available from Microsoft and others.

In this example implementation, Nodes within the Network may access any and/or all rule sets associated with subject files as conveyed with service-provided control documents (which may, in some instances be provided by different service providers) by means provided by the particular service providers. But additionally, as a component within the Network, this example embodiment may respond to these rules according to a suite of methods provided by the Network control scheme. These methods may include a Network-provided Server-based purchase system wherein a user within the Network may purchase eligible subject files and/or obtain “Sampler” versions of eligible subject files and/or obtain preview clips of eligible subject files, wherein eligibility may be defined by the service-provided control document.

In this example embodiment, the Nodes within the network and/or the associated Network-based Purchase Server may generate “supplemental control documents” that may be used to manage the subject transactions. In this sense, the execution of the rule sets conveyed in the service-provided control document(s) may, in this example, be instantiated independently of the methods and/or data provided by the “fingerprinting” and control document service(s)—noting again that one or more such services may be used.

In this example, the Network-based Purchase system may interlock a Purchase Server with methods that may reside within Nodes such that any and/or all of these methods (regardless of where these methods may reside) may interpret the rule sets within the service-provided control document(s). Based on the instructions embedded within those control documents, either the Server and/or the Node may generate a supplemental “transaction” document wherein the requested activity initiated by a Node may be encoded with reference to the governing service-provided control document. As a result, using methods and/or documents independent of those provided by the control service(s), the Network may execute transactions related to the subject file.

In one example, wherein the user may attempt to acquire a file that possesses a rule set that requires payment before the file may be permanently acquired, the supplemental “transaction” document may convey and/or may encode any and/or all of the elements of the relevant rule set (and/or may reference the service-provided control document) along with other information concerning, for example, the fingerprint-linked index of the subject file and/or pricing information. This “transaction” document may be conveyed to one or more Purchase Servers that may then request that the user log into a pre-established account (noting that as with common e-commerce systems, such accounts may be established by an number of means). Once the user provides and/or confirms payment-a service that may be provided by one or more e-commerce providers either as a complete, end-to-end transaction service (whereby the entire transaction related to validating, collecting and recording such payment transactions is provided as a complete service) or wherein aspects of the complete service may be provided by resources within the Network—either the same “transaction” document may be amended to record the successful execution of the payment transaction and/or another similar but associated document may be generated by the Purchase Server. One or more such “confirmation” documents may then be conveyed to the originating Node.

Note that such transactions may also be unsuccessful in that, for whatever reason, the payment transaction may not be approved, but that in either case, the Node may display an appropriate suite of user interface notices, dialogs and other components. The elements and the methods by which the user interface conveys this information may be independent of the service(s) that provide the control documents, the fingerprinting services and/or the e-commerce purchase transaction services.

In the present example, once the requesting Node has received one or more “confirmation” documents, that Node may then acquire the subject file. As stated above, however, some rule sets may have allowed the file to be routed to the requesting Node prior to purchase, but such that that file is encrypted within a DRM wrapper (such as Microsoft Windows Media DRM (WMDRM)), for example (thus rendering the file inaccessible without a license key), but other rule sets may require that the payment transaction be successfully executed before the file may be downloaded. In the latter case, the file may or may not be encased within a DRM encryption, but in those cases that DRM wrapping is present, the requesting Node may convey one or more confirmation documents to an appropriately configured DRM license key Server (such as may be provided by Microsoft to support WMDRM. In some embodiments of the present example, this DRM Server may be instantiated as a component of the Network and/or may be a service provided other providers. In any case, once the file is present in DRM form at the requesting Node, that Node may obtain a license key (by means appropriate to the DRM system) by providing the appropriate transaction document.

Note that the Network-operated purchase Server, in the present example embodiment may record all such transactions and may provide the associated data to processes that may reside within the Network and/or to processes and/or service outside the Network. Thus, in one example, the transactions documents may be stored and may provide the basis for activity and/or accounting reports, reports that may be generated by the Purchase Server and/or which may be generated by other processes associated with accounting and/or other data collection functions. Note that, in some embodiments, this reporting capability may also include activity unrelated to purchase of subject files, but may additionally include (but may not be limited to) activity associated with any methods that may be modeled to reside at the Node-Specific and/or Node-Relational and/or Network-Control Levels, whether those methods themselves and/or the associated data is uniquely provided for and/or by the Network.

In some embodiments, the Network may also provide mechanisms that permit alternate forms of such transactions such that the “currency” used to execute” payment” may be other than that required by the e-commerce provider. Thus, some transaction may be executed based on rendering commodities such as Network-provided “tokens” and/or credits—commodities that may be awarded and/or otherwise obtained by users at Nodes. Such commodities may, for example, result from activities such as barter, trade, purchase, contest participation, promotions, voluntary participation on Network-operated programs and/or procedures, and so forth. Such alternate payment forms may be Network-based and may incorporate third-party services. Note, however, that, in implementations, such programs may be administered by and/or related activities may be recorded by and/or records compiled and maintained by the Network-based Purchase system.

Note also that one or more DRM systems may be employed, and that the encryption/decryption infrastructure may be an independent component of the Network combined with one or more fingerprinting methods, control document methods, purchase transaction methods, and so forth within the operation of the Network. The Network may provide a control layer within which third-party services and/or local client functions are integrated to provide a content sharing system, and may further provide additional capabilities to enhance the content sharing system as deployed on the Network.

For example, the Network may support “try-before-you-buy” Sampler files even where such a service is not supported by underlying third-party services. In one embodiment, Sampler files may be encrypted using a third party encryption technology operating under control of the Network. Sampler files may be constituted from any Data Object within the Network and may be composed of any content type, including audio, video, video games, documents and/or computer programs (and other executables), and are intended to provide a user with limited use of the subject file under some set of terms. In some embodiments, the Network provides the means to convert these Sampler files to “permanent” subject files using one or more methods described above whereby the user may execute a purchase transaction and may, if appropriate, obtain an appropriate license key in the event that the subject Sampler file is provided within a DRM encryption. In various embodiments, indexing may be maintained exclusively within the Network (as in a pure peer-to-peer embodiment) or may employ content indexing from third parties, such as content or rights management providers.

As an example, Music Samplers may be provided within the Network by a number of means and in a number of forms. But note that these various forms of Music Sampler files may co-exist within the Network, and that the methods and/or data that support these forms may be shared. Thus, in embodiments, the service-provided control documents may contain rules governing the Music Sampler files, but in some instances those rules may be superceded and/or supplemented by rules that may be contained within and/or generated by and/or which may be maintained by and/or which may be administered by non-service provided components within the Network and which, therefore, may not be supported by the relevant control-document service. Thus, as regards the creation of and/or control over, and/or access to and/or distribution of and/or purchase-based conversion of Sampler files (including Music Sampler files), the control skein provided by the Network may extend the functionality provided by non-Network services that may be integrated within the Network.

One such example is a Network-based system that enables the creation of and/or management of and/or control over and/or re-play of and/or purchase-conversion of the Music Sampler files. Such Sampler files may (in some cases) provide (prior to purchase) to a Node a degraded and/or otherwise modified form of the same file that would be delivered if and when the Sampler is purchased. Thus, in some instances, the Sampler may contain one or more “voiceover” announcements, for example, and this announcement may, in this case, constitute the degradation. In this instance, the announcement may be permanently impressed on the Music file (as in “mixed” within the content), and in some such cases, the Musical Sampler file may be identical to that of the purchased file except for the inclusion of this voiceover. In other cases, the voiceover may be stored at some location (including within the Node or at a remote location) and “mixed” into the file during playback. In variations of this technique, the voiceover may be streamed from one or more locations in the Network and mixed with the subject file at runtime. In other cases, the announcement may be appended to the Sampler file and retrieved and mixed during playback. In other cases, the Sampler file may be converted to a different and/or lesser quality such that the subject musical data may be filtered (such that all or some portion of the file might be bandlimited) and/or may be encoded at lower bit rate. Such “lower audio quality” Samplers may or may not include a voiceover announcement. But note that such announcements may be dynamically “mixed” into any Sampler at any time—and/or may, alternatively, be removed—depending on the requirements mandated by the content rights-owner. Note also, however, that some Samplers may have no degradation of any kind and/or may have degradation removed and/or added, as above.

In cases where the rights owner requires that the Musical Sampler files be degraded and/or modified, the Network may provide corresponding functions. Thus, in one example, a suite of methods subsumed in a process called “Sampler-Maker” may create various forms of a Music Sampler. Sampler-Maker provides the means to enter the parameters for a Sampler, including (but limited to): the type of modification to the musical data (as in band-limiting and/or the encoding rate) and/or the portion of the file which would be subject to such modifications and/or the location within the subject file and content where an embedded announcements (if any) would be placed. Once the parameterization is complete, Sampler-Maker may operate on subject data files and may produce Musical Sampler files for distribution.

In one variation of these methods, Sampler-Maker constructs Sampler files as “composite” files wherein a Sampler file includes additional data. The Sampler file may contain a degraded or un-degraded form of the musical data, and additionally include data that provides instructions to a process (that may reside at an enabled Node) to operate upon the subject musical data, wherein such instructions may, for example, mandate the runtime insertion of voiceover announcements—which voiceovers may be included within the file and/or may be located at the subject Node and/or at a remote location—and/or which may contain instructions for a process resident within a Node to filter and/or otherwise operate upon and/or to introduce noise or distortion to the subject file at runtime in order to execute “local” degradation of the file. The composite Sampler file may also or instead, contain two separate music files such that one file may compose a degraded form of the relevant data—degraded as above—and one may contain a non-degraded form. Such “two-file” composite files may also include other data, including without limitation trading rules, transaction rules, usage restrictions, metadata, and so forth.

Samplers may include preview sections of the relevant musical file, “clips” of the subject file that may typically be provided to the Node when the terms of the Sampler have expired. The composite Sampler file may also, or instead, include data that provides instructions to processes that reside at the requesting Node such that the Sampler file may be linked to non-audio announcements (such as advertising) that may additionally and/or instead, be displayed to the user at runtime, and such ad-tethered samplers may be constructed in any of the forms as described above.

The Sampler may be “time-bound” and/or “instance bound”. In the former case, replay may be available only at certain times and/or for certain periods, and control information may be embedded in the composite file to execute these parameters; while in the latter case, replay may be enabled only for a certain number of instances, and this information may be contained within the file. Note, however, that any and/or all of this control may be contained within supplemental control documents associated with the subject file, and further, that in some cases, such control functions depend on interlocked information that may variously reside within the composite Sampler and one or more supplemental data structures.

Non-composite Sampler files may also be provided by and available within the Network. In one such form, the Sampler-Maker creates a non-composite version of the subject file that, apart from the degradation that may be mandated as above, is otherwise identical to the file to be purchased. In a variation of this embodiment, a Music Sampler may be created by Sampler-Maker as above and streamed to requesting Nodes. Note that some instances may require that this stream be DRM-encrypted and that in such cases, the network-based control scheme may manage the acquisition of the appropriate keys.

Both composite and non-composite Sampler files, in any form, may co-exist within the Network, and that the methods that support Sampler-related activity may be controlled within the overarching control skein provided by the Network.

The Network may also manage the distribution of Sampler files. In implementations, Music Sampler files may be available to Nodes on a limited-use basis. Thus, in one example embodiment, the Network may use service-provided control documents to identify content, but may use elements of the Network-based Purchase system to control the distribution and Node-level disposition of Samplers. In the context of Nodal activity related to acquisition of content from other Nodes (noting that such dispensing Nodes may be enabled and/or may be partially-enabled and/or may be non-enabled and/or may be disabled, variously and at any time, as described above) the Network may exert control schemes related to Sampler files that are supplemental to those embedded by control elements supplied by service providers.

Thus, in an example operation in the context of the present example implementation, when a music file is requested by Node, the rule set within the service-provided control document may, in some cases, require that the subject file be provided as Sampler prior to purchase, and in this instance, Network-based mechanisms may execute and administer these transactions. But note that while in some embodiments of this example, this rule set may not be contained in the service-provided control document. In other embodiments, the presence or absence of such information in the service-provided control document may vary depending on the subject file. In both cases, however, the Node may contact the Network-based Purchase Server and may pass a supplemental control document to that Server containing information relevant to this transaction. In cases where the Sampler rule set is contained within the service-provided control document, the Node, after examining the service-provided control document, may generate a supplemental control document that may include but may not be limited to the fact that the requested file has a Sampler rule attached. In cases where the Sampler rule set may not be present in the service-provided control document, the supplemental control document generated by the Node may include but may not be limited to one or more indices related to the subject content and some or all of the service-provided control document, and the Network-based Purchase Server, upon receipt of this document, may access its own record of which files may have Sampler capability and/or requirements.

In both cases, however, the Purchase Server may check a stored record of previous Sampler transactions for that Node, and if the number of Sampler plays for the requested files has not been exceeded, may generate a special version of a purchase confirmation document described in foregoing examples. This “Sampler purchase document” conveys to the elements that control the DRM keys—in the event that the Sampler has DRM encryption—that the requesting Node may receive a license key valid for one play of the subject file. Note, however, that there may be a variety of Sampler re-play options with any embodiment of the network, including, but not limited to any or all of those noted above. Thus, Sampler re-play for one file may differ from that of another—and thus, while one file may have a composite version, another may be streamed, and the Network-based Purchase Server may convey the instructions for the acquisition and the mode of re-play of a given Sampler for a given file to a requesting Node. Note, however, that time-based and/or event-based rules may also be considered in these scenarios, and thus, Sampler re-play may be alternatively administered at different times and/or in response to different event. Note also that, as above, the Network may instantiate changes to Sampler rules based on Network-administered commodities, as above wherein such commodities may include (but may not be limited to) rewards, credits, consideration for trades and/or barters and so on. Note that any and/or all of the foregoing may be controlled by and/or administered by the Network-based Purchase systems, which may in addition generate and maintain records and/or reports of such activity.

In some implementations, since when the Network-based Purchase Server serves as the control head for these operations, it may keep a record of all Sampler transactions. Thus, if and when the prescribed number of Sampler plays has been exceeded for the subject at the requesting Node, that requesting Node may receive a supplemental control document from the Network-based Purchase Server to execute other rules than re-play. Among these rules may be re-play of a preview clip of a selected portion of the subject track-if the rule sets for the subject track allow this clip replay-wherein the preview may be obtained from any Node in the Network and/or from a Network-based Server that may stream the clip and/or from non-Network-based resources and/or from within a composite Sampler (if the subject file has been constituted such that composite contains this preview and if that file is resident on the requesting Node).

In embodiments, a Node may convert a Sampler to a permanent version of the file by means of a purchase transaction. In a manner similar to the purchase transactions previously described, in such a case, once a valid transaction has been completed, the Network-based Purchase Server may convey a purchase document to the requesting Node. But since there may be a variety of Sampler formats present in an embodiment of the network, there may be a variety of conversion operations supported, depending on the nature of the Sampler and its mode of delivery. Thus, the conversion mechanisms may be particular to the Sampler type. In the case of a streamed-only Sampler, once the transaction is successfully completed, the file may then be downloaded from one or more Nodes. If, in this case, the file is DRM-wrapped, that file may then be converted by acquisition of the appropriate license key. If the Sampler to be converted in a composite Sampler and if that composite file is of the “two-file” variety (as described in the foregoing), the converting Node may possess methods to “extract” the non-degraded file, and if that file is DRM-wrapped, the file may then be converted by acquisition of the appropriate license key. If the Sampler had been downloaded as a complete file in a degraded form, the Node may be instructed to acquire the file in non-degraded form from one or more other Nodes, and if that non-degraded file is DRM-wrapped, the file may then be converted by acquisition of the appropriate license key.

Note, however, that the Network is designed to accommodate any type of Sampler format that be developer in the future, and in these cases Sampler-Maker (if it is required in the creation of these new formats) may be configured to support these cases. In addition, the methods and or Data associated with these new types may be integrated within the Network-based Purchase system and/or within Nodes.

One embodiment of the Sampler system provides that all or part of the processes and/or data required to execute any or all of the processes associated with Samplers including (but not limited to) their creation and/or modification and/or distribution and/or replay and/or purchase-conversion be provided to Nodes at the time of Sampler replay. The parameters for this runtime acquisition of required processes (and of associated data) may be contained within and/or may be referenced by one or more supplemental control documents. In these cases, such runtime acquired processes and related data may be considered a Data Object as defined in the foregoing and may be indexed and available throughout the Network. Note that such indexing may reference the Samplers for which those processes and associated data may be operative, and that each Sampler and/or Sampler format may associate one or more such processes and associated data independently of one another. The some or all of the elements that may compose and or which may be used by and which mat be derived from these methods and/or associated data may be downloaded to the requesting Node from one or more Nodes within the Network (which Nodes may include one or more Network-based Purchase Server) at run time (but, may, in some instances be available to process and/or operate upon any and/or all Samplers and/or Sampler formats variously and at any time), and/or may be embedded within composite Sampler files and/or may be extracted from and/or derived from other methods and/or Data within the Network, at any time, as above.

In some implementations, in a further extension of the service-provided control documents provided to the NRM, in the event that musical file selected by a Node for acquisition possesses a Sampler rule set-regardless of where that information may be located, as above—the Network-based Purchase Server may substitute a Sampler file for the file requested by the Node. That is, in a process called “http re-directed download”, irrespective of the nature of the file requested—that is, its specific encoding and variations of its file name as displayed at the Node as a result of a search for content—if that file has a service-provided control document, and thus may be positively identified, and if the rules associated with that file reflect the requirement of Sampler re-play prior to download, the Network-based Purchase Server may instruct the requesting Node to substitute a Sampler for the file requested. But note that this may not always result in a downloaded file as some Samplers may be routed to a Node by means of streaming techniques. In any case, provided the rule sets permit Sampler re-play, and in respect to any mode of Sampler re-play and composition and purchase conversion to a permanent (i.e. non-Sampler file) file, the Node may be provided with access to that content by means of a Sampler, rather than to other non-Sampler encodings, regardless of whether the Node had requested an alternate (i.e. non-Sampler) version.

Note that since the Network-based Purchase Server may be involved in Sampler management, distribution, re-play and purchase conversion, and thus may maintain records that may enable execution of the relevant rules, these records may be compiled and made available to accounting and activity reporting functions as described above in relation to the purchase feature. But note also that in a further extension by the NRM aspect of the Network of the functionality enabled by service-provided control documents, such Nodal activity may be subject to additional controls, control not supported by the subsumed service-provided functions and documents.

In one example of such an extension, cited in example implementations that follow and which may be related to other aspects of the Network described therein, any “ancillary” revenue that may be realized as a result of these activities—that is revenue not related to the actual purchase of the content—may also be tracked and/or recorded and/or compiled and/or reported as such revenue may be related to and/or that may be derived and/or that may be realized as a result of activities that may be related to the acquisition, distribution, re-play and purchase conversion of Samplers. Thus, if “ancillary” revenue is realized as a result of any of these activities, the Network-based Purchase Server may monitor and store a record of the activities and the ownership information related to the subject content.

In a further extension provided to the NRM of the control capabilities that may be supplied by the means of service-provided control documents, one embodiment of Network may provide the methods, through deployment of capabilities associated with the Network-based Purchase system or other Network-based facilities (which may include one or more Nodes), for registered parties to override the rules contained in the service-provided control documents. This facility may allow eligible parties to access a Node and identify, through a specialized user interface function, content for which they own rights that may supercede those possessed by those that may have mandated rules through the service-provided control documents. In the event that such override rights exist, eligible users may “mark” content for “blocking”, and/or may additionally disallow some or all of the relevant rules. In this event, when a Node accesses subject content, the Network-based Purchase system may examine that transaction and, if a record exists that the subject file has had such an override placed upon it, the requesting Node may be instructed to obey the override rules rather than those conveyed in the service-provided control documents.

In the foregoing examples, the assumption has been that when a Node requests a music file, one or more relevant service-provided control documents may be obtained for that file. That is, the previous examples have assumed that a service-provided control document containing rules sets may be obtained when a Node requests access to a file. But, in a further extension provided to the NRM of the capabilities that may be supplied by the service-provided control documents and methods, the Network may provide additional means to obtain such the relevant service-provided control document, means that may not be possible outside the teachings of the present invention.

These methods address an aspect of the Network that may result from the fact the Network may subsume Nodes that may not be fully enabled with the methods provided by the service that conveys the service-provided control documents and methods to processes within the Network. Thus, a Node may attempt to acquire files that reside in Nodes that may not subsume all of the elements required to create and maintain and obtain these control documents. This ability to access files in non-enabled and/or partially enabled and/or disabled Nodes (as defined above) composes one extension of the Network capabilities as provided by the NRM.

In an example embodiment of these capabilities, in the event that the requested file is not recognized (and thus, the requested file thus cannot be associated with a service-provided control document) and/or if no record of that file is contained in the relevant facilities referenced by the service-provided control methods, the requesting Node may convey the absence of this service-provided control document to the Network-based Purchase system. In this example, therefore, the requesting Node may generate and transit to the Network-based Purchase system a supplemental control document and may embed within that document information relevant to the subject file, including but not limited one or more indices associated with that file and or information related to and/or which may be derived from and/or inferred from the activity surrounding the Node's request including (but limited to) text strings that may describe the file.

In response, in an example embodiment, within a secure facility—a measure provided to ensure that the file is not misappropriated before it is identified by means of a fingerprint process and/or other similar technique—the Network-based Purchase system may itself and/or may cause an ancillary but appropriately configured facility (which facility may or may not be within the Network) to acquire that file from within the Network—by definition this acquisition will be effected from a non-enabled and/or partially enabled and/or disabled Node, as noted above—ignoring the fact that the required service-provided control document is absent.

Once the file is obtained by the secure downloading facility, one or more service-provided fingerprinting identification techniques may be employed to identify the file. The secure downloading facility may then convey the derived indices to the service-provided control facility and may then obtain, if it exists, a pre-existing control document, a result that may ensue if the requesting Node misidentified the requesting file and if this were the reason a control document could not be obtained.

In the event that no such pre-existing control document is found, however, the service-provided control facility may generate and convey to the secure downloading facility a new service-provided control document. The secure downloading facility may then convey this service-provided control document to the requesting Node, and in this case, since the file is new to the system, it is, by definition unclaimed by its owner (if one exists), and the Node may then be permitted to acquire the file. But note that in some implementations, that file may be obtained by the requesting Node from the secure facility instead of from the network source. In other implementations, the requesting Node may obtain the file from one or more Network Nodes, and in other variations, the secure downloading facility may be one of those Nodes.

Note that, although in the examples cited in the foregoing, the Data Objects in any and/or all implementations of the Network, any and/or all of the foregoing methods and/or functionality may be applied to any Data type that may process non-media Data Objects may be additionally and/or exclusively applied to non-media Data; executable computer programs (including, for example, but not limited to word processing or video game software programs) may, for instance, be uniquely indexed by replacing the signal processing steps with de-compilation techniques and analyzing the concatenated instructions that compose the program, and/or certain knowledge representation techniques may be applied to text-based documents, abstracting the “meaning” of words and/or phrases based on some ontology and/or set of ontologies.

The Data Object Content-Specific Set {OC_{T}_{ᵢ}} may contain elements that comprise the next component in the Data Object Set. The elements of this set may be distinguishable from other elements in other sets by virtue of the fact that the information composed within these elements may be derived from the content within the subject Data Objects. The methods by which this information may be extracted may be common to Nodes in the Network and may be shared by both the Adaptive and non-Adaptive components of the Network. Thus, in any and/or all implementations of the Network, the distributed data storage and distributed processing model described in the foregoing may be applied to the derivation and/or disposition of the elements of Data Object Content-Specific Set {OC_{T}_{ᵢ}} and/or to the processes that may utilize these elements, and/or to the results of such processes.

Note that the following description of the derivation of the set {OC_{T}_{ᵢ}} may be germane to one set of implementations involving media files, and is presented without loss of its generality in respect to any other Data types and/or the processes that may derive and/or control and/or utilize the information related to these Data Objects. That is, any other implementation and/or variations of this implementation may incorporate some or all the described methods. Also, other implementations and/or variations of this implementation may process any type of Data using the described methods and/or similar methods that may comprise extensions. Further, note that in the following set of implementations, the subject media files may typically be audio files, but video files may be processed with related methods.

One set of methods in this particular implementation may generate the elements of the Data Object Content-Specific Set {OC_{T}_{ᵢ}} by means of content-emergent technology (such as developed by MusicIP and others), but works equally well with other similar signal processing approaches known in the art. (These algorithms are part of a class of signal processing techniques known as content-emergent processes, so-named because the data that results from the process is derived from and/or may be defined by the content itself rather than being classified and/or measured based solely on some objective criteria.)

The Data Object Content-Specific Set is distinguished by the fact that its elements provide information about the subject Data Object that is unique to that Object and/or its representation(s) as embodied in that Data Object. In some implementations, these process(es) may be used to perform computations on some portion of the information (and/or all of the information) within a Data Object and to produce a set of n orthogonal vectors (where n≧1); in these methods, each vector may be related to some feature that may be common to that data type.

While the basis of the space spanned by the matrix containing these vectors is n, some non-orthogonal variables may also be included within this Set, and the linear dependence of these parameters on one or more of the vectors may be factored (without loss of generality) into the suite of operations described herein and in the operations that may proceed from the derived data. Thus, note that the possibility of the integration of linearly dependent variables may be assumed in this and other descriptions and that the actual dimension spanned by the vectors is functionally immaterial as an element in the Network.

In one example implementation (presented without loss of generality to other embodiments of the present invention wherein alternate methods may be used to similarly process other Data types) the extracted features mapped by the vector Matrixes that may compose elements of the Data Object Content-Specific Set may be related to acoustical and/or to psychoacoustical characteristics of the subject musical track. Thus, the result of this operation is the derivation of n “attributes” derived from the musical composition of the subject track. Technology developed by MusicIp provides one example of a set of algorithms that may produce such a Matrix; such musical attributes as tempo, rhythmic elements and orchestration may measured be assigned to one or more vectors. Other technologies provide similar capabilities, and, in implementations of the Network that require instantiation of Elements within the Data Object Content-Specific Set, any and/or all of such techniques may be used exclusively of, and/or supplementally to, and/or adjunctively to any other.

In the following example implementation, and others that may follow, the elements that compose the Data Object Content-Specific Set may be embedded in one or more a vector matrices [A], where Matrix [A] may be composed of basis vectors aₙ where n is the number of orthogonal attributes derived. Note that the resolution or bit-depth of each vector may be immaterial but may be normalized throughout the system, though this requirement is not absolute and there is no loss of generality if the resolution of successive steps differs in implementations and/or variations of implementations.

Note, however, that any element of the Data Object Content-Specific Set may be represented by any structure, and there is no particular requirement that content-derived features of those elements be embedded in vector spaces and/or in matrix form. This generality is particularly true in light of the numerous types of Data Objects that may be integrated in various embodiments of the Network. Some implementations may express the attributes of a Data Object using neural-net structures, while others may use network relational techniques, while still others may use image-processing algorithms.

Further, as described below, any and/or all such techniques may be combined in any implementation. Thus, the use of vector matrices in the following derivations should not be construed to particularize the present invention, but rather should be interpreted as descriptive. In this sense, the Matrices should be considered a mathematical representation of the operation of this aspect of the Network, although some implementations may indeed use vector matrices.

One example implementation of a possible method by means of which the musical content of a Data Object (in this case a musical track) may be processed using a content-emergent technology. The attribute derivation process may produce Matrix [A]_{T}_{ᵢ} when applied to the i^{th} Track of the subject media library. Matrix [A]_{T}_{ᵢ} consists of n basis vectors and may be formally expressed as follows:
[A]_{T}_{ᵢ}={ a̅₁^{T}^{ᵢ} . . . a̅ₙ^{T}}

The derived attributes may be associated with (and/or linked with any means typically used in controlling the disposition of data structures) the subject Data Object (in this example case, this Object is the subject musical track) may be identified using one or more of the indexing methods employed to compose the Data Object Identification Set.

Note that Matrix [A]_{T}_{ᵢ}, and/or elements that reside in the Matrix and/or variables that may be derived from such elements, and/or derivative forms, and/or transformed representations of the Matrix, and/or some combination of the foregoing may themselves constitute one or more elements in Data Object Identification Set, and/or may be used by one or more processes to derive (one or more) elements within the Data Object Identification Set, where such additional processing may include (but is not limited) recursive operations integrating some or all the elements of the Matrix and/or some or all of elements from the Data Object Identification Set.

The process(es) that produce Matrix [A]_{T}_{ᵢ} may be shared by Nodes in the Network, and/or any Layer and/or Level (including either the Adaptive and/or non-Adaptive methods associated with those Layers and/or Levels) may deploy, and/or access, and/or otherwise utilize these processes, and/or may and/or access and/or otherwise utilize the results. Thus, the distributed data storage and distributed processing model described in the foregoing may be applied any implementation. Moreover, theses processes may operate in any and/or of the Modes described above (Standalone, Hybrid and Pure), variously and/or at any time.

The foregoing description of the creation of the attribute Matrix [A]_{T}_{ᵢ} may form one element of the Data Object Content-Specific Set, but note that the ability to include additional methods does not impact the role of this matrix. That is, the creation of Matrix [A]_{T}_{ᵢ} is one implementation, and others may be possible using other content-emergent techniques; thus, the specific method of derivation may be replaced others without loss of generality in respect to the role of this element in the Network.

Further, other methods may be used adjunctively to the foregoing, wherein such additional methods may augment the vector space spanned by this Matrix, and/or wherein such additional methods may introduce variables that may be linearly-related to any and/or all the basis vectors, and/or wherein such additional methods may provide additional orthogonal vectors. Note that these additional variables and/or vectors may be integrated into Matrix [A]_{T}_{ᵢ} and/or that such additional variables and/or vectors may be constituted within a supplemental structure. The elements that may be generated and/or derived to supplement the Matrix [A]_{T}_{ᵢ} may not necessarily be content-derived, but may be related to an entirely different domain. These additional variables and/or vectors may, in some implementations, integrate and/or reference descriptive structures, using (but not limited to) keywords and/or key-phrases, for example, and/or may reference any kind of other data structures that may be associated with the Object. Such additional elements may be integrated into the matrix [A]_{T}_{ᵢ} and/or may be stored or accessed adjunctively in additional Matrices and/or in similar structures.

Note also that implementations may employ adjunctive descriptions and/or processes and/or additional Matrices as a supplement to and/or as a replacement for Matrix [A]_{T}_{ᵢ} and that such methods may be used variously and at any time depending on the context in the Network without loss of generality.

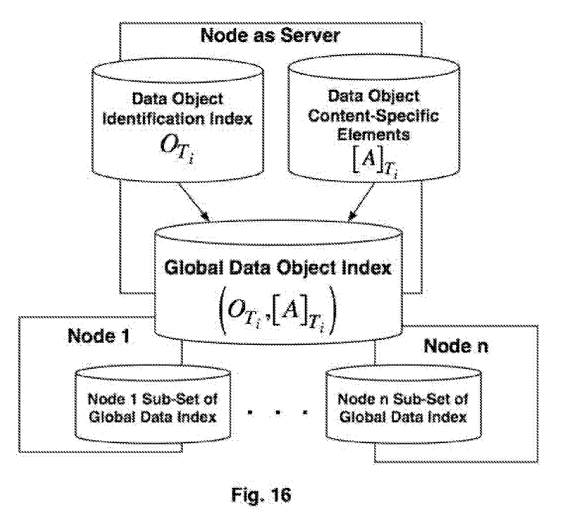

As shown in FIG. 16, the Data Object Identification O_{T}_{ᵢ} and Data Object Content-Specific Set [A]_{T}_{ᵢ} may be associated in a Network-wide Database, creating the data store (O_{T}_{ᵢ}, [A]_{T}_{ᵢ}). Note that though FIG. 16 denotes a Client-Server structure, any set of Nodes in any network topology may be used. Recalling the descriptions and drawings above (FIGS. 7-9), this Database is Global in that each Node in the Network executes functionally identical processes. In some implementations, some or all of these results may be reported to a central resource, but the results may also be stored at the Node level. But in either case, Nodes that share these methods (and/or that may share methods that may compatible with some aspect of the structure that composes the elements of the set) may access the Data Index freely (and thus, may also access the Data), and this creates a virtual Network database as detailed in the model above. The Network may deploy a search infrastructure (which may be available to Nodes of the Network or other external clients) using the techniques described herein. Aspects of Network search are described generally below.

In any implementation, the Object Identifier O_{T}_{ᵢ} and the derived Attribute Matrices [A]_{T}_{ᵢ}^{v} associated with that Object ((O_{T}_{ᵢ}, [A]_{T}_{ᵢ})) may be used by either the Adaptive and/or non-Adaptive elements of the system. Thus, without loss of generality to broader implementations made possible by additional teachings outline in this disclosure, the associated index and Data Object representation(s) (O_{T}_{ᵢ}, [A]_{T}_{ᵢ}) may be used, in some embodiments, as a specialized type of content-based, associative search and retrieval system. The Mashboxx Explore™ system is one such example where a non-Adaptive search may be performed by submitting to the Nodes within the Network the Matrix [A]_{T}_{ᵢ} (and/or some representation of the information contained within that structure and/or in its equivalent) that is associated with “seed” Object O_{T}_{ᵢ}. (But note also that since Network Nodes may share the associated methods and indexing techniques, the distributed model applies; thus, a Network search may be seen as functionally equivalent to a search performed on the local user's library.) The result of this aspect of the cited example is that the requesting Node may obtain the Object Indices of Data Objects that possess similar Attribute Matrices to that associated with track O_{T}_{ᵢ}.

Thus, in one aspect of that cited system, a user may select a musical track and search for other musical tracks that “sounds-like” a seed track based the relationship of their derived respective Attribute Matrices. Note that this type of content-based search may be extended throughout the network by application of the distributed processing model since the indices are shared throughout the network. In this manner, the Mashboxx Mashboxx Explore™ system may be extended from local node functionality to remote functions—in a feature set called Mashboxx Remote Explore™. Note also that this example is illustrative and that the teachings of the present invention extend and expand this functionality as described in the following.

Another implementation—using methods detailed the following—may also allow a user to select an image and/or a section or sections of an image and/or objects within an image and may search for other Data Objects and/or for elements within a Data Object that may have elements as reflected in the respective Attribute Matrices. Other implementations may also permit a user to select a document and/or a section of a document and/or groups of documents and search for Data Objects that have similar attribute matrices. Moreover, these and other implementations may perform attribute matching on mixed media files. Some or all of these implementations may be integrated variously and at any time within the operation of the Network.

When taken alone, these implementations compose a type of associative, content-based indexing that is non-Adaptive in that the operation does not, by itself, imply any further transformative action than that related to finding, evaluating and delivering the indices of the appropriately referenced Data Objects. But the present invention may also reside in the integration of the particular qualities of various Attribute Matrices, and the following examples and descriptions illustrate these teachings.

FIG. 17 shows one implementation wherein the identifier O_{T}_{ᵢ} for Object Tᵢ may be extracted and submitted to a central storage point in the Network (shown in FIG. 17 to be an “Attribute Server”). Using this identifier, the Server returns the Matrix [A]_{T}_{ᵢ}, if the Object Tᵢ has already been ingested into the Network. If not, the local Node generates the Matrix [A]Tᵢ, may append this Matrix to the Object identifier O_{T}_{ᵢ} and stores this pair locally. Further, the mode passes the Matrix [A]_{T}_{ᵢ} and the identifier O_{T}_{ᵢ} to the central data storage.

(Note, however, that since identical processes may be present at every Node in the system, as illustrated above, the Data Objects and the associated indices and attributes matrices may be “virtual” across the Network. FIG. 17 shows how one implementation permits the network-wide integration of these processes with the use of a central storage point, but this central storage may not be necessary in some implementations.)

In implementations, each member element of the Data Object Identification Set may be associated with an element in one or more of the Data Object Content-Specific Set(s). Thus, the unique identifier O_{T}_{ᵢ} composes the first element in a set of ordered pairs wherein that identifier may be associated a unique elements within one or more of the Network Content-Specific Matrices [A]_{T}_{ᵢ}^{v} where v≧1 and represents the v^{th} attribute Matrix [A]_{T}_{ᵢ} as it applies to the i^{th} Object in the Network.

In this way, the elements that compose the Data Object Identification Set and the Data Object Content-Specific Set(s) form a set of ordered pairs, (OA)_{T}_{ᵢ}^{v}. This order pair relationship may be formally expressed:
((O_{T}_{ᵢ}, [A]_{T}_{ᵢ}¹) . . . (O_{T}_{ᵢ}, [A]_{T}_{ᵢ}^{v}))=(OA)_{T}_{ᵢ}^{v}

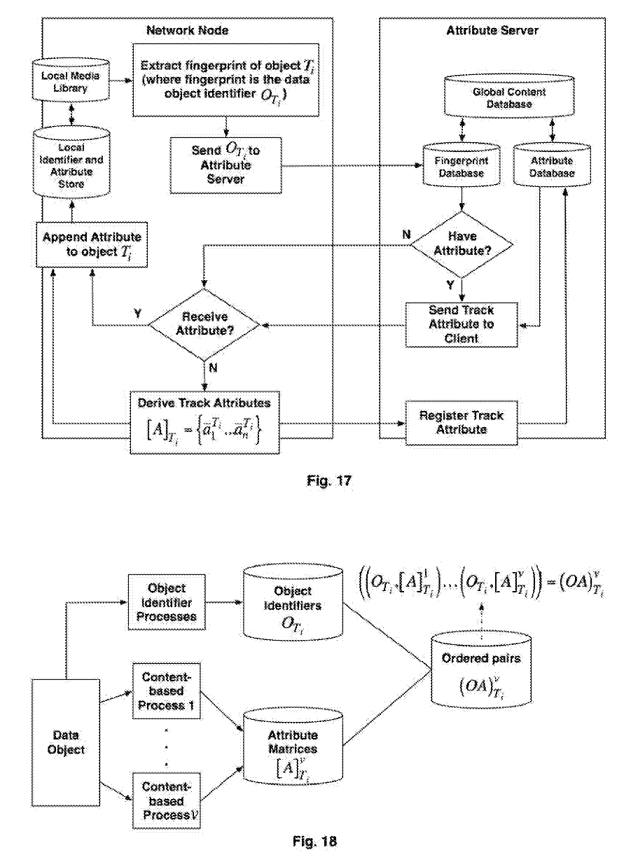

FIG. 18 shows how the Network may store these ordered pairs. Note that any number of Attribute Matrices may be associated with a Data Object, and such relationships result in any number of ordered pairs.

Thus, note that Matrix [A]_{T}_{ᵢ} may also be represented [A]_{T}_{ᵢ}^{v} where V represents the v^{th} attribute set of Matrix [A]_{T}_{ᵢ} as it applies to the i^{th} Data Object in the Network. Thus, in some implementations, there may be multiple attribute matrices associated with a given Data Object. Therefore, without loss of generality, the Matrix [A]_{T}_{ᵢ} may be understood to represent more than one matrix associated with a Data Object.

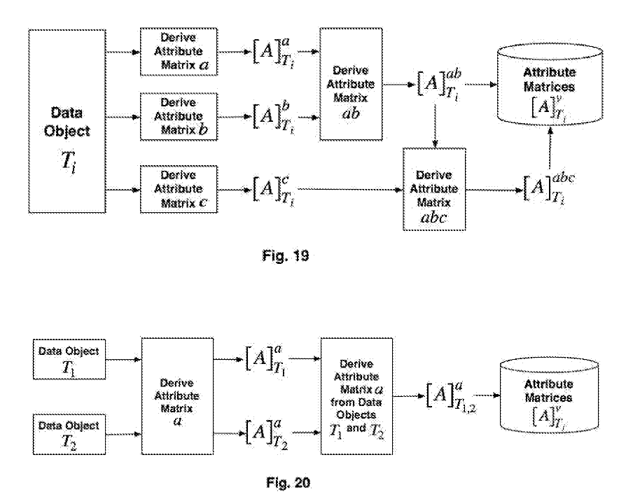

In some implementations, an Attribute Matrix may be derivative of one or more other Attribute Matrices, where the derivation process may use some and/or all of the elements of any and/or all other Attribute Matrices. The derivation processes that may be used in these implementations may include any compatible computational algorithm and/or sets of algorithms (and/or sections or portions of one or more algorithms), without limit, and as may be required to instantiate features and functions associated with an implementation of the Network and/or with any of its constituent elements. FIG. 19 shows how such derivative Matrices may be instantiated.

Implementations that instantiate methods as illustrated in the example in FIG. 20 may be more generally described as producing a set of one or more Attribute Matrices that may be derived from one or more “seed” Matrices (and/from one or more elements within any of these “seed” Matrices—where such an operation may include selecting and/or operating upon one or more elements from one or more Matrices), and these results (and/or one or more element from these results) may be used to constitute yet another set of one or more Matrices—Matrices that may then be subject to further processing and/or which may “seed” the creation of additional Matrices.

A taste infrastructure may be deployed on the Network using derivation and manipulation of attributes and Matrices as generally described herein. The taste infrastructure may use individual file attributes, aggregate file attributes for a Node or user, aggregate attributes for a neighborhood within the Network (such as a neighborhood of related Nodes), and/or normative classifications to support a search management infrastructure. As will be appreciated in the following description, the taste infrastructure may adapt dynamically to user and community activities including media search, media acquisition, media consumption, and explicit user preferences.

In implementations, this set of methods may be called “chaining”, but this term should not be understood to limit the variations to linear combinations. These “chained” derivation operations may also, without limit and/or in some combination (and/or may, in addition) integrate circular and/or recursive computations.

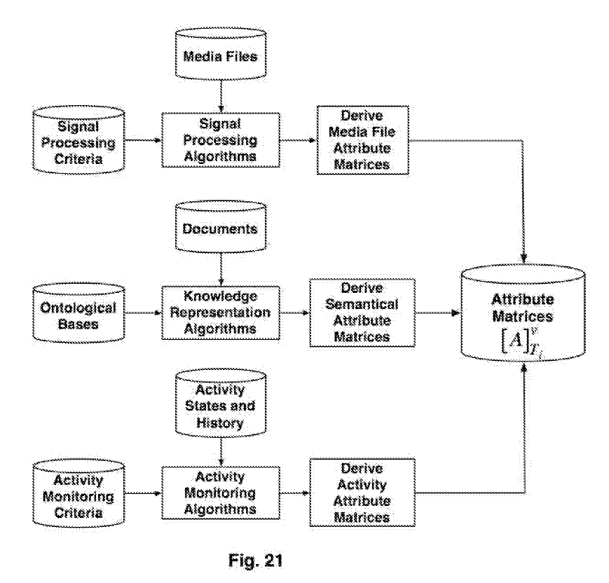

Note also that, in variations of these methods, one or more Attribute Matrices from one or more Data Objects may be combined with the one or more Attribute Matrices from one or more different Data Objects to form one or more Attribute Matrices. An example embodiment of such a process is shown in FIG. 21. Data Objects T₁ and T₂ may be processed to produce Attribute Matrices [A]_{T}_{₁}^{a} and [A]_{T}_{₂}^{a}; these Matrices may be derived (in the example below) by one or more methods that reference the Objects to generate a unique Attribute Matrix a for each Object. But, as shown in FIG. 20, a further process may then derive Attribute Matrix [A]_{T}_{_{1,2}}^{a}.

Note, however, that Matrix [A]_{T}_{_{1,2}}^{a} may also be derived by operating directly on the subject Data Objects, successively and/or in some combination and/or recursively. Note also that the subject Data Objects may be of any type and/or may be of different types, and that different derivation methods may be combined in the “chained” results.

Further, implementations may embody one or more methods wherein “chained” Matrices compose one or more elements in a “feedback” configuration. In these embodiments, results from “downstream” processes may be “fed-back” to one or more “earlier” processes and/or to “later” processes (“feed-forward”), and/or to adjunctive processes (which adjunctive processes may or may not be related to the derivation of the original “seed”) such that one possible result may be a modification and/or transformation of any and/or all of the elements within any and/or all of the participating Matrices.

Moreover, “chained” configurations that include “feedback” and/or “feed-forward” functionality may produce changes and/or modifications and/or transformations to Matrices that may not be participants in the “chain”.

In some implementations of “chained” processes (including those that may incorporate “feedback” and/or “feed-forward” embodiments) the associated processes (and/or other unrelated processes) may additionally and/or supplementally and/or exclusively modify any and/or all of the processes in the “chain”, and/or may modify (as in the foregoing) any and/or all the processes that may be used to produce data structures as described in the foregoing. Thus, “chaining” methods may also transform and/or otherwise modify both Data and/or processes, whether that data and/or process is specifically involved in the “chain”. Note further that in any implementation, variously and at any time, such transformations may be temporary and/or permanent.

Note also that “chaining” Matrices may not produce a Matrix as defined in the foregoing, but may alternately and/or supplementally produce a set of one or more data structures that may not compose a set of vectors, but which may compose information represented in other forms. Such forms may include (but may not be limited to) any mathematical result and/or quantity and/or measurement criteria, and/or may include text, and/or phrases, and/or variables and/or links to other data. Any and/or all of these results may be accessed by and/or utilized by any method within any Layer and/or Level within the Network, and in the context of any Mode (Hybrid and/or Standalone and/or Pure) variously at any time, depending on the context and or requirements of an implementation.

In some implementations, one structure that may be functionally equivalent to Attribute Matrix [A]_{T}^{ᵢ}^{v} may be a neural net structure wherein the “neurons” within the net represent the orthogonal spaces spanned by the vectors and wherein the strengths of the connections are embodies within the weights that associate these neurons. Such a network may be derived in some cases from one or Attribute Matrices, but some implementations may derive one or matrices from the Network.

In some implementations, the Data Content-Specific Set may compose information derived from associated Data Objects, wherein the derived data may be either “static” and/or “dynamic”. The term “static” may be understood to mean that the information in a Matrix is dependent only on the information contained in and/or represented by the data that composes the Data Object, and the term “dynamic” may be understood to mean that the information in a Matrix may, in addition to and/or instead of being “static”, may change based on factors not exclusively derived from the information in the associated Data Object. Note that in some implementations, a Matrix may variously and at any time become either static and/or dynamic, depending on the context and requirements of an implementation.

But note also that any and/or all such Matrices (and/or any and/or all data structures that may be derived from any of these operations—as described above) and/or any and/or all of the processes that may be associated with these Matrices (as described above) may be “dynamic” by virtue of changes and/or transformation engendered by any process and/or by any activity, whether or not that process and/or activity is subsumed within the Network, and/or whether or not that process and/or activity is related to the creation of and/or derivation of those Matrices. Such changes may originate from and/or may be influenced by methods related to the “Fixed” Layer of the Network, for example, and/or may be the result of user and/or Network activity, which activity may take place in and/or may be inferred from activity the local or Node and/or which may take place in and/or may be inferred from activity at remote Nodes.

In the following descriptions of various implementations and embodiments of the Network, therefore, the methods and/or activities related to elements of the Data Object Content-Specific Set assume the variations made evident in any/and or all these “chaining” methods described in the foregoing, noting that any and/or all of the elements of that Set may be derived, and/or modified by any and/or all of these methods, variously and at any time, depending on the context and/or requirements of an implementation.

While in the foregoing description of the derivation of (O_{T}_{ᵢ}, [A]_{T}_{ᵢ}) and the associated processes by which those sets may be derived and/or may be processed (and in some of the implementations that may be described in the following), media files and associated signal processing methods have been and may be cited, other operations may also be used to derive the Matrix [A]_{T}_{ᵢ}.

Thus, a variety of techniques may be applied in any implementation to non-media Data Objects, and in fact to any Data Object within the Network. In general, such processes may be aligned to the type of information embedded within subject data Object, but this may not always be true. There may be instances and/or embodiments of the Network wherein one or more processes that may apply generally to a certain Data Object type may also be applied to others. In some of these instances, there may be one or more adjunctive and/or supplemental “transformative” processes applied to the subject Data in order to apply such methods. One example of such a case may be seen in the application of time-series mathematical algorithms to text documents wherein the text first may be transformed by some normative process such as encoding of words within the text into symbols.

Note, therefore, that some implementations may employ a collection of one or more methods to derive the attributes from Data Object and that the application of these techniques, individually, and/or in any combination in any order may produce the results that may be integrated into one or more Matrices (wherein any and/or all of the variations previously described may apply).

Of particular note is a group of methods that may be used in any implementation wherein one or more attribute Matrices [A]_{T}_{ᵢ}^{v} may be derived using formal and/or relational knowledge representation. These techniques may provide one set of mechanisms by means of which methods throughout the Network may operate upon and/or may interact with any and/or all of the Matrices within a Network. Such implementations may embed either the implied or inferred “meaning” of the subject data, and/or may provide a basis to infer such “meaning”.

One set of implementations may use knowledge representational techniques to provide the means to integrate text-based documents within the operations associated with the Network, and these methods may be applied exclusively and/or additionally and/or supplementally to other techniques. In such embodiments, the Matrices that may form one or more elements in the Data Object Content-Specific Set may integrate abstractions of “documents” and/or groups of “documents” (where the term “document(s)” may refer to Data Objects that may contain text).

These processes may use semantical and/or inference methods and/or knowledge representation techniques to derive one or more attribute Matrices [A]_{T}_{ᵢ}^{v}, and/or may embed such representations in data structures and/or in processes that may be used by and/or referenced by methods associated with Data Objects (including but not limited to the “chaining” methods cited in the foregoing).

Thus, in one such implementation—but many others may be others possible—in a manner that may be seen as analogous to the manner in which signal processing techniques (including but not limited to those described above) create a media “attribute” matrix, knowledge representation techniques may be used to derive a set of semantically meaningful “attributes” from one or more documents and/or from sections one or more documents.

The ontological underpinning of these semantical definitions may be defined arbitrarily to fit the requirements of any implementation system. Alternatively and/or in a supplemental fashion, an ontology may be joined with other ontologies, creating any number of associated attribute Matrices [A]_{T}_{ᵢ}^{v} where the association may be defined by the individual ontologies and/or by a union of the subject ontologies and/or by one or more ontologies that may be derived from such a union, and/or by a disjoint set of one or more ontologies.

These ontologies may provide one or more semantical bases and/or one or more semantical relationships (and/or groups of semantical relationships) that may be defined as “objective” (where an “objective ontology” may be understood to mean an arbitrary system generated from factors outside the Network) and/or may be defined as “subjective” (where a subjective ontology” may be understood to mean that a system that may be derived from and/or may be inferred and/or may have elements derived from and/or inferred by activity within the Network). Some implementations may integrate “hybrid” ontologies and/or groups of “hybrid” ontologies where “objective” and/or “subjective” ontologies may be integrated and/or combined.

In any of these cases, the ontological system(s) may be derived from a document and/or groups of documents, and/or from any collection of Data Objects, and/or from any emergent behavior and/or activity within the Network, and/or any Node and/or groups of Nodes, and/or may be arbitrarily generated according to criteria external to the Network. Thus, in one aspect a classification scheme may be provided (however derived) for use by the taste infrastructure, search infrastructure, and so forth. This classification scheme may support other operations of the Network by providing a static or dynamic global reference for content distributed across the Network.

Note, however, that in the same manner that the various methods described in the foregoing apply equally to these type of Matrices, and/or to data structures that may be result from operations that may be related to (and/or may be derivative) of processes that may be associated with these Matrices (wherein the semantical relationship(s) that may result from these ontologies may be used and/or operated upon (as described in the foregoing, including but not limited to various “chaining” methods)), these same methods may also be applied to modify and/or update and/or otherwise transform one or more of the ontologies that may provide the basis for these semantical definitions.

In this sense, any or all of these ontologies, and/or derivations of these ontologies, (including but not limited to schemas that may result from unions of the discrete ontologies) may be treated in implementations, as a Data Object and may therefore be treated as any other Data Object in the system, as described in the foregoing.

Implementations that integrate one or more of these knowledge representation Matrices [A]_{T}_{ᵢ}^{v} may associate and/or may align with and/or impute and/or imply a semantical basis and/or semantical relationship (as defined by any set of one or more ontologies) with any and/or all of its own the component vectors, and/or with any and/or all of the elements that may compose any and/or all of the Matrices [A]_{T}_{ᵢ}^{v} within the Content-Specific Set.

Thus, in one example implementation, Ontology A may define the semantical relationship between a set of text strings (denoted in this example as S₁ . . . Sₙ where 1≦j,q≦n), such that IF Sⱼ-<S_{n-q}, THEN Proposition X is true. Process A may detect the presence of this relationship and assert Proposition X. Representation techniques may embed any of all of these relationships within any structure and/or within one or more Attribute Matrices [A]_{T}_{ᵢ}^{v}.

In another set of implementations, video and still images may be similarly processed using, for example block-encoding and/or object-encoding techniques—or any other image processing technology—wherein some set of Matrices [A]_{T}_{ᵢ}^{v} may embed representations of the attributes and/or nature and/or the inferred or implied nature of the images and/or components of the images and/or Objects and/or segments within an image, and/or a sequence of images and/or non-sequenced groups of images.

Another implementation may join the representation of these images and/or elements within these images with semantical meaning(s) derived an ontological system or systems as described in the foregoing, and the derivative semantical basis may be mapped to the images processed (as described above). Note, however, that any and/or all of the variations described in the foregoing may be applied to these processes, as well.

In one example implementation, an image-processing algorithm may be employed to identify instances of an American Flag in digitized photographs. Such a pattern may be embedded within an associated Attribute Matrix wherein the degree of correspondence of a given image (and/or image segment) to a set of one or more archetypical “Flags” may be reflected in one or more vectors within one or more Matrices. (Note that this an example and that the normative aspect may be instantiated in and represented by any number of techniques.) Another set of Matrices may be instantiated that instantiate the “meaning” of this image (and/or image segment) and/or the degree of correspondence of that image to one or more of the archetypical “Flags”, wherein that “meaning” may be derived from one or more ontologies as described in the foregoing. In one possible example of this type of embodiment, a process may be reference any and/or all of the relevant matrices (and/or may reference other non-related matrices) and may present a user with “patriotic” music whenever they access a qualified object. Note that the definition of “patriotic” may be defined the relevant ontologies and the degree of correspondence of any musical Object (as reflected in its associated Attribute Matrix) to such a definition may be used the “appropriateness” of its inclusion.

Thus, in the foregoing example embodiment, the one or more ontologies may be used to instantiate one of more “semantical” Attribute Matrices [A]_{S}^{v}; these Matrices [A]_{S}^{v} may be used by Process A that may additionally access one or more attribute Matrices [A]_{P}^{v} that may be derived from photographs in the Network. Process A may embed and/or may reference some normative data store, and in the event that a Data Object Tₚ (from which one or more Matrices

$${[ A ]}_{{P}_{{T}_{p}}}^{v}$$

may be derived) meets a normative threshold, may then determine that Data Object Tₚ (and/or some segment of Data Object Tₚ) is “patriotic”. Process A may then access one or more Attribute Matrices [A]_{M}^{v} that may be derived from musical files within the Network, and in the event that a Data Object Tₘ (from which one or more Matrices

$${[ A ]}_{{M}_{{T}_{m}}}^{v}$$

may be derived) meets another normative threshold, may then determine that Data Object T_{M} is also “patriotic”. Thus, Process A may then access Object Tₘ whenever a user (and/or process) accesses any photograph Tₚ adjudged to be “patriotic.

In one example an extension, Process A may integrate user feedback to define and/or refine the normative elements that determine whether a particular image (and/or particular image segment) and/or musical Object (and/or segment of a musical Object) is indeed “patriot”.

Note that in the foregoing example, Data Objects Tₚ and/or Tₘ may be replaced, and or supplemented by any Data Object, including, for example, a text document. Thus, by any number of means, a user may activate Process A (and thus be presented with an appropriate image and or music piece) by accessing a document that may be adjudged by Process A to be “patriotic” (by means of one or more derived Matrices associated with that document and/or that may be associated with data related to that document).

Note also that Process A may be configured to execute the foregoing logic whenever any of the relevant Objects are accessed, in any order and, variously and at any time, depending on the context and requirements of a particular implementation.

This simple example may illustrate the manner in which the elements of discrete Attribute Matrices may be used by processes to execute associative functions, but note that many more applications become possible in the context of the Network. Thus, the foregoing example should not be construed to limit application of the present invention to other functionality beyond association of Objects and/or Activity. The concept “patriotic” may equally be replaced by “baseball”, for example, but more generally, Process A may perform any operation within the Network, related without limitation to network activity, node activity and node-relational activity.

Thus, the foregoing example provides one explication of the manner in which implementations may use Attribute Matrices of any type, derived from by means of any number of methods and applied to any Data Object, and the means by which these structures may be related to any activity within the Network.

Note also that any and/or all of the foregoing may additionally and/or adjunctively be integrated with “training” methods wherein either user inputs (and/or inputs harvested from groups of users) and/or inputs related and/or derivative of processes within the Network may influence and/or may be used as a factor in any and/or all related logical decisions. In this manner, some implementation may integrate and/or may utilize any number of feedback and/or feed-forward techniques known in the art wherein either Data and/or processes may be updated, amended and/or otherwise transformed.

Further, note that such methods may be exclusively and/or adjunctively supplemented and/or replaced by other methods that provide the means to account for and/or factor user-derived and Node-level-derived and/or Network-level derived behavior in these operations, and that such methods may be used variously and at any time, depending on the context and or requirements of an implementation.

Note further, that any and/or all of the component Data Objects and/or Processes and or Attribute Matrices in the foregoing example may be integrated variously and/or discretely separately in Nodes within the Network, and that access to these components may be “virtual” as modeled in the distributed data distribution and distributed data processing model outlined in the foregoing.

Note finally that any and/or all of the component Data Objects and/or Processes and or Attribute Matrices in the foregoing example may be accessed by any and/or processes and/or Data Objects that may be modeled as residing in any/or all of the Levels and/or Layers in the Network. Note also that such implementations may be embodied in Node that may be (variously and at any time) in any of the Modes cited in the foregoing (Standalone and/or Hybrid and/or Pure).

In another set of implementations, the Matrices [A]_{T}_{ᵢ}^{v} may be created by application of any and/or all of the methods cited in the foregoing (variously and at any time, depending on the context and requirements of an implementation) to mixed media documents and/or to groups of mixed media documents, where “mixed media” may be understood to refer to documents that may embed text and/or images, and/or video and/or music and/or speech.

Note, therefore, that one or more such Matrices may be created for any Data Object, using methods appropriate to one or more sections of such Objects. In one example implementation, let Data Object O subsume text T and photographic images P, although any other types of data that may represent any type of information may be thus contained. Examples of such Objects and/or such constituents may include (but may not be limited to) Powerpoint documents, word processing documents, HTML files, Flash animations, WMA-encoded audio, Quicktime-encoded videos, and so on. In the present example, one or more processes may create one or Attribute Matrices for Data Object O and/or for each sub-section within O. With respect to the sections of O that may contain text, one or more knowledge representation processes may be applied to the text T and may generate one or more Attribute Matrices [A_{T}^{out}^{_{z}}]_{O}^{v} where T may refer to an text-based process that may generate this Attribute Matrix referencing Ontology ont_{z} and which is the v^{th} such Matrix derived from Object O. Another set of processes may be applied to the photographic images P within Object O and may generate one or more Attribute Matrices [A_{P}^{image}^{_{w}}]_{O}^{t} where P may refer to the imaging process that may generate this Attribute Matrix using image parameters image_{w} and is the w^{th} such Matrix derived from Object O. Note that another Matrix may be generated and associated with O that may subsume these text and image derived Matrices, but in other cases, these “elemental” Matrices may additionally exist independently. Some implementations may allow both cases.

Note also that such “mixed media” Data Objects may also encompass instances wherein discrete Data Objects that may embed one or more of the foregoing elements may be linked and/or otherwise associated dynamically (that is, at run-time) and/or permanently. Any and or such linked Objects may be have one or more associated Matrices that may link to one or more other Data Objects, creating a suite of linkages that may supplement and/or may extend and/or may replace other such linkages that may otherwise exist. But note also that such “layered” linkage may be applied to any Data Objects within the Network.

Note further that any Data Object may have one or more or more associated “metadata” files where “metadata” may encompass Data Objects that contain information about and/or which may reference one or more information sources about the associated Object. The “layered” linkage described in the foregoing may be extended to include such metadata. Note that some implementations of the Network may treat such metadata files as Data Objects, and thus may be linked and/or layered, as above. In other cases, the metadata may be contained within the Data Object and in these cases, one or more processes that may locate and/or interpret the information within these metadata files may be integrated within the present processes. In all cases, the subject metadata may be subjected to one or more processes that may generate one or more Attribute files for that information and may link such files to one or more Data Objects. But in some cases, generation of such Matrices may not occur but instead, the information within the metadata files may be used to create “layered” associations, as above, using one or more data processing processes. In other cases, such linkages may co-exist with Attribute Matrices.

In practice, extending the previous example, let Object O be composed as above and let there be n metadata files Oₙ associated with O. Let Metadata File 1 be a text file that may describe the content of O and its relationship to some indexing scheme where the index may be called I. In an example implementation that illustrates these teachings, let Process 1 be applied to metadata file 1 such that it generates Attribute Matrix 1. Let Metadata File 1 also contain a reference to the embedded photographic images P within Object O. Let Process 2 be applied to the relevant portion of Metadata File 1 such that it may generate Attribute Matrix 2. Let Process 3 operate on Index I to create a linkage with the Object Identifier(s) associated with Object O, and thus with the various Attribute Matrices associated with O, as described above. But note that in some implementations and/or in this implementation but in respect to another Object P, the metadata associated with P may not be deconstructed, as above, but may be encoded, using one or processes, into one or more Matrices and/or similar structures.

FIG. 21 shows an example implementation wherein one or more Attribute Matrices that may be embodied within the Network. Note, however, that other implementations may deploy additional processes to create other Matrices and similar structures, without limit. Note also that there are implementations wherein these disparate processes (which may be used to operate upon various Data Object types thereby producing the respective matrices germane to those Objects) may be combined with additional processes wherein “hybrid” matrices may be produced, combining the attributes of several media types.

In some implementations, the Attribute Matrices within the Network may have associated identifiers and in this way may themselves be treated as Data Objects. In such configurations, the matrices may be shared between Nodes within the Network without the requirement of sharing the referenced Data Object. Thus, Attribute Matrices may assume all the characteristics of Data Objects and may, in some cases, serve as the basis of a further abstracted Attribute Matrix.

One such implementation may be seen in the Mashboxx Explore™ system wherein one or more Attribute files associated with one or more musical files are passed to nodes within a Network and wherein the receiving nodes performs a matching processes with its local attribute files. The receiving nodes return the index (and/or associated data) of such matching files to originating node. In one variation of this implementation, the Attribute Matrices (files) may be indexed as described and treated, in the system as Data Objects.

Note also that processes may be deployed that monitor the disposition and the patterns with which users and/or groups of users interact with matrices, in a manner that is similar to the means by which processes may monitor the disposition of Data Objects.

In a variation of the example implementation (as may be seen in the Mashboxx Explore™ system) note that there may be mechanisms whereby a user may optionally modify and/or adjust the Attribute Matrices associated subject media. Further, in some embodiments, an additional suite of Matrices may be created that embody so-called “editorial” factors, where such factors may include (but may not be limited to) user comments and/or evaluations and wherein such factors may be converted and/or transformed by some ontological system (whereby “meaning” is defined and ascribed to the subject media). These factors may be embedded in this “editorial” matrix and may be used to calculate inclusion criteria and/or to prioritize presentation of included media.

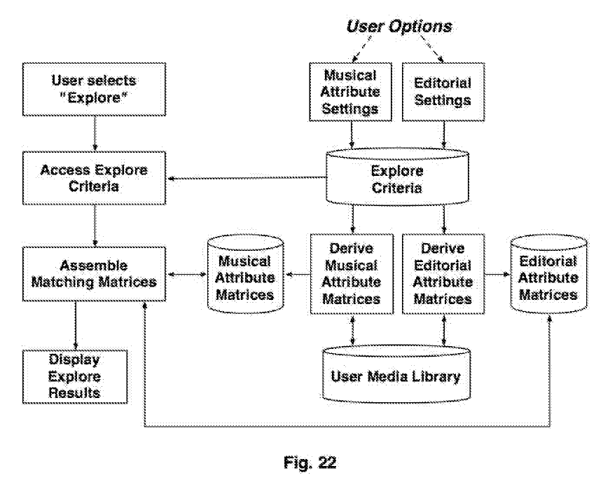

An example implementation of the Mashboxx Explore™ system is shown in FIG. 22. Note that, in accordance with the distributed processing and data store model described in the foregoing, the example implementation embodied in the Mashboxx Explore™ system provides the basis for users in the Mashboxx Network to discover content throughout the online world by mapping its methods to existing content acquisition techniques. That is, a user may select a Data Object and select “Explore” as shown in FIG. 22.

The Mashboxx Explore™ system may display Data Objects to users, which “match” (according to some set of criteria) the Attributes of selected Data Objects, regardless of the location of those Objects within the Network. Functionally, this method is analogous to network-based content search based on text strings or service hash (such as may be used in peer-to-peer file sharing networks), but rather than matching metadata-based text strings or hash number, this implementation uses Attribute Files and/or some derivation for of the information contained therein) as a basis for search and matching.

Note that variations of the example implementation embodied in the Mashboxx Explore™ system may combine any number of Attribute Matrices associated with Data Objects within the system, including (but limited to) those that may be derived from the activities of users and/or groups of users. Such variations may additionally or alternately combine any Attribute Matrices variously and at any time, depending on the context and requirements of the implementation.

In some variations, Attribute Matrices for identical but discrete Data Objects distributed within the Network may be transformed and/or may be modified and/or may evolve differently at different nodes. Associated “change” or “delta” files that measure the differences between the original instantiation of the Attribute Matrices and a transformed version may be used to interpret Attribute Matrices that may be subject to such “uneven” evolution and wherein additional “normalization” processes may be instantiated. In this way, a normative basis upon which to operate on distributed files may be propagated within the Network.

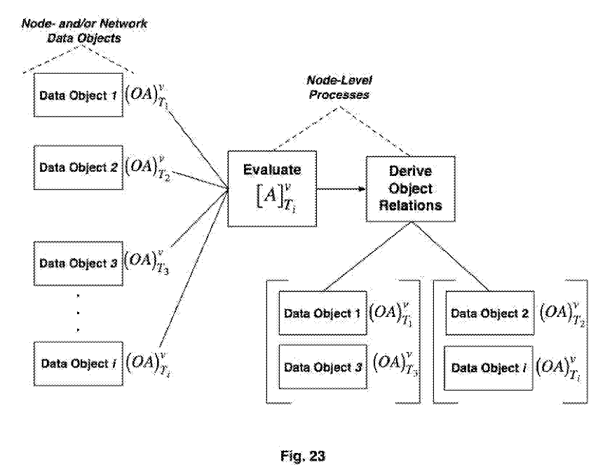

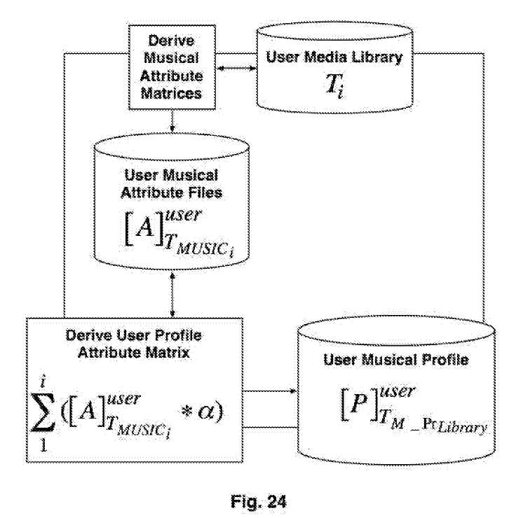

In implementations, the set (OA)_{T}_{ᵢ}^{v} may be used to associate Data Objects by a method called “Object Attraction”. In these implementations, Nodes in the Network may share a process that measures the relationship between the Matrices [A]_{T}_{ᵢ}^{v} associated with the various Data Objects in the Network. By means of this evaluative process, the relationship between Objects indexed by O_{T}_{ᵢ} may be measured, and, in implementations, those Objects may be sorted and/or ordered. Implementations of that use “Object attraction” may follow the flow outlined in FIG. 23.

In implementations, the evaluative process may operate on the abstractions associated with any of the Data Objects (which abstractions may be embedded within Matrices [A]_{T}_{ᵢ}^{v}) rather than the data itself. In variations, the “Object attraction” methods may be used exclusively or in a supplemental fashion to other data mining techniques and/or with any “collaborative” filtering techniques, variously and/or sequentially and/or at any time.

Note that either the “Fixed” Layer or the Adaptive Layer of the Network may use the elements within Data Object Identification Set and the Data Object Content-Specific Set (s) variously, at any time. Likewise, within the Adaptive Layer, either the Adaptive and/or the non-Adaptive level may use the elements within these sets variously and at any time.

In some implementations, it may not be required that every Node in the Network instantiate any or all of the processes that create and process the ordered pairs (OA)_{T}_{₁}^{v}. In these implementations, one or more non-enabled computing platforms may access enabled Nodes, and/or enabled Nodes may contact non-enabled platforms, and in these implementations, that connection may create a form of the Network as described in the foregoing.

One example of such an implementation could be a Web Site (which would comprise a “Node”) that provides both enabled and/or non-enabled clients access to Data Objects that have been processed such that any or all of these Data Objects possesses an associated ordered pair (OA)_{T}_{ᵢ}^{v}. In this instance, this Web Site may itself be considered “hybrid” in that it may appear enabled for enabled Clients but non-enabled to others.

In such example implementations, when any Client (either enabled or non-enabled) accesses such a Web Site, the Server-side process may classify and/or present its Data Objects using the “data attraction” method, and/or using some combination of that method with other methods. Note that such a Hybrid Server may provide different functionalities to enabled Clients than may be provided non-enabled Clients. Note also, that such different capabilities may be available variously and at any time, depending on the context and requirements of the implementation.

In some implementations, the “data attraction” method may be used in conjunction with and/or as a supplemental element with known search techniques and/or collaborative filters wherein some type of user profile and/or user history and/or usage and/or consumption pattern of the subject user and/or other users and/or groups of users may be used to condition and/or filter and/or order and/or otherwise manage the presentation of information germane to any of the Data Objects and/or to search strings that may be submitted to the Server.

The use of the “data attraction” methods in this manner and in these implementations may be called “one-sided” in that the processes that compose those methods associated with “data attraction” may be present on one Node and not on another. In this sense, the “data attraction” methods may be seen as generally applicable where only one Node must be enabled. Thus, without loss of generality to any implementation, the following descriptions may be considered to as applying to Network operations (wherein two or more of the Nodes subsume the processes) and/or to “hybrid” interactions that may at times, in relation to certain clients, “one-sided” (where one or more Nodes implement the process but some may not.

In some implementations, the Matrices [A]Tᵢ^{v} may be used in a “Fixed” mode in that user and/or system-related activity does not change or alter the composition of the embedded attributes. In these implementations, the “data attraction” methods may be seen as residing in the “Fixed” Layer described in the foregoing (see FIGS. 1-3). Alternatively, these methods may also be seen as residing in these “n the Adaptive Layer but as non-Adaptive components. In this manner, the “data attraction” methods may be implemented as supplemental to and/or may be used alternatively and variously at any time (depending on the context) with other Adaptive and/or non-Adaptive elements.

Alternatively, in some implementations of the methods associated with “data attraction”, one or more Nodes may integrate processes that permit any or all user and/or system-related activity to modify any or all of the attributes associated with any or all Data Objects (and which are embedded within one or more Matrices [A]_{T}_{ᵢ}^{v}), and/or may integrate processes which may alternatively and/or in a supplemental fashion, variously and/or at any time permit manual (that is, by a user or a network operator) and/or conditional modification of the Attributes. In such implementations, the “data attraction” methods may be seen as residing in the Adaptive Layer of the Network and as forming an Adaptive component.

In implementations, such modifications to one or more Matrices [A]_{T}_{ᵢ}^{v} may result from detection of the presence and/or absence of some condition and/or set of conditions that may (or may not) be related to the Data Object and/or to the user and/or to any information pertaining to Network, the Node (enabled or non-enabled), and/or to the Data Object. Such conditions and/or information about such conditions may be contained in and/or may be referenced by data within the Matrices [A]_{T}_{ᵢ}^{v} and/or may be related to and/or may be linked by external data and/or documents, which are referenced to the relevant Data Object, and/or Data Objects and thus to one or more related Matrices [A]_{T}_{ᵢ}^{v}).

Thus, the Data Object, Data Object Identifier Set, and Data Object Content-Specific Set(s) and the derivative ordered pairs (OA)_{T}_{ᵢ}^{v} may be alternatively “Fixed” and/or Adaptive, and thus may be modeled as being part of other the “Fixed’ Layer and/or the Adaptive Layer (and in the latter case, may be implemented as either Adaptive and/or non-Adaptive). Further, any of these implementations and any of the models by which they are expressed may be implemented in a standalone fashion and/or may co-exist variously and any time, depending on the system context.

In some implementations, the Attribute Matrices derived from one or more Data Objects within a Node may be “summed” and/or aggregated by means of one or more processes, thereby creating a Node-level “profile” (and/or a user-level profile if there are multiple users on a Node—and in the following descriptions of this aspect of the Network, these terms may be used interchangeable without loss of generality). Note that in some implementations, there may be any number of means to create this Attribute Matrix [A]_{T}_{ᵢ}^{Node} (where the superscript Node may be replaced by “User” in some embodiments), and that this structure may itself be treated as a Data Object and assigned an index. In this sense, Attribute Matrix [A]_{T}_{ᵢ}^{Node} may be viewed as available throughout the network in the context of the distributed data and distributed process model.

Thus, Profile Matrices in some implementations, may be represented by

$${[ P ]}_{{[ A ]}_{T}^{v}}^{Node ( s )}$$

where the subscript [A]_{T}^{v} refers to one or more of the V Attribute Matrices derived from Data Objects T that may have contributed to the derived Profile Matrix, and where the superscript Node(s) may refer to a Node (and/or groups of Nodes) within a Network referenced by Profile Matrix

$${[ P ]}_{{[ A ]}_{T}^{v}}^{Node ( s )} .$$

But note again that in some implementations the terms Node(s) may equivalently refer to one of more users associated with a Node and/or with groups of Nodes.

Note also that the various methods of processing and manipulating Attribute Matrices cited in the foregoing (and in example implementations that may follow, all of which serve to illustrate the teachings of the present invention) may also be applied to the creation and/or generation and/or derivation and/or maintenance of such Profile Matrices, including but limited to the example “chained” and recursive operations and related configurations described in wherein any number of transformations may be employed.

In this sense, as with Attribute Matrices, in implementations, any and/or all Profile Matrices may be derived by means of a variety of methods and/or may be instantiated in alternate structures (such as features maps and statistical compilations) created and/or modified by means of any number of transformations, and that in some embodiments, these alternate representations may be used in any combination.

In embodiments, therefore, Profile Matrices may be viewed as a type of Attribute Matrix and the foregoing descriptions of the creation and/or generation and/or derivation and/or maintenance and/or transformation of Attribute Matrices apply without loss of generality to Profiles Matrices. Profile Matrices are distinguished, however, by the fact that, in general (but not exclusively), the information they embed may convey characterizations of groups of one or more Attribute Matrices. But note that some Profile Matrices may include additional information not embedded in any Attribute Matrix, and/or may integrate information based on Data Objects and/or some Nodal and or Network activity nominally unrelated to its constituent Attribute Matrices. Finally, there are variations of this embodiment wherein Profile Matrices may be constructed from Data Objects that may not have associated Attribute Matrices.

Further, Profile Matrices may also embed information that may (in part or completely) be derived from groups of one or more Attribute Matrices wherein the subject Attribute Matrices may in turn be derived from different Data Object types and which therefore may have been derived by means of distinct processes. Thus, since the information from Attribute Matrices that may be integrated into one or more Profile Matrices may exist in a variety of formats, such information may be subjected to methods that “normalize” this information for inclusion into one or more of these Profile Matrices.

Moreover, certain Profile Matrices may integrate information as above but may additionally factor in other parameters including, for example, changes in some variable over time or frequency of user and/or Nodal access to some Data Object and/or to groups of Data Objects and/or to processes and/or to activities.

The variety of possible Profile Matrices is limited only by the requirements of an embodiment in that such structures may be developed and/or derived in relation to any activity and/or set of activities associated with a Node and/or with groups of Nodes and/or with methods instantiated within and/or which may operate within a Node and/or groups of Nodes, and/or with the activities of users and/or groups of users. Moreover, Profile Matrices may be derived from any Data Object by using characterization processes appropriate to the Object type.

In implementations, one or more Attribute Matrices [A]_{T}^{v} and/or Profile Matrices

$${[ P ]}_{{[ A ]}_{T}^{v}}^{Node ( s )}$$

may be combined and/or concatenated create an Integrated “Profile Set”. The constituents of such an Integrated “Profile Set” may include (but may be not limited in some implementations to) Attribute Matrices and/or Profile Matrices that may be related to any set of Data Types and/or to combinations of one or more Data Types and/or to Nodes and/or to groups of Nodes and/or to users and/or to groups of users an/or to information which may be related to system and/or to user activity (as described above).

In addition, note that in implementations, such Integrated Profile Sets may include variables, data structures and/or information and/or other references to data that may not necessarily have contributed to the derivation of any or all of the Attribute and Profile Matrices structures. Such “Ancillary Data” may originate from processes that may be seen as external and/or unrelated to the Network and/or which may have been processed by and/or delivered to processes within the Network by external processes.

Finally, such Integrated Profile Sets may also include and/or may be influenced by input that may be harvested from information related to a user, to groups of users and/or may integrate information that may be inferred by and/or which results from processes that monitor activity related to users and/or groups of users and/or to Node and/or groups of Nodes, and/or which results from processes that monitor the activity of processes with a Node and/or groups of Nodes (where such Nodes and/or groups of Nodes may be enabled or non-enabled or partially-enabled, as described above).

In some embodiments, such “Ancillary Data” may be processed by methods by means of which the information may be transformed and/or otherwise modified in order to be integrated within one or more Attribute and/or Profile Matrices and/or such that it may be processed by methods that utilize one or more Attribute and/or Profile Matrices. But note also that in some variations, such “Ancillary Data” may itself form a type of discrete Attribute and/or Profile Matrix.

Thus, while the example embodiment shown in FIG. 22 illustrates one method by means of which Attribute Matrices and/or Profile Matrices may be derived from both various data types as well as from observed and inferred user activity, note that in implementations, the processes that may create and/or which may operate upon Integrated Profile Sets may additionally subsume and/or reference and/or may be modified by the Attribute Matrices and/or Profile Matrices themselves as well as other factors as described above. In this sense, Integrated Profile Sets may be subject to any or all of the methods cited in the foregoing which may be applied to discrete Attribute and/or Profile Matrices, including but not limited to the examples of “chained” and recursive methods cited in the foregoing.

In implementations that employ Integrated Profile Sets, such Sets may be represented by any number of means. One method may use symbols and/or groups of symbols that may represent some or all of the information within the constituent Attribute and/or Profile Matrices and/or related ancillary information, but in other cases, the Attribute and/or Profile Matrices and/or related ancillary information may themselves constitute this Set. Moreover, implementations that deploy Integrated Profile Sets may require a combination of symbol representation with Attribute and Profile Matrices.

Note that since it is the nature of many Data Objects to change and/or be transformed in response to any number of stimuli, the information derived from these Objects (as embodied in one or more Attribute and/or Profile Matrices and/or ancillary data) may concomitantly change and/or be transformed. Thus, as cited in the foregoing, since both dynamic and static Attribute and/or Profile Matrices may co-exist various within the Network, it follows that the Integrated Profile Sets within which such structures are included may also be responsive to and may reflect these changes.

Thus, processes (that may be modeled to reside at any Level and/or at any Layer within the Network) that operate upon Integrated Profile Sets and/or which may execute computations based on information within those Sets and/or which may otherwise respond to elements within those Sets, may also be adaptive to the changes that may occur within Network profiles. In this sense, as described above, in some implementations, changes in underlying Data Objects from which these abstractions may be derived may be reflected in the Integrated Profile Sets, but further, changes in those Sets may, in implementations engender changes and/or may modify and/or otherwise change the computational methods themselves.

In implementations, Attribute and/or Profile Matrices and/or Integrated Profile Sets may be aggregated either within a Node, across Nodes and within groups of Nodes in any combination, variously and at any time, depending on the context and requirements of the Network. Thus, the derivation methods germane to the creation of these Matrices and Integrated Profile Sets and/or the methods that may operate upon these structures may be modeled to reside (in total and/or partially) within any of the Layers (Fixed or Adaptive) and/or Levels (Node-Level and/or Node-Relational Level and/or Network-Control Level) within an embodiment of the Network, and may be understood as assuming the characteristics associated with the distributed data and distributed process models described in the foregoing.

In some embodiments, as described in the foregoing, any number of methods may be used to derive Attribute Matrices [A]_{T}^{v} and/or Profile Matrices

$${[ P ]}_{{[ A ]}_{T}^{v}}^{Node ( s )}$$

and/or associated Ancillary Data related to those structures may not necessarily be expressed as a vector matrix but in alternate forms such one or more feature maps and/or statistical compilations and/or one or more geometric shapes. Note also that, without loss of generality, references to Profile Matrices in the following example embodiments may be considered to include Integrated Profile Sets with the characteristics described in the foregoing.

One example implementation may be used to illustrate these teaching, but note that, as stated, any type of Data Object may be processed and/or integrated within the Network activity in this manner In this example, a Node-Level Profile Matrix may be created on the basis of the local musical library attached to that Node. An example embodiment is shown in FIG. 24. In this case, the individual local musical tracks within a Node may be first processed to derive an Attribute Matrix

$${[ A ]}_{{T}_{{MUSIC}_{i}}}^{user}$$

for each of the i tracks associated with that user. Another process may then derive the musical library profile for this user and the resulting information may be embedded in Profile Matrix

$${[ P ]}_{{T}_{{M\_Pr}_{Library}}}^{user}$$

where the subscript T_{M}_{_{—}}_{Pr}_{_{Library}} designates that this matrix embeds the derived information on the musical attributes of the local library and the superscript USER designates a specific user at that Node.

In mathematical terms, the derivation of this Profile may be modeled as:

$${\sum }_{1}^{i} ( {[ A ]}_{{T}_{{MUSIC}_{i}}}^{user} * α ) = {[ P ]}_{{T}_{{M\_Pr}_{Library}}}^{user}$$

Where the operator * represents the derivation operation that operates on the elements of

$${[ A ]}_{{T}_{{MUSIC}_{i}}}^{user}$$

and α represents one or processes that use the operator to derive the Profile Matrix

$${[ P ]}_{{T}_{{M\_Pr}_{Library}}}^{user} .$$

Note that this particular embodiment of a Profile may form part of an Integrated Profile Set wherein additional and/or ancillary and/or supplemental information may be appended and/or otherwise referenced. Note also that while there is no requirement that the constituent elements that compose such Integrated Profile Sets share the same mathematical dimension, in some implementations, certain computational operations that may be performed using upon these structures may require such compatibility. In these instances, transformative operations may be utilized to instantiate this mathematical compatibility.

In one example implementation, the Attribute Matrices that may compose an Integrated Profile Set may be transformed to map across n dimensions, regardless of the dimensionality of the original Matrices. In this fashion, computational geometry techniques may be used to operate upon these structures. Thus, in one example embodiment, the Integrated Profile Set for each Node in the Network may be composed of a plurality of Attribute Matrices wherein each Matrix constitutes a Profile derived from distinct Data Objects and/or from Node-level activity (such as the frequency with which a node accesses Data Objects) and/or from Node-Relational activity (such as the frequency with which Nodes within the Network initiate communication with certain other Nodes) and/or from Network Control activity (such as the frequency with which Nodes engage in similar activity with other Nodes).

In this example embodiment, each constituent Nodal Profile Matrix may be transformed to map across n dimensions, noting that in some cases, the magnitude of certain dimension may be null. In this instance, the Integrated Profile Set may, therefore, be modeled as a lattice characterized by “sections” wherein each “section” is an n dimensional shape derived from its “parent” Attribute Matrix. Since, by definition, these structures are content-emergent and activity-emergent, the geometric “shape” of such lattices evolves over time, but may be interpreted and/or operated upon variously and at any time by any of the processes described herein. Thus, for example, using computational geometry methods, the relationship between such lattices (that may emerge at the Nodal-Specific Level and/or at the Node-Relational Level and/or at the Network-Control Level) may serve as an element in processes that control the operation of the Network (at any of the Levels described herein), including (but not limited to) methods that define the interaction of Nodes and/or how information that passes between Nodes may be conditioned and/or processed, and/or presented and/or otherwise modified.

But note that such geometric techniques may be combined with other methods variously and any time, and that such methods may be employed by any Level or Layer in the Network. Certain embodiments may employ (but may not be limited to) such as operational methods as pattern recognition, and/or heuristic evaluation, and/or natural language processing and/or linear mathematical techniques, and/or statistical processing. Further, any or all the elements of an Integrated Profile Set may be processed and/or operated and/or otherwise modified and/or transformed in a “chained” configuration, as described in the foregoing.

In some implementations, Profile Matrices of any sort may be used in realize the “data attraction” methods described in the foregoing. At the first level, a Profile Matrix may be used within the Node itself such that information within Attribute Matrices (and/or other structures that may define Data Objects) may be used to sort and/or prioritize or otherwise operate upon subject data Objects to accomplish any number of operations.

Thus, in one example implementation of Node-level “data attraction”, Profile Matrix

$${[ P ]}_{{T}_{{M\_Pr}_{Library}}}^{user}$$

may be used by a process that examines one or more Attribute Matrices associated with Data types other than music to associate those Objects in processes employed by that user. In this example, suppose that the Attribute Matrix

$${[ A ]}_{{T}_{{MUSIC}_{i}}}^{user}$$

yields a Musical Library Profile

$${[ P ]}_{{T}_{{M\_Pr}_{Library}}}^{user}$$

that may (for the purposes of illustration) be represented by the symbols XWXZX. Suppose, moreover, that one or more processes PI within this Node operate on locally-stored digital photographs using some set of ontologies such that processes PI interpret the elements of these images according to the definition(s) defined by those ontologies and which derive one or more Attribute Matrices associated with each image. And further suppose that the ontologies used by processes PI are designed such that they provide a correlative basis by means of which the processes PI derive the Attribute Matrices in manner that is computationally compatible with Profile Matrix

$${[ P ]}_{{T}_{{M\_Pr}_{Library}}}^{user} .$$

Thus, in this example another set of processes PM may then prioritize and/or organize and/or sort and/or display to the user images and/or elements of images based on the degree to which those images correspond to information represented by symbols XWXZX.

Note that the foregoing example may be applied without limit to any Data Object using any appropriately derived set of one or Attribute Matrices associated with those Data Objects, including, but not limited to text, illustrations, audio programming, video, video games and any other Data Type.

Note that in implementations, any set of Data Objects operated upon in this manner and wherein one or more associated Attribute and/or Profile Matrices may be derived from these Objects, the “data attraction” aspect of the present invention may be configured to interact with any process and/or software program within the Node (and by extension, within any Node since the distributed model may be applied).

Thus, without loss of generality, note that such associated Attribute and/or Profile Matrices and/or the symbols (XWXZX in the previous example) used in this manner may be transformed and/or otherwise modified to be compatible with the subject data and associated processes.

At the next level, using the foregoing example based on musical libraries, Profile Matrix

$${[ P ]}_{{T}_{{M\_Pr}_{Library}}}^{user}$$

may be assigned an index and in this manner may be shared between Nodes within the Network and may be operated upon by processes that may exist at either the Node-Relational Level and/or at the Network Control Level.

Thus, in one example that may be modeled at the Node-Relational Level, in manner similar to that described in the foregoing example, a “dispensing” Node may pass images (and or descriptions of images) to other “receiving” Nodes based on the degree of correspondence of the receiving Nodes' musical Profile Matrix

$${[ P ]}_{{T}_{{M\_Pr}_{Library}}}^{user}$$

to Attribute Matrices (and/or their representations) derived from or otherwise associated with images residing on the “dispensing” Node(s).

Note the foregoing is an example of an implementation wherein the “data attraction” is configured such that “receiving” Node “pulls” the images (and or descriptions of images) from “dispensing” Nodes and/or wherein the “receiving” Node “searches” for qualified the images (and or descriptions of images) that may reside in “dispensing” Nodes by circulating Profile Matrix

$${[ P ]}_{{T}_{{M\_Pr}_{Library}}}^{user}$$

and/or some representation of that information along with a request to activate the local associative process.

But note further that (extending the above example without loss of generality to other obvious examples) in such implementations, the “dispensing” Nodes may alternatively and/or supplementally “push” the images (and or descriptions of images) to “receiving” Nodes. In such a cases, one or more Attribute Matrices associated with those images (and/or some representation of that information) may be “pushed” by the “dispensing” Node to one or more locations in the Network. Nodes possessing qualified Profile Matrix

$${[ P ]}_{{T}_{{M\_Pr}_{Library}}}^{user}$$

may then access and/or view the images and/or representations of the images.

Note that the “attraction” of the Data Objects between the qualified Nodes may use any number of enabling processes, but in some embodiments, these processes may be modeled as being limited to the Node-Relational Level. That is, in some implementations, there may not necessarily be a Network-Control Level facility involved in the “attraction” and that in such cases, the operations may be executed in “pure” peer communication environment.

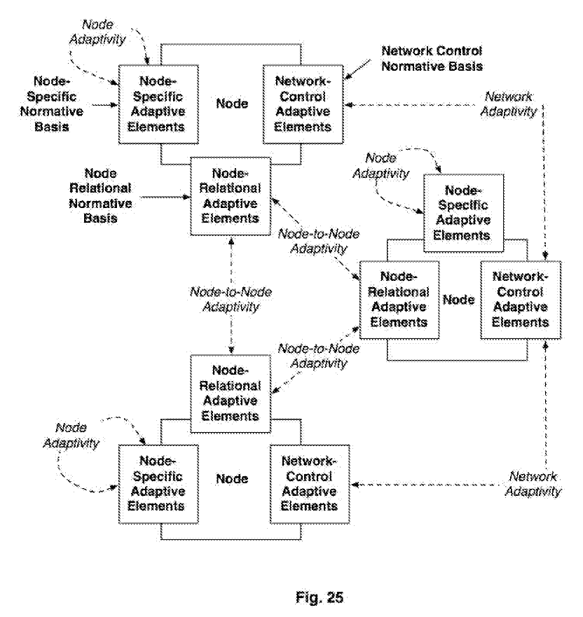

In other embodiments, however, the exchange of Data Objects may be partially and/or fully controlled by one or processes that may be modeled as being part of the Network-Control Layer. FIG. 25 extends the example from above to detail how Nodes within the Network may process these Matrices, as above.

In this example implementation, Node 1 (the “receiving Node”) might request a Server to instruct attached Nodes (dispensing Nodes) to send images have Attribute Matrices that match the Attribute Profile Matrix

$${[ P ]}_{{T}_{{M\_Pr}_{Library}}}^{user} .$$

(For the purposes of clarity, note again that in some embodiments, the Profile Matrix

$${[ P ]}_{{T}_{{M\_Pr}_{Library}}}^{user}$$

may be represented by another set of symbols, and in this example, suppose the Attribute Matrix

$${[ A ]}_{{T}_{{M\_Pr}_{Library}}}^{{Node}_{1}}$$

may be represented by the symbols XWXZX.)

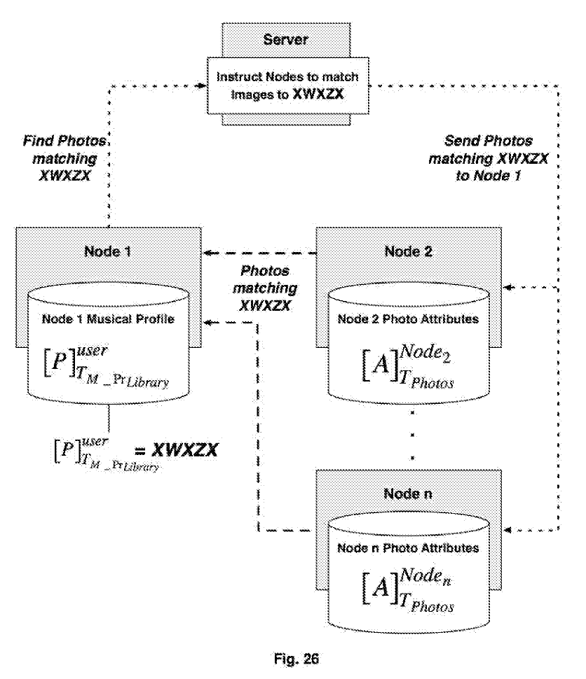

Thus, as shown in the example in FIG. 26, the symbols XWXZX may be transmitted from receiving Node 1 through the Network to dispensing Nodes 1-n by means of a Server; Nodes that possess images that bear a relationship with the symbols XWXZX may then be returned to receiving Node 1.

Note that, in embodiments, there may be controlling processes within the dispensing Nodes that interpret the symbols XWXZX and that receiving Node 1 may additionally append files and/or may modify the symbols XWXZX to define the terms under which the dispensing Nodes create “matches”. That is, certain embodiments may create “nearest” matches using, for example, algorithms that calculate the relative relationship between the symbols XWXZX and the derived features of subject content as embodied in associated Attribute Matrices.

But note that in some cases the parameters that may define these relationships may be transmitted along with the symbols and/or may be stored in either a central and/or a group of distributed locations. Note also that some embodiments may instantiate processes within one or more Servers wherein these operations are optimized and/or enabled.

Note that these example implementations may be expressed in terms of the distributed data and distributed process model described in the foregoing. In this manner, it can be seen that, in the previous example, the Attribute Matrices [A]_{T}_{_{Photos}}^{Node}ₙ and/or Profile Matrices

$${[ P ]}_{{T}_{{M\_Pr}_{Library}}}^{user}$$

that may reside any of the n Nodes in the Network may be treated as co-resident with receiving Node 1. In this sense, the associative search may be understood to be functionally identical to a locally executed associative search—that is, an inter-Nodal search may be seen as functionally identical to a search that is germane to and performed relative to Data Objects within receiving Node 1. This model may be applied without loss of generality in embodiments where Server operations may be involved.

Certain embodiments of the Network may use these “data attraction” techniques in “hybrid” configurations wherein an “enabled” Node may interact with one or more Nodes that may not be “enabled” (and/or which may be partially enabled) in that these Nodes may not instantiate some or all of the processes that may be present at the originating Node. In one such example, Node 1 may pass information to one or more non-enabled Nodes wherein the information delivered may be derived from one or more Attribute Matrices. In such embodiments, the originating Node may possess one or more processes that may transform or otherwise configure the data passed to the non-enabled Nodes such that any non-enabled Nodes may interpret the transmitting data.

In one example implementation of such a “hybrid” configuration, Node 1 may possess the Profile Matrix

$${[ P ]}_{{T}_{{M\_Pr}_{Library}}}^{user}$$

that characterizes the music library of that Node. In order to search for and/or acquire data that may be consistent with some set of criteria, Node 1 may instantiate a process P_INT that may operate on that information contained in Profile Matrix

$${[ P ]}_{{T}_{{M\_Pr}_{Library}}}^{user}$$

such that process P_INT “interprets” the meaning of the information contained in Profile Matrix

$${[ P ]}_{{T}_{{M\_Pr}_{Library}}}^{user}$$

(based on one or more ontological frames of reference) and which then may create an associated data structure, A_PR. This data structure would, in this example, be designed to be consistent with the requirements of non-enabled Nodes in such a manner that the information represented by Profile Matrix

$${[ P ]}_{{T}_{{M\_Pr}_{Library}}}^{user} ,$$

now represented in data structure A_PR, may be processed by methods residing in non-enabled Nodes. Note that data structure A_PR may be embodied in any form including (but not limited to) text strings, XML files and the like.

One example of such an implementation would make it possible for Node 1 to supplement a query to a non-enabled Server (such as a commercial search engine, for example) for information about a keyword string (entered by a user at Node 1). Using these methods, the “nominal” search string (entered by the user) may be supplemented with information embedded within and/or derived from data structure A_PR, a file which may contain one or more transformed versions of that Node's musical library profile as embedded in Profile Matrix

$${[ P ]}_{{T}_{{M\_Pr}_{Library}}}^{user} .$$

This additional information may be used to enhance and/or refine the “nominal” search string by providing a “profile” of the user's musical library.

Other examples of the application of these teachings may include accessing e-commerce web locations that may incorporate some version of customer profiling (commonly known as “collaborative filtering”). In example cases, implementations may instantiate processes (either at the originating Node and/or at the receiving Server or both, in some combination) that may transform any or all of the elements of data structure A_PR to amend and/or supplement and/or otherwise influence the composition of the customer profile associated with that user and/or Node and/or may supplement and/or otherwise influence any requests for information originating from and/or germane to that user and/or Node.

Note that in some implementations, the “data attraction” methods may be applied to Data Objects for which there is no associated Attribute and/or Profile Matrix and/or for which the information about the subject Data Objects is contained in supplemental and/or metadata files such that the methods used to effectuate “data attraction” may not be used with this information. Apart from the “transformation” methods described in the foregoing whereby “data attraction” may be made compatible by operating on and/or otherwise modifying the information with and/or which represents an Attribute and/or Profile Matrix, in some embodiments, in order to execute methods described, one or more Attribute and/or Profile Matrices and/or information which represents these structures may be appended to files associated with such Objects.

In a variation of such methods, one or more methods (which may be located on either an enabled and/or non-enabled Node) may create links between one or more Attribute and/or Profile Matrices. These links may be viewed as derivative Data Objects and, in this sense, may be modeled as residing at any Level and/or Layer within the Network, and thus may be subject to any and/or of the processes described herein the interact with and/or process and/or utilize Data Objects.

One set of implementations wherein “hybrid” configurations may be used may additionally or exclusively employ a specialized Server to facilitate the interaction of Nodes with either enabled and/or non-enabled resources. In certain embodiments, these facilities may instantiate processes that may optimize and/or otherwise facilitate the exchange of information between Nodes within the Network. Such “sub-netting” may be accomplished by aggregating Nodes that possess profiles that meet some set of criteria. This optimization may be executed by one or more processes that may be modeled as residing at either the Node-Relational Level or Network-Control Level in the Network, or some combination.

One example of such an embodiment would facilitate “introduction” of Nodes to other Nodes that possess profiles that may interpreted (by means of some ontology) as likely to share interests. For example, let Node 1 posses a musical library that is represented by Attribute Matrix

$${[ A ]}_{{T}_{{M\_Pr}_{Library}}}^{{Node}_{1}}$$

which may be represented by the symbols XWXZX and let Node 2 posses a musical library that is represented by Attribute Matrix

$${[ A ]}_{{T}_{{M\_Pr}_{Library}}}^{{Node}_{2}}$$

and which may be symbols XWXZY Let some Process M (which may be modeled as residing at either the Node-Relational Level or Network-Control Level in the Network) execute a function that evaluates the proximity of symbols XWXZX to symbols XWXZY according to some set of criteria C. Let process I (which may be modeled as residing at either the Node-Relational Level or Network-Control Level in the Network) execute a function that may inform any Node possessing the symbols XWXZY that Nodes that possessing the symbols XWXZX may share similar interests, and which, in the obverse case, may inform any Node possessing the symbols XWXZX that Nodes that possessing the symbols XWXZY may share similar interests. Then let process C enable “introductions” between one or more qualified Nodes. Such introductions may take the form, in some embodiments, of “special views” into the musical libraries of qualified Nodes, for example, or may suggest correspondence through e-mail or instant messaging.

Further, some embodiments may allow one or more Nodes “grouped” in such a fashion to receive information from one or more sources. Such information may include (but may not be limited to) advertising, offers, promotions and the like. By employing the “data attraction” methods described in the foregoing, each Data Object (which contains relevant information such as ads or links or offers, for example) may be assigned an Attribute Matrix and Nodes that possess related Attribute and/or Profile Matrices may access those objects.

Note that in some implementations, this “sub-netting” within the Network may be accomplished by means of distributed data attraction techniques—and in this sense, may operate “automatically” in that the relevant Objects are “attracted” to related Nodes—but that some implementations may additionally and/or exclusively use one or more controlling Nodes (which in implementations may be composed as Servers and/or as Nodes that alternately function as Servers). Such resources within the Network may evaluate the Profiles associated with one or more Nodes and may route and/or may facilitate the routing of information to those Nodes such that information consistent with those associated with those profiles is presented. This presentation may, in some instances route only information that falls bounds defined within the some ontological underpinning and/or may prioritize such information according elements of that ontology and/or according to a context derived from one or elements of the Nodal Profile and/or the context of the Nodal activities.

In this sense, in some implementations, variously and/or at any time, depending on the context of the related activities, the presentation and/or prioritization of information delivered to the Node may be adaptive with respect to a Nodal Profile of the originating Node but may also be influenced by the characteristics revealed by the aggregated Nodal Profiles of groups of Nodes.

Note also that both methods that deploy data attraction (wherein the information may be routed to and presented within destinations based on distributed (i.e. local) evaluation of the relevant Attribute Matrices of the subject Nodes and the subject Data Objects) and methods that deploy centralized routing (wherein some set of resources accessible by Nodes) supervise the routing and presentation of relevant information) may co-exist within implementations of the Network. The results of such operations may, depending on the context, be combined into an integrated presentation.

But note further, that in some embodiments, variously and at any time, some or all of these functions may be executed solely by the originating Node and/or by one or more Nodes in collaboration with other Nodes (which groups of Nodes may include the originating Node). Thus, some implementations may dynamically combine data attraction techniques with routing techniques, variously and at any time (depending on the context), and these combinations may be executed at the Node-level, and/or at the Node-Relational level and/or at the Network-Control level. In this manner, operations that execute data attraction may be executed at the Node-level in one instance (in a certain context), but at a Node-Relational level in another, and in yet another, may be combined with routing techniques. And in the latter case, the combined operation may in one case be executed by a Node in a standalone fashion (as a Node-level operation), but may, in another case, access a central resource to execute some part or all of the procedure.

In some variations of implementations that deploy these techniques, one or more resources (which may (variously and at any time) operate as Nodal- and/or Node-Relational- and/or Network-Control-based resources, as described above) may provide “ancillary” information—that is, information that may be understood to be relevant to context of the subject activity (wherein the degree of relevance may be defined by some criteria and/or ontology) but which itself is not contained in the relevant Attribute and/or Profile Matrices. In such embodiments, processes that operate upon this information may combine information included within and/or derived from some or all of the information within the relevant Attribute and Profile Matrices—including but not limited to those gathered from one or more Nodes within the Network and that may be derived from and/or assigned to Data Objects within the Network—with such “ancillary” information external to those Attribute and Profile Matrices. Note that the operations that process this information may access Network-based and/or non-Network-based resources to compose and condition the relevant “ancillary” information.

In one such embodiment, the Network may be configured to deliver profile-based Web Search results to enabled and/or non-enabled and/or partially enabled Nodes. In this example implementation, (presented without loss of generality as many variations may be developed from this set of teachings), a user at a Node may engage in some set of activities and “ancillary” information—including but not limited to Web search results—may be flowed to this Node based on both the immediate context of the activity but such that this ancillary information may be conditioned by, influenced by and/or derived based upon the profile of that Node (and/or of that user within that Node) and/or by the profiles of one or more other Nodes. Note that the activity upon which the context is based may not be directly related to Web search.

In an example embodiment, the originating Node may communicate the context of its activities to a central resource. Note, however, that although this and some examples that may follow may cite such a central resource, variations of these and other embodiments may execute the described functionality within one or more Node (where such Nodes may include the originating Nodes) without and/or in conjunction with such a “central resource”. Thus, in the following descriptions, the term “central resource” should be understood to include, in some embodiments and/or in some contexts within embodiments configurations that, variously and at any time, depending on the context, may generate and/or process and/or execute any or all of the operations described.

In addition to information concerning the activity context, the Node may include one or more elements of its Node (and/or user) Profile. In this and other related example embodiments, the Node may submit one or more “seed” components to one or more central resources. In some example operations, there may be two “seed” components, but note that these components may be integrated within a single structure and/or may be distributed across a plurality of structures. These “seed components may include (but in many variations may not be limited to): 1) the context of its activity; and 2) the relevant elements of its Nodal (and/or user) Profile. (Note that in the following example, the term “Nodal (and/or user) Profile” may be understood to refer any or all of the elements that may constitute an Integrated Profile Set as described in the foregoing.) Based on these “seed” components, the central resource (or one or more Nodes, as above) may then compose a search string, a string that may be derived from either the context “seed” and/or elements of the submitted profile “seed”.

In a specific example of such an implementation (presented for illustration without loss of generality with respect to obvious extensions and enhancements), let central resource PS be a Network Node that connects to some or all Nodes in the Network such that when any of the connected Nodes engages in some set of Activities A . . . M, those connected Nodes provide to resource PS one or more elements of their Nodal Profile [A]_{T}_{ᵤₛₑᵣ}^{Node}^{_{N}} and information concerning the context of Nodal user activity. In this simplified example, let Process WS_{central} reside at the central resource PS. Let Process WS_{node}^{activity} reside at Node 1 such that this process produces a communicable Data Object called A(α_{A . . . M}) where α_{A . . . M} represents an encoding of information related to Activities A . . . M. Let Process WS_{node}^{profile} reside at Node 1 such that this process operates on Nodal profile [A]_{T}_{ᵤₛₑᵣ}^{Node}^{₁} to select the information about that Node (and/or a particular user) and which generates a communicable Data Object P_{ws}, where P_{ws} encodes the relevant information from Profile.

In this example, when Node 1 engages in Activity A, Process WS_{node}^{activity} and Process WS_{node}^{profile} produce Data Objects A(α_{A}) and P_{ws}^{node1} respectively. These data Objects may be transmitted to resource PS and Process WS_{central} (resident at PS) operates upon the encoded information they embed. Let the output of Process WS_{central} be a communicable Data Object A(α_{A}^{node1}) where α_{A}^{node1} may embed one or more of the following information: 1) one or more search strings derived from “seeds” A(α_{A}) and P_{ws}^{node1}; and 2) information instructing Node 1 as to the method of presentation related to each string—where the latter information may be called a Web Search Template. Let the search strings in 1) above be represented by

$${S}_{{1}_{{α}_{A}}}^{node 1} … {S}_{{m}_{{α}_{A}}}^{node 1}$$

where

$${S}_{{m}_{{α}_{A}}}^{node 1}$$

denotes the m^{th} search string derived from seeds A(α_{A}) (which encodes Activity A as related to α with respect to Nodal (and or user) Profile_{ws}^{node1}.

Continuing this example, Node 1 may receive Data Object A(α_{A}^{node1}) and may activate Nodal Process WS_{node}^{A . . . M}. (Note that Process WS_{node}^{A . . . M} is related to Process WS_{node}^{activity} and Process WS_{node}^{profile} node in that the latter processes previously formatted and presented Data Objects A(α_{A}) and P_{ws}^{node1} to resource PS and Process WS_{node}^{A . . . M} receives the processed returned data.) Process WS_{node}^{A . . . M} operates on returned Data Object A(α_{A}^{node1}), extracting the information in that Object concerning the Web Search Template and may, as a result, present a related User Interface component using presentation instructions that may be embedded in Data Object A(α_{A}^{node1}). Process WS_{node}^{A . . . M} may then extract the embedded search string(s)

$${S}_{{1}_{{α}_{A}}}^{node 1} … {S}_{{m}_{{α}_{A}}}^{node 1}$$

from Data Object A(α_{A}^{node1}) and these strings may be transmitted to a search engine. (Note that in the event that Data Object A(α_{A}^{node1}) contains more than one search string, these strings may be submitted either separately and/or in aggregate, depending on the context and the requirements of a particular activity and/or on the characteristics of the search engine.)

In any case, Node 1 receives the results from the search engine, data that may contain one or more hyperlinks h that typically (but not necessarily) point to Web locations. Process WS_{node}^{A . . . M} presents those hyperlink results (with appropriate text that may accompany those hyperlinks) through the User Interface elements described by the Web Search Template received from resource PS.

Note that the presentation of these hyperlink results (as mandated by means of the Web Search Template) may vary according to any number of factors in this chain of processes, including, but not limited to Activity A, and/or to α, and/or to information related to and/or derived from Nodal (and or user) Profile P_{ws}^{node1}, and/or to search string

$${S}_{{m}_{{α}_{A}}}^{node 1} ,$$

and/or to any other factors including but not limited to rules that may apply to any of the preceding factors and/or to Network requirements.

Continuing this example, in some implementations, if and when a user at Node 1 accesses any of the hyperlink results received from the search engine, Process WS_{track}_{_{—}}_{click}^{node1} may be activated and the activity surrounding this access may be stored. Thus, Node 1 may record information pertaining Activities A . . . M (including information related to the activation of the processes that ultimately produce the subject hyperlinks as described) and, upon user access to one of the related hyperlinks h, may encode this information into Data Object

$${}_{wc}^{time}{W}{}_{{P}_{ws}^{node 1}}^{node 1} ( {}_{}^{{h}_{n}}{S}{}_{{m}_{{α}_{A}}}^{node 1} ) ,$$

where

$${}_{}^{{h}_{n}}{S}{}_{{m}_{{α}_{A}}}^{node 1}$$

denotes the n^{th} hyperlink h within the m^{th} search string derived from seeds A(α_{A}) (which encodes Activity A as related to α with respect to Nodal (and or user) Profile P_{ws}^{node1}, and where time may encode the time and date of the access and where WS may encode other “wildcard” information related to these events which may be used in creating and retrieving and otherwise characterizing the access and any related transactions that may transpire.

In an extension of this example implementation, note that since elements that compose Nodal (and/or user) Profile P_{ws}^{node1} may evolve over time, as described in the foregoing, the processes described above may provide different results to that Node in response to identical Activities A(α_{A . . . M}) and in respect to the information contained in α_{A . . . M}. Thus, while a user may engage in identical activities at different times, the adaptive element of the Network captures and encapsulates the evolving elements that may be factored into the operations.

Further, note that identical Activities A(α_{A . . . M}) initiated by different users at different Nodes will be dependent on different Profiles. Thus, if user 1 at Node 1 and user 2 and Node 2 simultaneously engage in Activity A, and if (as is mathematically likely) P_{ws}^{node1} (associated with user 1 at Node 1) is different from P_{ws}^{node2} (associated with user 2 at Node 2), the results displayed by Process WS_{node}^{A . . . M} may be different.

In this manner, the Web Search results may be seen as responsive to and adaptive to the relevant elements of the respective Nodal (and/or user) Profile. As noted in the foregoing such Profiles may compose some of all the elements of an Integrated Profile Set (as described) and that such information contained within these Integrated Profile Sets (and/or any elements of these Sets that may be used) may optionally, variously and at any time (depending on the subject activity and the context of the Network) include additional information that may influence and/or which may condition and which may otherwise be used as a factor in these and related operations. Note further that in some embodiments, the “seed” components may include information and/or Nodal Profiles from one or more other Nodes within the Network, as above. Note finally that such information may be aggregated and may form an “Aggregated Profile” composed of some or all of the information associated with and/or contained within the Integrated Profile Set(s) associated with one or more Nodes.

Since any and/or all of these elements may change over time, and since operations governed by processes within the Network (where such operations and the associated operations may execute functions germane to any and/or all of the Levels within the Network-Nodal-Specific, Node-Relational and Network Control), these and related operations may compose one Adaptive aspect of the Network. In this sense, the Network may be seen as “adapting” to the changing conditions within the Network: the flow of information and the composition of that information to and/or from and/or between Nodes in the Network may change as a result of the “evolution” of Data Objects.

Note further that, in variations of the present example, the operations described above may, at any time during execution, be integrated within a “chained” construct (as described in the foregoing) wherein Activities A(α_{A . . . M}) and/or user response to the returned hyperlinks and/or Nodal and/or user interaction with any of the elements and/or variables used in the operations may be themselves used to change or otherwise modify the related elements. Thus, in one example, elements of Data Object

$${}_{wc}^{time}{W}{}_{{P}_{ws}^{node 1}}^{node 1} ( {}_{}^{{h}_{n}}{S}{}_{{m}_{{α}_{A}}}^{node 1} )$$

may be used to update and/or otherwise modify any or all of the elements of the relevant Profile Set. Note further that this modification can be shared with other Nodes and may be used as a factor in any operation of the Network, at any level and layer, variously and any time, depending on the context of the activity. Further, the information contained within Data Object

$${}_{wc}^{time}{W}{}_{{P}_{ws}^{node 1}}^{node 1} ( {}_{}^{{h}_{n}}{S}{}_{{m}_{{α}_{A}}}^{node 1} )$$

may be combined with other similarly derived Data Objects, and this information may be used variously by processes throughout the Network.

In another set of variations of implementations of this type, there may be one or more processes that operate upon the variables related to “seed” Data Objects A(α_{A}) and P_{ws}^{node1} to enhance and/or otherwise modify the information contained within those objects. Examples of such processes may include (but are not limited to) natural language processing and/or inference processing (using known methods that may combine AI techniques that may include heuristic methods and/or neural-based processing). Moreover, such methods may access databases within the Network and/or outside the Network to gather additional and/or supplemental information that may contribute to the computation such enhancements.

Referring to the previous example, in some implementations, one result of these “auxiliary” enhancement operations may be an extension and/or enhancement of the Web Search strings

$${S}_{{1}_{{α}_{A}}}^{node 1} … {S}_{{m}_{{α}_{A}}}^{node 1}$$

such that these extensions and/or enhancements embed and/or append additional information to those strings. Further, these and related operations may produce one or more “additional” and/or modified “seeds”, “ancillary seeds” that may be derived by means of inferences and relationships between the original “seeds” and other (nominally) unrelated information. Such information may be resident anywhere in the Network, but may also be obtained from Network and/or from external Databases.

In an example implementation, in practice, using the previous example, resource PS may, in response to “seeds” A(α_{A}) and P_{ws}^{node1} generate Web Search Template TOP₅ such that the originating Node is instructed to present a User Interface component that has 5 “Topical Tabs” or sections. Each of these Topical Tabs may embed, in this example, one of 5 search strings

$${S}_{{1}_{{α}_{A}}}^{node 1} … {S}_{{5}_{{α}_{A}}}^{node 1} .$$

Thus, in this example, resource PS initiates Process WS_{central} and, using input A(α_{A}) and P_{ws}^{node1} (from the originating Node 1), accesses one or more processes and Databases to determine that this combined input maps to Web Search Template TOP₅. Further, accessing one or more processes and Databases (processes that may include some combination of natural language processing, relational database evaluation and/or other related processes as described to above), one or more Nodes (including the originating Node) may determine a “Label” for each of the “Topics”. This Label may be derived (by means of processes previously described) from the original “seeds” A(α_{A}) and p_{ws}^{node1}.

In this sense, the search strings that may be constructed by Process WS_{central} (or by any other process and/or group of processes that may reside singularly and/or in a distributed collaborative fashion one or more Nodes where, in either case, one such may include the originating Node), including “labels” for each “Topic” may be represented:

$${\sum }_{\begin{matrix}k = 1 - 5 \\ t = 1 - 4\end{matrix}} {S}_{{k}_{{α}_{A}^{t}}}^{node 1}$$

where

$${S}_{{k}_{{α}_{A}^{t}}}^{node 1}$$

represents the k^{th} search string (related to Topic k), and where α_{A}^{t} represents the t^{th} transformation of seed α_{A} (where A represents the subject Activity) and where node1 reflects the elements within the original seed P_{ws}^{node1} related to the Nodal (and/or user) profile of Node 1 at the time of the submission of original “seeds” A(α_{A}) and p_{ws}^{node1}.

Thus, the output of Process WS_{central} may be information related to the User Interface elements of Web Search Template TOP₅ and search strings

$${S}_{{1}_{{α}_{A}}}^{node 1} , {S}_{{2}_{{α}_{A}^{′}}}^{node 1} , {S}_{{3}_{{α}_{A}^{″}}}^{node 1} {S}_{{4}_{{α}_{A}^{″′}}}^{node 1} … {S}_{{5}_{{α}_{A}^{″″}}}^{node 1} .$$

Note that in this example, there are a total of 5 “alpha” seeds (α_{A}^{0 . . . 4}) such that, in this illustration, the original “alpha is retained and assigned to search string 1. But note also that this is an arbitrary choice for the purposes of illustration and does not limit the generality of the teachings.

In practice, using again music to illustrate the principle (although, as noted, any Data Object may be used), if a user at Node 1 accesses a particular musical track T from artist X (which, as noted may be located anywhere in the Network), Process WS_{central} may return (from the example above) Web Search Template TOP₅ with instructions for the Node to display 5 Topical Tabs, each with a Label. Note that, in this example, the Node submitted the “seeds” A(α_{A}) and P_{ws}_{_{node1}} such that the Activity A is (in this example) may be “Access” Musical Track”) and the α_{A} may contain information about that track such as (for example) its Network index (as described above), the name of the Track (in this case T) and the artist (in this case X) and so on. Moreover, one or more Attribute Matrices associated with Track T (and/or with Artist X) and/or the indices for those Matrices may be included and/or referenced.

In this example, Process WS_{central} may employ the described processes and data to construct the Labels for each Topic in Web Search Template TOP₅ by combining information contained in α_{A} with information obtained by accessing information contained in one or more Databases and/or which may be derived from one or more processes. Thus, example Topics could be as follows: Topic 1=“Concerts by Artist X”. Topic 2=“Movies featuring Artist X), Topic 3=“Merchandise Featuring Artist X”, Topic 4=“Artists Similar to Artist X”) and Topic 5=“Other Songs Similar to Track T”. (Note that, as stated, these “Labels” are presented for illustration only.) These text strings may be embedded within Data Object A (α_{A}^{node1}) (the output of Process WS_{central}) and may be received by Process WS_{node}^{A . . . M} (as described above).

In this example, also embedded in Data Object A(α_{A}^{node1}) are related search strings

$${S}_{{1}_{{α}_{A}^{1}}}^{node 1} , {S}_{{2}_{{α}_{A}^{2}}}^{node 1} , {S}_{{3}_{{α}_{A}^{3}}}^{node 1} {S}_{{4}_{{α}_{A}^{4}}}^{node 1} … {S}_{{5}_{{α}_{A}^{5}}}^{node 1} ,$$

where α^{1 . . . 3} correspond to the “Labels” 1-5. Thus, Process WS_{central} may construct the search strings to reflect the “Topic” of the “Labels” with which they are associated. In this example, therefore, search string

$${S}_{{1}_{{α}_{A}^{1}}}^{node 1}$$

may contain information that may cause a search engine to return results related to Topic 1=“Concerts by Artist X”, as described above.

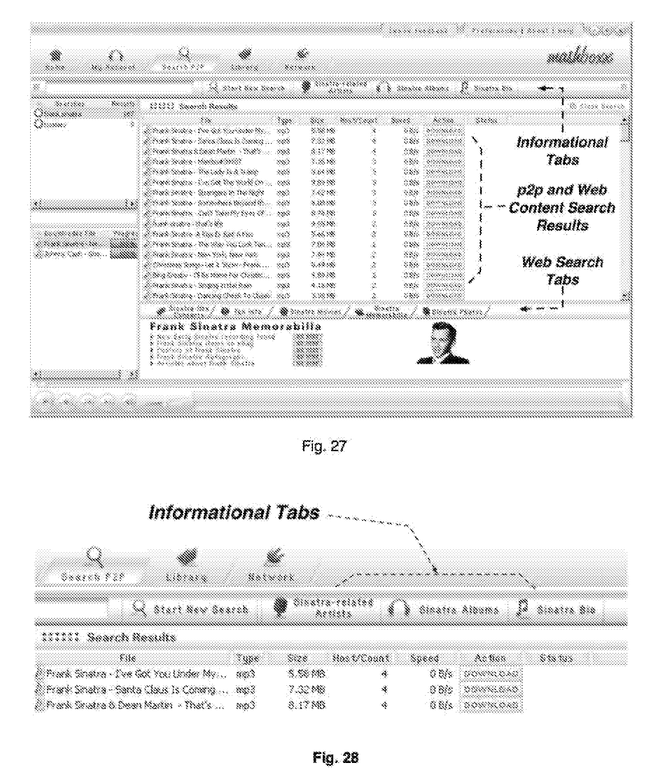

To further illustrate these teachings, in one example implementation, a Node may engage in content search activity as shown in FIG. 27. In this example embodiment, the user has entered content search string “Frank Sinatra”. The content search results are shown in the center section, and this includes content available throughout Nodes in the Network including content that may be located within Nodes that may be enabled and/or partially-enabled and/or non-enabled and/or disabled, as defined and described in the foregoing. Note that these results may any type of Data Object, although this example, as shown in FIG. 27 is confined to audio tracks.

Thus, expressed in terms of the foregoing description of these teachings, Activity A in this example would be “Search for Content-Music” and the α_{A} initial seed would be “Frank Sinatra”. Note that in this example embodiment, the Web Search Template presented by the Node includes the following Topics with the appropriate Labels, as described above: Topic 1=“Sinatra-Like Concerts”, Topic 2=“Fan Information”, Topic 3=“Sinatra Movies”, Topic 4=Sinatra Memorabilia” and Topic 5=“Sinatra Photos”. Note further that in this example, each Topic has an associated search string constructed by WS_{central} in response to this seed and Activity, noting again however that tone or more of these strings may originate from one or more Nodes in the Network, including the requesting Node.

Thus, in this example, the following strings may be embedded and/or associated with Tabs 1-5:

$${S}_{{1}_{{Frank\_Sinatra}_{Search\_for \_Content - Music}^{Sinatra - Like\_Concerts}}}^{node 1} ;$$

$${S}_{{2}_{{Frank\_Sinatra}_{Search\_for \_Content - Music}^{Fan\_Information}}}^{node 1} ;$$

$${S}_{{3}_{{Frank\_Sinatra}_{Search\_for \_Content - Music}^{Sinatra\_Movies}}}^{node 1} ;$$

$${S}_{{4}_{{Frank\_Sinatra}_{Search\_for \_Content - Music}^{Sinatr\_Memorabilia}}}^{node 1} ;$$

$${S}_{{5}_{{Frank\_Sinatra}_{Search\_for \_Content - Music}^{Sinatra\_Photos}}}^{node 1}$$

As shown in FIG. 27, this example embodiment includes another information field, denoted in the referenced FIG. 27 as “Information Tabs”. As shown in greater detail in FIG. 28, these “Information Tabs” may be generated by similar processes as described above, but may be displayed to the user in a different fashion. One reason for this distinction may be that information contained in the respective fields may differ, and thus, Nodes may display such information in different formats. The number of display formats may differ depending the requirements of a particular implementation and/or, within such implementations, on any and/or all of the elements related to the subject Activity, including, but not limited to the subject Activity, the subject α_{A} and related “seeds”, one or more elements within a Nodal Integrated Profile Set, Nodal (and/or user preferences) and/or any other conditions that may exist within the Network.

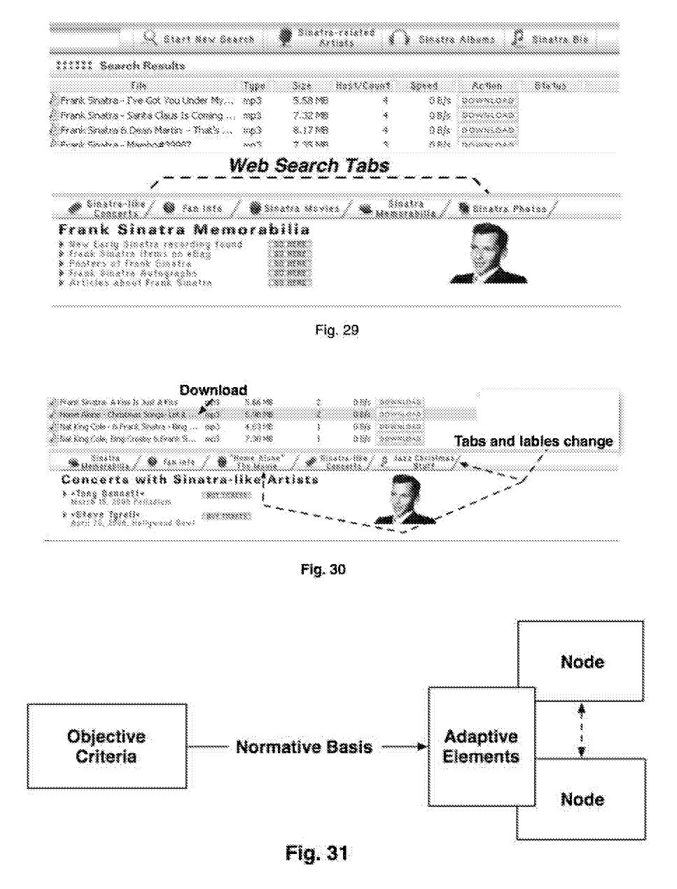

In FIG. 29, the Web Search Tabs as describe above may be seen in more detail. Note that FIGS. 27-29 reflect one methods wherein methods combine to control information as presented at a Node, and that such methods may exist in ant Level and/or Layer within the Network and that such control may be exerted over information by one or more Nodes any of which may, variously and at any time, depending on the context of the activities and the state of the Network, be enabled, partially-enabled, disabled and/or non-enabled, and/or may be in Mode (Pure and/or Hybrid and/or Standalone.)

Note, therefore, that the adaptive nature of the Network may be seen in this example in that the format and content of information displayed within a Node may change not simply in response to Activities, but in response to the nature of the content related to the Activity and/or to the state of any and/or all of the various elements of associated Integrated Profile Sets where such Sets may be Node-associated (and/or user-associated within that Node) and/or may be associated with Node-Relational and/or with Network Control factors and/or methods, and/or may be associated with any and/or all of the various elements of any Profile within the Network.

To continue this example, if after engaging in the Activity related to seed “Frank Sinatra”, the user at Node 1 then selects a specific song as displayed n the returned results, in embodiments, the Web Search Template TOP and the related Tabs and Labels may be refreshed in response to this action.

Thus, as shown in FIG. 30, in this example, the Tabs and associated Labels (and the associate strings, as above) may change. Thus, in this example, the “seeds” have changed and Process WS_{central} may respond with a different Web Search Template. In this example, the user has elected to “download” a song that happens to have been included in the soundtrack of the movie “Home Alone”. Thus, as shown in FIG. 30, Tab 3 may now be labeled “Home Alone the Movie” and may embedded and/or otherwise associate Search String:

$${S}_{{3}_{Frank\_Sinatra \_Let \_it {\_Snow}_{Download\_Content - Music}^{Home\_Alone \_the \_Movie}}}^{node 1} .$$

Tab 5 may also be re-labeled “Jazzy Christmas Stuff” and may embed and or otherwise associate Search String

$${S}_{{5}_{Frank\_Sinatra \_Let \_it {\_Snow}_{Download\_Content - Music}^{Jazzy\_Christmas \_Stuff}}}^{node 1} .$$

Comparing FIGS. 29 and 30, it can be seen that the Activity related to the seeds has changed, and thus, the related information delivered to and/or displayed by the Node may change. As described in the foregoing, such strings may embed one or more hyperlinks (with appropriate labeling with such links) that may link to locations within and/or outside the network and the Node may access such locations through normal means associated with associated protocols.

Note that any and/or all of the Activity described in the foregoing examples (and in others that may follow) may be recorded and/or tracked by any and/or all of the mechanisms described.

In the foregoing examples, the Node may track the immediate context as the user progresses through various activities. But note that in some implementations, the construction of these strings may be additionally influenced by and/or enhanced by and/or extended by and/or may otherwise be modified by any number of other factors beyond the “alpha” seed and the Activity A. In one example, elements of Nodal (and/or user) Profile P_{ws}^{node1} may influence the construction of these strings, including (but not limited to), for example, information related to the Node's previous activities and/or the geographic location of the Node. Thus, in this example, Topic 1 may include an extension that limits the string to “Concerts by Artist T near the geographic location of Node_1”. Thus, in this example, the search strings derived from an identical Activity (“Accessing Musical Track”) for identical Data Objects (Track T by Artist X) may be different when returned to Nodes that may (in all mathematical probability) have different Nodal (and/or user) Profiles P_{ws}^{node}^{_{—}}ⁿ.

Moreover, note that, in this example, the instructions for the user interface elements of Web Search Template TOP₅ may also be influenced by these factors. Thus, the presentation of the Labels themselves (including such things as geometry and/or color) may differ for Nodes that submit identical “seeds” (as above) but which may have different Nodal (and/or user) Profiles P_{ws}^{node}^{_{—}}ⁿ.

But note that modification of the “seeds” may also take place within the originating Nodes. In any or all implementations of the Network, including but not limited to those cited in the foregoing and those that mat be cite in the following examples and descriptions, the parameters that a Node may generate to obtain search strings may be modified as that Node engages in further activity. That is, in a process that in practice is called “string sharing”, functions within a Node may “share” the “seeds” generated by an activity with functions related to and/or which govern the other activities and, as a Node engages in further activity, the “seeds” may be modified to reflect these further activities.

Thus, in some implementations and in variations of the present examples (without loss of generality to other related operations resulting from these teachings), Activity A at Node 1 may generate “seeds” A(α_{A}) and P_{ws}^{node1} with results described in the foregoing and in example implementations that may follow. As that Node proceeds to Activity B, it may generate “seeds” A(α_{B}^{A}) where the subscript B designates the current “new” activity and the superscript A indicates that Activity A preceded Activity B. In this manner, Activities within a Node (and or between one or more Nodes) may be linked. In implementations, the resulting “seeds” may therefore be modified and may reflect the “context” of Nodal and/or Node-Relational and/or Network-Control Activities. The limits and/or terminus of such linkage may depend on the context of the subject Activities and/or on the requirements of a particular implementation and/or conditions with the Node and/or groups of Nodes.

Note also that such “seed” tracking and seed sharing may be “fed-back” into any of all of the Network Integrated Profile Sets (as described) and that such integration of this and related information may be executed by means of (but may not be limited to) any or all of the “chaining” methods described herein. Note finally that any and or all methods that may track and/or record these and related operations, as described herein, may be executed in relation to “seed” sharing.

To extend a previous example, let Node 1 engage in Activity A such that this Activity may cause that Node may generate “seeds” A(α_{A}) and P_{ws}^{node1}, as above with the result that that Node may receive

$${S}_{{1}_{{α}_{A}^{1}}}^{node 1} , {S}_{{2}_{{α}_{A}^{2}}}^{node 1} , {S}_{{3}_{{α}_{A}^{3}}}^{node 1} {S}_{{4}_{{α}_{A}^{4}}}^{node 1} … {S}_{{5}_{{α}_{A}^{5}}}^{node 1} ,$$

where α^{1 . . . 5} relative to Activity A correspond to the “Labels” 1-5 and Web Search Template TOP₅. Let Node 1 then engage in Activity B. If these Activities implement “seed sharing”, that Node may generate “seeds” A (α_{B}^{A}) and modified Profile ^{B}P_{ws}^{node1} where the anteceding superscript B may represent a modification to that Profile based on the fact that the Node has now engaged in Activity B. (But note that in some implementations, the subject Profile and/or relevant element of that Profile may not itself be modified but that this Activity (and or a record of previous and/or subsequent activity) may be captured in an adjunctive structure.)

Thus, in this example, the resulting strings (that may be generated by and/or delivered to the requesting by one or more Nodes, noting that within such a plurality of Nodes, the originating Node may itself generate the string) may be represented

$${S}_{{1}_{{( {α}_{B}^{A} )}^{1}}}^{node 1} , {S}_{{2}_{{( {α}_{B}^{A} )}^{2}}}^{node 1} , {S}_{{3}_{{( {α}_{B}^{A} )}^{3}}}^{node 1} {S}_{{4}_{{( {α}_{B}^{A} )}^{4}}}^{node 1} … {S}_{{5}_{{( {α}_{B}^{A} )}^{5}}}^{node 1} , where {( {α}_{B}^{A} )}^{1 … 5}$$

correspond to the “Labels” 1-5 within Web Search Template TOP₅. Note however that, as above, Activity B following Activity A in this example may result in a different Web Search Template TOP_{w} where w may represent any number of Tabs. But notes as well that any number of Activities may be subject to such processing such that the resulting “seeds” may contain many “trailing” references.

While the previous example cites “seed sharing” as it related to distinct Activities, note that modification of “seeds” may take place within a single Activity. Thus, the expressions above may additionally be expressed

$${α}_{A ( {x}_{i} )}^{{A}_{( {x}_{i} )} , {A}_{( {x}_{j} )}}$$

where A(xᵢ), A(xⱼ) convey Activity A related to “subject” X and i, j represent the i^{th} and j^{th} such “subjects.

In some implementations, the processes that may be associated with “string sharing” and the operations that may modify and/or augment and/otherwise transform the relevant “seeds” may in addition and/or instead accept information and/or data from other sources. Note that such sources may originate from any location (that is, from Nodes within and outside the Network, such that any Network Nodes may include the originating Node). Thus, the information presented to Node may be influenced by any number of factors, including but not limited those cited in these examples.

Note, however, that in some embodiments, some or all of the functions executed by a central resource in the previous example(s) may be physically co-located within and executed by the Node in question, ands/or such processes may result from a collaboration of one or more external Nodes wherein one or more associated processes may contribute to the generation and/or derivation and/or delivery of the relevant information. Thus, the previous examples constitute example embodiments (wherein there may be central resource PS, for example), but in other expressions, Nodes with the Network may execute some or all of the required processing. In this sense, the previous examples should be understood as equally applicable as a distributed process in accordance with the distributed model described in the foregoing.

The examples demonstrate how information flow within the Network may be conditioned by and/or influenced by and/or otherwise modified by not simply the immediate context of the present Activity of a Node (and/or or groups of Nodes) but by the evolving Profiles associated with that Node (or Nodes). This “dual track” information control may be one characteristic of the Network at any of its Levels (Node-Specific, Node-Relational and Network-Control). Such operations may be extended to “sub-netting” operations wherein one or more processes that may reside at the Network Control Level may aggregate one or more elements of the Integrated Profile Sets associated with Nodes within the Network and may, as one result, create “groupings” of such Nodes based on one or more “correlative” processes. Such “correlative” processes may employ (but may not be limited to) any set of computational techniques such as may be cited herein.

One such result of these processes may be that these groups may be assigned an identity within the Network, and in some embodiments, processes within the Network may dynamically adjust the flow of information to and/or from and/or between Nodes (in response to any Activity associated with a Node and/or with groups of Nodes) based on the relationship of those Nodes (and/or the Activity) to those identified “groupings”. In some embodiments, this “grouping” information may be included within one or more elements an Integrated profile Set associated with a Node (and/or groups of Nodes), and this information may then be used as a factor in any and/or all of the foregoing examples.

Note that, as stated, Nodal and/or Node-Relational and/or Network Control Activities within Nodes and/or as between groups of Nodes may be monitored and/or tracked, and that in some implementations, records of such activities may be operated in order to provide accounting and/or activity monitoring information. In an extension of such an embodiment, such “sub-netting” or groupings of Nodes may be included within such compilations. But note that, in some implementations, certain processes may be instantiated that create information specifically targeted for those groupings within the Network, and as a result, certain information may be presented to certain Nodes in a certain fashion (as above) and other information to other Nodes in another fashion. Moreover, in some instances, the same information may be presented to one group of Nodes in different fashion than as may be presented to another grouping.

In a further extension of these information control methods-noting that these groupings may be derived from profiles and elements of Integrated Profile Sets that may change over time, and thus, these methods may be, by nature, dynamic and/or adaptive—certain additional processes may monitor the response of Nodes and or groups of Nodes to such information flow. In some embodiments, these responses may be complied and/or analyzed by one or more processes and the results of such analysis may be used as factors to modify and/or supplement the Profiles of the subject Nodes (and/or elements of associated Integrated Profile Sets) and/or the content of the information that may be available to those Nodes.

There may be implementations of the Network that may extend the utility of the Network wherein the Data Object Identifier and Data Object Content-Specific Set(s)—and any or all of the characteristics associated with these sets, as described above—may be integrated with another set—the Data Object Normative Set {ON_{T}_{ᵢ}}. The addition of this component may enhance the Adaptive capability for Nodes within the Network and/or for the relationship between Nodes within the Network and/or the elements that may control the Network.

That is, the Data Object Normative Set(s) described in the following and in related example implementations, may be utilized as an Adaptive component variously and at any time at the Node-Specific Level and/or at the Node-Relational Level and/or at the Network Control Level. Further, in a manner consistent with the foregoing descriptions, processes and/or Data Objects associated with the Data Object Normative Set {ON_{T}_{ᵢ}}may be modeled as distributed, and thus may be instantiated independently of their location within the Network. Note also that, in manner consistent with the foregoing, processes and/or Data Objects associated with the Data Object Normative Set {ON_{T}_{ᵢ}}may be instantiated within Nodes that may operate as enabled and/or partially-enabled and/or disabled, such that these Nodes may operate in this manner variously and at any tine, depending on the context of the Network and Nodal activity. Thus, in the following descriptions and example embodiments, the processes and/or Data Objects associated with the Data Object Normative Set {ON_{T}_{ᵢ}} may operate within Nodes that may, variously and at any time be in Standalone, Hybrid and/or Pure Mode, as described above.

Note also that some implementations may use some or all the elements of the Data Object Normative Set {ON_{T}_{ᵢ}} within the “Fixed” Layer of the Network. Note, again, however, that in some implementations, the non-Adaptive aspects of the system may co-exist with the Adaptive elements, and that in some implementations, either may be instantiated without the other. Note also that such functionality may permit, in some implementations, Nodes that are enabled only for some aspects of these methods to interact with and/or to integrate with Nodes that may be enabled with the same and/or with different aspects.

Note further that some implementations cited in the following descriptions may be based on an implementation of the Adaptive components as related to the music tracks within the Network, but as mentioned in the foregoing, these methods apply without loss of generality to any type of Data Object within the Network.

The Data Object Normative Set(s) may compose and/or may be derived from a set of criteria that forms a basis against which the elements that compose the system may be measured. That is, the measurement criteria may be formalized into one or more Data Object Normative Set(s) {ON_{q}}composed of one or more Matrices [ON]_{q} to create a normative basis that may be distributed among the Nodes in the Network.

Referencing FIG. 31, and in the descriptions that may follow, note that the term “Objective” may be understood to encompass the fact that the criteria may not be specifically derivative of any particular Data Object, but may be derived from and/or created by and/or modified by and/or otherwise instantiated from a set of conditions and/or criteria that may be derivative of and/or related to one or more elements with any of the attribute Matrices [A]_{T}_{ᵢ}^{v} that may be present in the Network, and/or may be completely independent of any or all of such attribute Matrices [A]_{T}_{ᵢ}^{v}, and/or may be result from some combination of independent and/or factors that derive from such attribute Matrices [A]_{T}_{ᵢ}^{v}.

As noted above, the normative criteria that form the basis of the Matrices [ON]_{q} that may compose elements within the Data Object Normative Set {ON_{T}_{ᵢ}} may be used at and/or may be modeled to reside at the Node Specific Level, and/or at the Node Relational Level and/or at the Network Control Level within the Network. But note that in some implementations, the criteria that may provide the foundation for this normative basis may be different for each of these Levels, but in other implementations, some portion of these elements, or all may, variously and at any time (depending on the context) be shared between these Levels. In other implementations, the normative basis may be shared by the Levels initially but may evolve and/or be modified and/or be extended and/or may be otherwise changed by processes and/or by Data Objects that reside at those Levels, and these changes may or may not be shared, and/or may be shared but used selectively and/or adjunctively and/or sequentially, variously and in any combination, depending on the system context.

In the following description, as it applies one possible implementation that deals with entertainment-related activities, this normative measure is generally referred to as Format. In practice, Format may refer to the radio format structure that defines the broadcast and/or distribution markets for popular music. But in fact, as mentioned, this normative element may be based on and/or derived from any criteria or on a combination of separate criteria, including, but not limited to criteria related to images, text and/or any other Data Object. Further, any number of normative elements may be integrated and used in any aspect of the system variously and at any time, depending on the context.

In one implementation wherein the subject data is music, one of the Data Object Normative Matrices {ON_{T}_{ᵢ}} is based on and/or derived from Format. Thus, one Normative Matrix subsumes a set of one or more attribute Matrices [A]_{T}_{ᵢ}^{v} derived from musical tracks that may be used to represent form one or more Format Archetype Sets {FA} where {FA}ⱼ represents the j^{th} such set. Thus, the j distinct Formats may be formally represented as {FA}ⱼ={T₁^{j} . . . Tₗ^{j}} where Tₗ^{j} represents the l^{th} element (Track) in set j. The number of these the Objective “poles” in the Adaptive system is designed by the index j. It will be understood that the use of mathematical expressions herein is descriptive only, and represents generalized relationships rather than specific procedures or algorithms, although a number of suitable mathematical operations may be substituted for many of the descriptive relationships suggested by these expressions. It will also be understood that, while Matrices are generally described herein as matrices of content attributes, that a matrix may also, or instead, include metadata, keywords, or any other objective data, or that an attribute may be an item of metadata, a keyword, or the like. Thus, while in some embodiments, elements of the system described herein such as the classification scheme or the taste infrastructure may employ matrices of attributes derived from content, these matrices may be combined with or include representations of metadata, keywords, annotations, or other data that may assist in data attraction and other operations of the systems described herein.

The derivation of these archetypical attribute matrices may be viewed as a type of system initialization for the Adaptive network wherein the Objective elements that form the basis of the criteria around which the self-organizing aspects of the system emerge are specified, elements that serve as points of reference for the Adaptive nature of the Network.

Note, however, that these “poles” are not limited to the j Format Archetype Sets. There may be additional Archetype Sets not related to Format as that term is described above. Thus, more formally, {FA}ⱼ may be represented {{FA}ⱼ . . . {F′A}_{q}} where {F′A}_{q} represents other types of archetypical matrices. But without loss of generality with respect the multitude of other expressions, the following discussion will represent this method with {FA}ⱼ.

In one example implementation, the first step in the process of deriving the format profiles is to define the number of Formats, j. The number of elements (music files in this description, but which may be any Data Object) in these sets will vary, but in one implementation, the criteria by which these tracks are selected may be based in part on accessing and compiling historical data such as the format to which music files have been assigned for radio play and distribution. The number of tracks in each set may be chosen to be large enough so that the associated musical attributes in aggregate represent an archetypical set of attributes associated with that musical genre.

One example of such an implementation may be seen in the following example. A Database may be assembled consisting of the sets {FA}ⱼ where each set may consist of the tracks associated with that format. The Track Attributes for each set {FA}ⱼ may be extracted, creating a set of matrices {[F]ⱼ}. Thus, this database may consist of j sets of matrices that may subsume of the attributes of all the reference tracks associated with each format.

This may be formally expressed:
{[F]ⱼ}={[A]_{T}_{₁}^{j}, [A]_{T}_{₂}^{j} . . . [A]_{T}_{₁}^{j}}
where [A]_{T}_{₁}^{j}=(_{j a̅}₁^{T}^{₁} . . . j a̅ₙ^{T}^{₁})

Thus, in this manner, a Format Meta-Profile Matrix [FM]ⱼ may be derived for each of the j Formats. This Format derivation process may examine the attribute Matrix [A]_{T}_{ᵢ}^{j}=( a̅₁^{T}^{₁} . . . a̅ₙ^{T}^{₁}) of the aggregated attributes of the I tracks associated with each of the j profiles and derives a Matrix of Meta-attributes [FM]ⱼ that may comprise the attributes associated with that Format._The j sets of Meta-attributes matrices [FM]ⱼ are stored for reference in the system.

Thus, in formal terms:

$${[ F M ]}_{j} = {[ F ]}_{j} * {\sum }_{1}^{l} {[ A ]}_{{T}_{l}}^{j} = ( a {o}_{1}^{j} … a {o}_{n}^{j} )$$

Where aoₙ^{j} represents the where the n^{th} vector in the array and germane to the j^{th} Format and the operator * denotes this recursive optimization operation

The objective criteria that compose the Matrices [ON]_{q} within the set {ON_{q}} (that may be composed as a set of mathematically criteria compatible with the elements within attribute Matrices [A]_{T}_{ᵢ}^{v}) provide a measurement or “Normative Relational” basis by means of which the Data Objects from which they may be derived to be measured. These operations produce the Data Object Normative Relational Set {OR_{T}_{ᵢ}^{v}}_{q} where q represents the q^{th} set of criteria as applied to the v^{th} attribute Matrix [A]_{T}_{ᵢ} as it applies to the i^{th} Object T in the Network (and where q≧1, v≧1, i≧1).

The foregoing description may be expressed mathematically as follows:
{OR_{T}_{ᵢ}^{v}}_{q}=({ON}_{q}*{OC}ᵥ)_{T}_{ᵢ}
where * represents a relational operation that produces the measurement criteria and where q represents the q^{th} set of criteria and V represents the v^{th} attribute Matrix [A]_{T}_{ᵢ} within the Data Object-Specific {OC}.

Referencing FIG. 25, it can be seen shows how the Normative elements and the related Normative Relational Matrices may be applied at the Node-Specific, Node-Relational and Network Control Levels.

In practice, this set of methods may provide the means to quantify the relationship of the attributes derived from any Data Object within the system (Tᵢ) (as embedded in one or more associated Attribute Matrices [A]_{T}_{ᵢ}) against some nominal set of criteria (embedded in some Normative Matrix [ON]_{q}) and to embed the results of this measurement in a set of Matrices [OR_{T}_{ᵢ}] (where this set is called the Data Object Normative Relational Set {OR_{T}_{ᵢ}}). But as expressed in the formula above, this operation may be repeated for any number of Attribute Matrices (where that number is denoted q) against any number of Normative Matrices [ON]_{q} (where that number is denoted v) and may be applied to every Data Object in the Network (Tᵢ).

There are many methods that may be used for the relational process and any implementation may use one or more of these methods discretely and/or sequentially and/or in combination variously and at time, depending on the context. The operator * may, for example, measure the Euclidean distance of each vector in some Matrix [A]_{T}_{ᵢ}^{v-x} (as derived from some data Object Tᵢ) from a Normative Matrix [ON]_{q-w}, producing the Normative Relational Matrix [OR_{q-w}^{v-x}]_{T}_{ᵢ}. Another operator *′ may measure, as another example, the Hamming distance. Other operators may be based on and/or may use statistical analysis, linear algebraic transformations and any other known linear operations, including network theory-based algorithms. One set of operators *ₑ^{T} may derive eigenvalues and may use these derivations to operate upon the matrices.

Further, any or all of these algorithms may be supplemented by and/or used adjunctively with and/or sequentially and/or in combination, variously and at any time (depending on the implementation and the/or the context) with either heuristic pattern recognition techniques and/or with neural net-based algorithms (or in combination in any order) where, for example, the latter may include (but may not be limited to) the use of neural net techniques that may derive a differential neural pattern such that the weights of the connection to the reference basis vectors serve as the correlative criteria. Finally, so-called hybrid AI pattern recognition may be applied wherein both rule-based evaluation and neural net connection weighting is used, either in standalone fashion and/or with any of the techniques associated with linear operations.

Note that the non-Adaptive aspects of a network or system or individual Node (or some combination) may also use the derived relational elements. To avoid confusion with the implementation described in the foregoing where the relational matrix [TF]ᵢ^{j} is tied to the musical attributes of a media file, let Matrix [DO]_{q}^{k} constitute a relational matrix consisting of the results of the some set of correlation functions ● that provide a measure of the distance between the elements of Matrix [O]ₖ which represent the attributes of the k^{th} data Object within a system, and Matrix [D]_{q}, the q^{th} instance of a set of normative criteria.

In one set of implementations, the k Data Objects may be processed such that the derived attributes (embedded in [O]ₖ) are associated with that Data Object, and the relationship of those attributes in Matrix [O]ₖ to a set of Objective criteria embedded in Matrix [D]_{q} may be contained in the associated relational Matrix [DO]_{q}^{k}, such [O]ₖ●[D]_{q}=[DO]_{q}^{k}. The relational matrix for the k^{th} data Object Matrix [DO]_{q}^{k} is then appended or otherwise associated with that k^{th} data Object. Whenever a Node within the network or system accesses that k^{th} data Object, the relational Matrix [DO]_{q}^{k} may also be referenced. Thus, the specific positive action of accessing that k^{th} data Object triggers access to the Matrix [DO]_{q}^{k} that provides a measure of the relevance of that Data Object to some set of criteria. In this manner, the k data Objects in the system may be linked to one another through the strength of their relationship to each of the q archetypical matrices [D]_{q}.

Note therefore, that the previous example implementations may integrate one or more Relational Matrices of this type ([DO]_{q}^{k}). In this manner, operations that involve use of and/or which may reference Nodal (and or user) Profiles (and/or groups of Nodal (and/or user) Profiles to produce results (as described in example implementations in the foregoing) may additionally and/or supplementally and/or exclusively use one or more Relational Matrices to influence and/or to condition and/or to manipulate and/or to extend and/or to otherwise enhance their operation.

The Adaptive nature of the Network and the Nodes within the network are based on the creation of the Data Object Normative Relational Elements. This set is derived by the application of one or more measurement techniques that quantify the relation of any Data Object to one or more archetypical meta-profiles.

In practice, the implementation described in the foregoing may uses the music-related Meta-Attributes matrices [FM]ⱼ to derive the relationship between each music track to each of the Formats, though as stated, any Data Object or executable may be measured, using appropriate techniques.

Extending previous examples, in one embodiment in the Network, such Normative Relational measurement may be accomplished by executing the Format Correlation Function. This function may analyze the relationship between the content attributes for each track with those associated with each derived Meta-Attribute (“Format” in this case) and may produce a unique Track Format Matrix for each track, [TF]ᵢ^{j} where j represents the relevant Format derivation as applied to the i^{th} Track.

Recall that the track attribute matrix for the i^{th} track is represented as:
[A]_{T}_{_{i={ a̅}}₁^{T}^{_{i . . . a̅}}ₙ^{T}^{_{i}}}

The Format Correlation Function (which may produce a Track Format Matrix for the i^{th} track) may be derived as follows, where the operator ● represents this correlation operation. Thus:

$$\begin{matrix}{[ TF \}}_{{T}_{i}}^{j} = {[ A ]}_{{T}_{i}} {• [ F M ]}_{j} \\ = \{ {\overline{a}}_{1}^{{T}_{i}} … {\overline{a}}_{n}^{{T}_{i}} \} {• [ F M ]}_{j} \\ = \{ {{\overline{r}}_{1}}^{{F}_{j} , {T}_{i}} … {{\overline{r}}_{n}}^{{F}_{j} , {T}_{i}} \}\end{matrix}$$

where r̅ₙ^{F}^{ⱼ}^{,T}^{ᵢ} represent the n^{th} vector related to the j^{th} Format as derived from the ● operation on Track Tᵢ, and r̅ₙ^{F}^{ⱼ}^{,T}ᵢ= a̅ₙ^{T}^{_{i● a̅}}ₙ^{F}^{_{j.}}

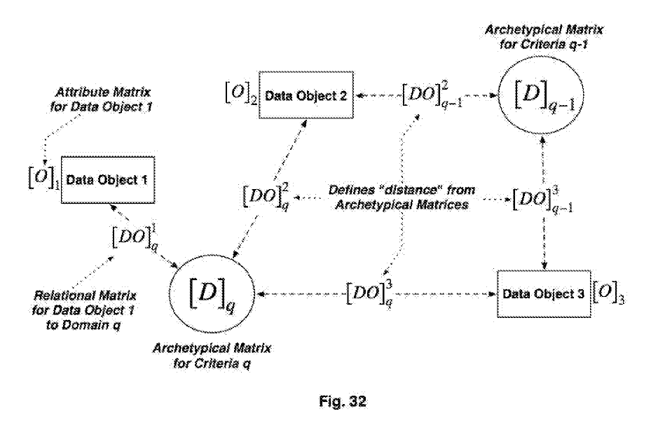

In the one example implementation, shown in FIG. 32, Data Objects 1, 2 and 3 may have derived Attribute Matrices [O]₁, [O]₂ and [O]₃, while there are two “Meta-Attribute” Matrices [D]_{q} and [D]_{q-1}. The operation [O]ₖ●[D]_{q}=[DO]_{q}^{k} (where k−=1, 2, 3 . . . ) defines the “distance” or relationship between the Object attributes and the criteria embedded in the “Meta-Attribute” matrices. Thus, Data Object 1 is closer to [D]_{q} than Data Objects 2 and 3; but Data Object 1 has no relationship to [D]_{q-1} while Data Object 2 is more closely related to [D]_{q-1} than data Object 3. In mathematical terms, this “distance” might be formally represented and derived and operated upon in any number of ways, as described above.

In some implementations, the operation [O]ₖ●[D]_{q}=[DO]_{q}^{k} may provide one or more Layers of abstraction through which Data Objects may be linked without reference to the specific content within the Data Object itself. That is, in some implementations, Data Objects may be assigned a relevance weighting—defined by some ontology or set of ontologies which may be embedded in the operations that produce [O]ₖ, [D]_{q}—in relation to the Objective “poles” in the system, but these relevance weights may not be based on keywords or key phrases but are based on the abstraction defined by the attribute derivation which is content-emergent according to a prescribed ontological scheme.

In some implementations, this structure may be used in conjunction with the “data attraction” methods previously described and may allow automated prioritization of information within Nodes and within the Network. Thus, in the foregoing example illustrated in FIG. 32, if a user selects and/or interacts with and/or otherwise accesses Data Object 1, Data Object 2 might be given priority over Data Object 3, and/or may be presented differently. Likewise, if a use selects and/or interacts with and/or otherwise accesses Data Object 3, Data Object 1 would be presently differently than data Object 2, but Data Objects 2 and have an additional relationship to [D]_{q-1}, and thus data Object 2 might be presented with this additional dimension.

Note that any and/or all of the previously cited embodiments wherein the flow of information may be controlled by means of one or more Nodal (and/or user) Profiles and/or Integrated Profile Sets and/or any elements therein as they may be instantiated within the Network and/or within Nodes and/or which may control actions between Nodes, may use, as elements in these calculations, the extensions provided by the Normative and Normative Relational elements.

Note further that these extensions may, as in the foregoing and with respect the related elements of the Data Object Set (including, for example, the Object Identification elements and Content Specific Elements) be accessed by and/or utilized by and/or may influence methods an/or Data Objects within a Node which may, variously and at any time (depending on the context) be in any Mode (Standalone, Hybrid and/or Pure) and in any state (enabled, partially enabled and/or disabled and/or non-enabled) and may be accessed and/or utilized by and/or otherwise operated upon by processes that may exists at by any Layer and/or Level in the Network.

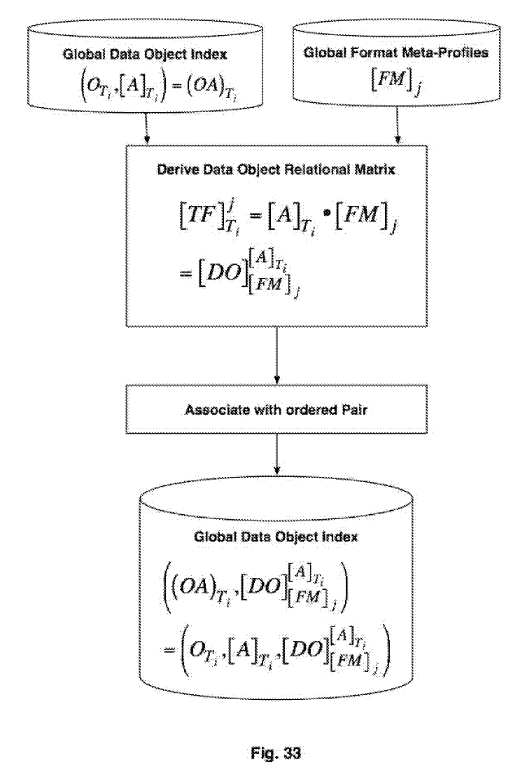

FIG. 33 reflects how the Relational Matrix may be associated with each Data Object in the Network. Recall from FIG. 18 that ordered pairs (O_{T}_{ᵢ}, [A]_{T}_{ᵢ}) (OA)_{T}_{ᵢ} may be associated with data Object T where Data Object identifier O_{T}_{ᵢ} may refer to Data Identifier O as it is associated with the i^{th} instance of Object T and where [A]_{T}_{ᵢ} may denote an Attribute Matrix (noting that there may be more than one such Matrix associated with a Data Object). Thus, in embodiments (including those cited in the foregoing), the Relational Matrix

$${[ DO ]}_{{[ FM ]}_{j}}^{{[ A ]}_{{T}_{i}}}$$

may be additionally associated with the relevant ordered pairs, where the subscript [FM]ⱼ refers to the j^{th} Meta-Profile Matrix, as above.

Thus, noting again that each object may have more than one Attribute Matrix and each Attribute Matrix may have more than one Relational Matrix (since there may be more than one Meta-Profiles [D]_{q}:

$$( {( OA )}_{{T}_{i}} , {\sum }_{{i = 1 … n}_{{j = 1 … m}_{v = 1 … q}}} {[ DO ]}_{{[ F M ]}_{j}}^{{[ A ]}_{{T}_{i}}^{v}} ) = {\sum }_{ι = 1 … n} ( {\sum }_{{v = 1 … m}_{j = 1 … q}} ( {O}_{{T}_{ι}} , {[ A ]}_{{T}_{ι}}^{v} ) , {[ DO ]}_{{[ F M ]}_{j}}^{{[ A ]}_{{T}_{ι}}^{v}} )$$

In this manner, as noted, the processes cited in the foregoing that control information flow within the Network may use elements in Normative Relational Set in processing and/or operating upon accessing and/or otherwise modifying Data Objectsone set of implementations, a user may search for and access data Objects by requesting “similar things”, without referencing the actual content itself, rather, search and access may be based on the degree to which system and nodal Objects are related to the abstracted elements of the seed Object. In some implementations of this type, there may be operations based on a unit Matrix where [D]_{q}=1, with the result that the system will “attract” or “link” Objects based on their simple correspondence to the seed attribute matrix.

In some implementations, using this set of methods, advertising for and/or links with goods and services may be “attracted” to Data Objects without specifically being indexed to those Objects. This represents an extension to the “data attraction” techniques described in the forgoing in that those previously cited may have based the “attraction” on elements of the Data Content Set and not elements on the Normative Relational Set associated with the subject Data. In this sense, these and related extensions may provide an additional type of “automated data-based magnetism” wherein information is flowed to and from Nodes and/or users and/or groups of users based on the defined ontology or set of ontologies embedded in the system by means of Matrices [D]_{q}.

To further illustrate these teachings, in one example implementation, an online bookstore (for example) may index its offerings (Data Objects) by deriving a set of knowledge-based semantical expressions related to books and embedded in a set of attributes Matrices [O]ₖ. A set of Objective representations may then be generated and embedded in another series of archetypical Matrices [D]_{q}. Further, a set of advertising Objects may have a similar set of attribute Matrices [AD]_{P}. Thus, using the operations: [O]ₖ●[D]_{q}=[DO]_{q}^{k} and [AD]_{P}●[D]_{q}=[ADO]ₚ^{q}, whenever a customer accesses the k^{th} Data Object (a book title for example), the advertising Data Objects with the appropriate relational Matrices [ADO]ₚ^{q} would be “flowed toward” or “attracted by” that customer. This and other such implementations may be used adjunctively and as a supplement to known “collaborative filtering” techniques and behavior modeling systems, wherein a customer's history and past and current behaviors may be linked to the histories and behaviors of other customers. The operation of these well-known systems may be enhanced by the methods described herein, either adjunctively or in a fashion where the information from the respective systems is merged.

Thus, in some implementations, the described system may be used to embed an abstracted semantical layer to data search and data access systems. One advantage in this approach is that a variety of additional computational technologies may be integrated including but not limited to signal processing technologies, pattern recognition technologies, network and relational mathematics and advanced statistical and linear transformation techniques.

There are other implementations that may apply to Enterprise environments where corporate Data Objects may be assigned a relational matrix measured against or linked with a defined ontology. As noted below, these implementations may be adjunctive to and/or may be supplemental with other network structures (such as sub-netting and workgroup assignments) and/or user and/or group profiling techniques wherein such individuals and/or groups of users would assume or be assigned a relational definition relative to the Objective, archetypical matrices [D]_{q}.

One difference between this method of abstracted associative search and keyword search is that Objects may be indexed and thus cross-referenced based on the relationship between a set of content-derived attributes to an external ontology (or a set of meanings). But the selection of relevance is based on the relationship of the derived attributes to that meaning as embedded in Matrix [D]_{q}.

These techniques may similarly be applied to metadata.

Note that the methods and implementations previously described related to Integrated Profile Sets and Node (and/or user Profile) may also incorporate one or more elements of the Normative Relational Set. As described in the foregoing, for example, a Node may possess an Integrated Profile Set, but one or more elements of this Set may each have one or more Normative Relational Matrix associated with the related Attribute Matrices. Thus, one or more elements of the Integrated Profile Set may have one or more measurement elements that may reflect the relationship of those elements to one or more Normative Matrices.

One implementation of the methods related to Normative Relational Matrices may also be seen in the sub-netting methods previously described wherein Nodes may be grouped by the nature of their Nodal (and/or user) Profile and/or Nodal Integrated Profile Sets. In the previously cited example implementations, such groups and methods associated with their creation and/or maintenance within the Network may be derived from aggregating one or more elements from one or more Nodal (and/or user) Integrated profile Sets within the Network, such that some of that data may have been gathered from connected Nodes, any of which in any may, variously and/or at any time be in any state—enabled and/or partially-enabled and/or non-enabled and/or disabled—provided that, in the event that any of those Nodes are a state other than enabled, that processes related to generating and/or transmitting one or more of the elements are active and present, as may be required to participate in the aggregation process.

One result of such aggregation, as described in previous example implementations, may be the creation of “sub-nets” wherein Nodes (and/or users) that may possess certain characteristics within one or more elements of their Integrated Profile Sets may be grouped with others, according to one or more criteria. One result of such groupings may be that the interaction between these “similar” Nodes may be optimized and/or otherwise encouraged since one or more elements of their Integrated profile Sets may indicate, according to one or more criteria that may motivate the grouping, that such grouped Nodes may share interests. Such optimization may be executed by means of methods that may operate on one or more Data Objects related to such activity, which methods may be instantiated at the Node-Specific Level and/or the Node-Relational Level and/or the Network-Control Level. That is, the methods that execute and/or which may respond to such groupings may operate upon and/or may respond to one or more Data Objects (which may be related to and/or which may be derived from one or more elements of an Integrated profile Set) related to such groupings in a manner wherein the results of the execution may be evident in Nodal-based activity (and thus such methods would be related to the Node-Specific Level) and/or to the manner in which Nodes may interact with one another (Node-Relational) and/or the manner in which Nodes may be operate within the Network (Network Control levels).

Further, as noted in previously cited example embodiments of the Network, information flow within such groups and/or to and/or from Nodes so grouped and/or into and/or out of such groups may be changed and/or otherwise modified based on one or more elements of the associated Integrated Profile Sets and/or based on one or criteria that may form the basis of the groupings. Moreover, such groups may be named and/or provided with an identity. Finally, note again that assignment to and/or participation in such sub-nets may itself compose and/or may influence one or more elements in such Integrated Profile Sets, and that in embodiments that may include activity monitoring, records and/or data that may be derived from such activity may compose and/or may influence one or more elements of related Integrated Profile Sets.

In some embodiments of the Network, such Nodal aggregation may be called Neighborhoods. In an extension of the creation and/or maintenance and/or operation of such Neighborhoods and their related methods and Data Objects, one or more elements that may be derived from and/or which may be related to one or more elements of the Data Normative Relational Set may be integrated into these embodiments. Thus, in embodiments where Integrated Profile Sets may be used, as described in the foregoing, one or more Normative Relational Matrices may be additionally integrated and may be associated with one or more elements of those Sets.

Thus, extending a previously cited example embodiment wherein the subject Data Objects may be music files—noting again that any Data Object may be subject to these processes—one or more Meta-Profiles may be derived or otherwise created, and one or more Relational Matrices may be associated with each file, as cite previously. But in implementations that may create one or more Profiles of the local media library associated a Node (and/or with a user at that Node), these Relational Matrices may be used to create a measurement of the “distance” (as described above) of one or elements of that Node-encompassing Profile to one or more Meta-Profiles. (But note that some implementations of such methods may instead and/or additionally measure the relation of any vector or other component that may comprise a Profile as related to a given Data Object, and the following description may encompass such sub-Profile dimensional correlation).

Thus, using any or all the methods previously cited (and/or additional methods that may be obvious to those skilled in this art), sub-nets and/or groupings of Nodes (and/or users)—Neighborhoods—within the Network may be created and/or maintained based on measurements that may be contained within and/or revealed by and/or which may be inferred from these Relational Matrices and/or from Data Objects that may be derived from and/or which may otherwise result from such operations related to such relational structures.

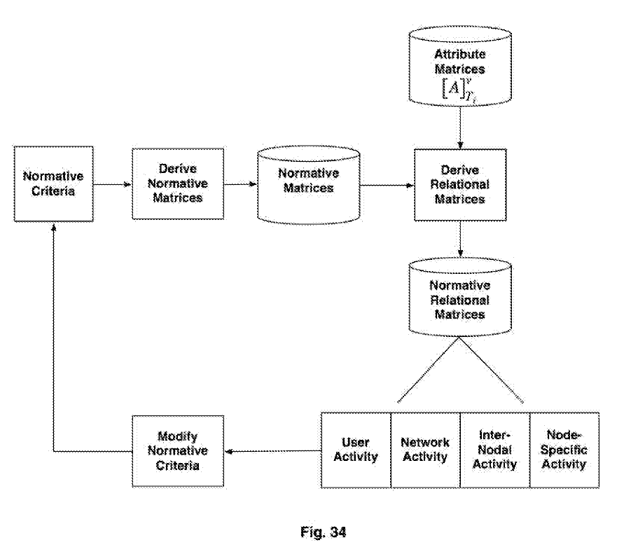

Note that, as cited out in the foregoing, the creation and/or maintenance and/or modification such Relational Matrices may include any and/or all such methods related to Attribute and/or Profile Matrices, including (but not limited to) “chained” operations. FIG. 34 shows one example of how such Relational Matrices may be constructed.

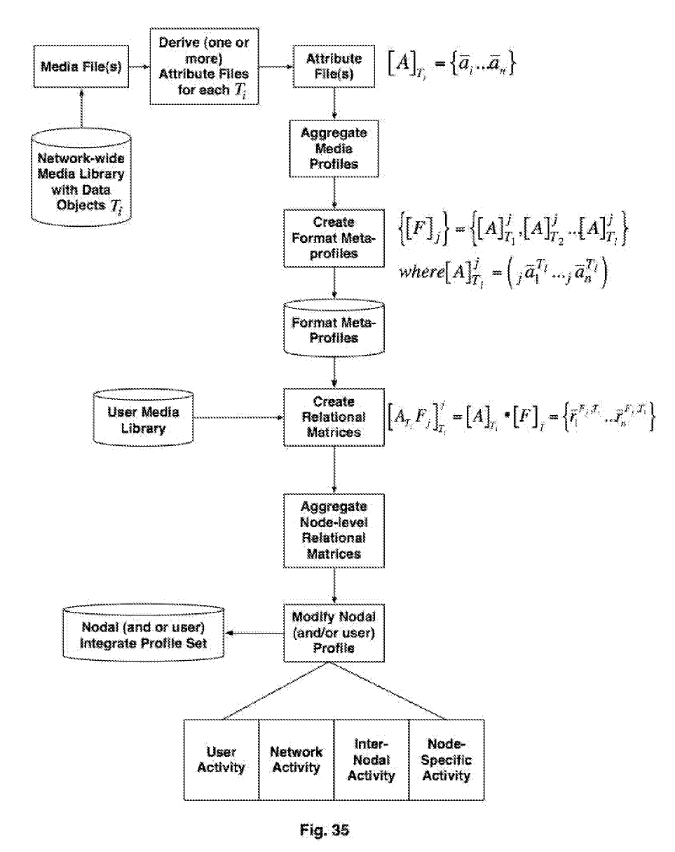

In one example embodiment of these teachings, again citing music files as one example Data Object that may be subject to these methods, and extending the previous examples, as shown in FIG. 35, Data Objects Tᵢ may be processed to derive one or Attribute Matrices [A]_{T}_{ᵢ}, and, as described in the foregoing, one of more such files may be used to derive one or more Format Meta-Profiles. These Meta-Profiles may be transmitted to Nodes within the Network such that those Nodes may then create one or more sets of Node-level set of Relational Matrices as described previously using the Node-Level user Library. (Note, however, that, as noted in the foregoing, one or processes that may be related to such Node-level derivation operations may not be required if the subject Node is enabled to process its library to associate the elements of that library with the Data Object indices and the ordered pairs previously cited. But some elements of that Library may not have such associations and/or that Node may not be fully enabled (at the time of this operation) to execute that association. Thus, this operation is included in FIG. 35 for completeness, but may not be necessary in all cases.)

In any and/or all cases of these example embodiments, subject Nodes may then aggregate the Relational Matrices through one or more operations where such operations may include (but may not be limited to) those cited in the foregoing. In some embodiments, one or more Node-level Relational Profiles may be generated, and one or more elements of those Relational Profiles may be integrated within and/or may modify existing elements of one or more Nodal (and/or user) Integrated Profile Sets.

Note, however, that as there may be one or more activities and/or Data Objects related to any or all the elements of one or more Integrated Profile Set(s), one or more monitoring processes may be related to and/or may reflect activity that may be user-based, and/or Network based and/or inter-Nodal based and/or Nodal based, and thus, one or more processes may modify one or more elements of such Sets.

In one aspect, the Network may support Neighborhoods, or groups of addressable Nodes within the Network, through a sub-netting infrastructure that supports social networking and similar functions. In one example embodiment of the Network, the previously cited methods support sub-netting (and/or Neighborhoods) within the Network wherein one or more Relational elements may be aggregated on a Network-wide basis.

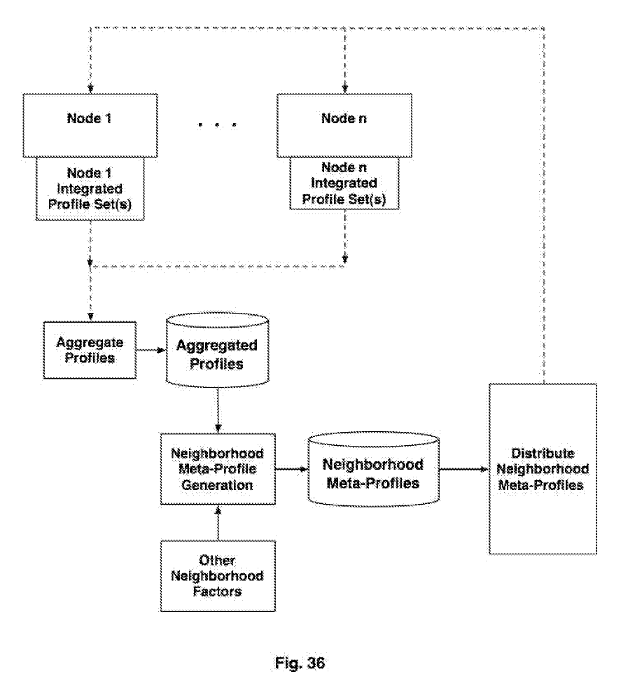

As shown in FIG. 36, such Neighborhoods may be derived by such aggregation of one or more elements of one or more Nodal (and/or user) Integrated Profile sets that may reside at one or more Nodes. As shown in FIG. 36, this aggregated data may be combined with other factors to create a Neighborhood Meta-Profile where such a Profile may be derived using methods for Meta-profile generation, as described above. These Neighborhood Meta-profiles may then be used by or more Nodes to generate or more Neighborhood Relational Matrices. These Neighborhood Relational Matrices may be created at each Node such that the information contained therein and/or which may be stored in associated Data Objects and/or control documents (as cited above) may be influenced and/or otherwise modified by and/or supplemented with other factors as may be contained in any and/or all of the Matrices and/or related Data Objects cited in the foregoing, including but not limited to user feedback and other objective criteria, depending on the requirements of the embodiment and the Network.

Further, these Neighborhood Relational Matrices may be used by and may influence and/or may be used in conjunction any and/or all of the methods and/or Data Objects cited in the foregoing and/or with those that may be obvious those skilled in the art. Such integration may include (but may not be limited to) any and/or all methods and Data Objects that control and/or condition and/or which may operate upon (at any Level and/or any Layer and/or regarding Nodes that may be in any state of enablement and/or in any Mode) information and/or Data Objects and/or access to information and Data Objects, including but limited to the previously cited NRM, Web Search and other related methods.

Moreover, any such activity may also be monitored by and/or controlled by and/or modified by any and/or all previously cited methods (and/or those that may be obvious those skilled in the art) and records of such activity may be compiled and/or operated upon.

One embodiment that may incorporate such features within the Network may be called a Taste system wherein activity related to one or more Nodal (and/or user) Integrated Profile Sets(s) and/or to a Neighborhood system (as described in but not limited to the foregoing) may be monitored and/or may be responded to within the context of implementations of such system. A Taste system may, in one example embodiment, incorporate one or more of the previously cited methods with one or more additional methods (such that any such methods may reside on one or more nodes) which, by virtue of combinations of such methods may control information that may flow to and/or from and/or between and/or which may be “attracted to” (as described in the foregoing wherein one or more methods that may be related to embodiments of the network that may include “data attraction” functions as described (but wherein such methods may not be limited to such descriptions in that many variations may be obvious to those skilled in the art)) and/or which may other otherwise influence and/or modify processes and/or methods and/or Data Objects within the Network. As with any and/or all previously cited example embodiments and related methods described herein (and those that may become obvious to those skilled in the art), any of these combinations that may compose embodiments of a Taste system integration may include (but may not be limited to) any and/or all methods and Data Objects that control and/or condition and/or which may operate upon (at any Level and/or any Layer and/or regarding Nodes that may be in any state of enablement and/or in any Mode) information and/or Data Objects and/or access to information and Data Objects, including but limited to the previously cited NRM, Web Search and other related methods.

A Taste system or taste management infrastructure may use one or more methods within example embodiments of Neighborhood sub-netting methods, as described in the foregoing. Thus, the elements that may compose factors that may be considered in computing the relationship of one or more elements one or more Nodal (and/or user) Integrated Profile Sets (that may be associated with Nodes and/or with groups of Nodes) may be considered measurements of the relevant user's “taste” and/or the “taste” of groups of users. Thus, the information that may be presented to that user (and/or groups of users) (through and/or using any and/or all of the previously cited methods and obvious variations) may be conditioned by and/or influenced by and/or otherwise modified these relational factors.

Such a system may be “dynamic” in that those elements that may contribute to one or more parameters that be factored into the creation and/maintenance of sub-nettings within a Network—that is, the “boundaries” of the Neighborhoods with a Network—may evolve and/or be modified over time in response to any number of stimuli. Such stimuli may include (but may not be limited to) changes in the composition of the Nodal (and/or user) Integrated Profile Sets, wherein such changes may occur for any reason, not limited to those cited.

Note further that the elements that may define one or more parameters that may be used to the creation and/or modification of sub-netting and/or Neighborhoods within embodiments of the Network may additionally and/or exclusively include objective criteria that may not be content-derived, but which may be based and/or derived from one or more criteria such that any and/or all of such criteria may be mandated based on objective factors. Thus, as one example of such an embodiment, a Neighborhood that may have been derived (as above or using related methods) from one or more elements that may compose Nodal (and/or user) Integrated Profile Sets within the Network may be further defined and/or modified and/or sub-divided (such that this action may sub-net a sub-net). This sub-netting may proceed to any level of granularity such that one or more resulting “sub-sub-nets” may compose one or Nodes and/or one or more groups of Nodes that may be distinguished by the degree to which they correspond to one or more of the nominated criteria. In this manner, information that may flow from to and/or from Nodes within the Network may be controlled and/or conditioned.

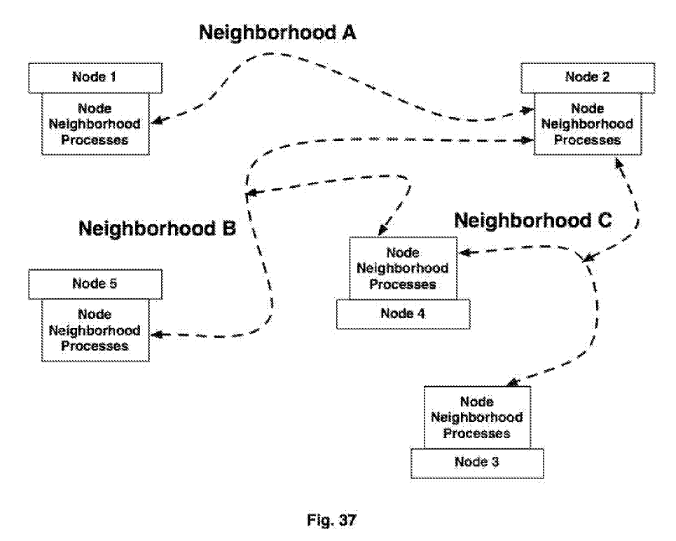

In one example embodiment, as shown in FIG. 37 let Neighborhood A, B and C be derived using the previously cited methods as shown in FIG. 36. As noted, the definition of a given Node's relationship to the Neighborhood Meta-profiles that may define A, B and C may be contained in and/or may be derived from one or more elements of one or more Nodal (and/or user) Integrated Profile Sets associated with that Node, and/or maybe composed with one or more related Data Objects and/or control documents accessible within the Network. (As noted above, however, other criteria may be used to determine this relationship, including (but not limited to) input that may be harvested and/or gathered from and/or by one or more users associated with that Node.)

Referencing FIG. 37, Nodes 1 and 2 may be offered information and/or such information may be influenced by and/or modified by and/or may formatted based upon (but not limited to) the relationship of one or more elements within one or Integrated Profile Sets (associated with Node 1 and Node 2) to one or more the Meta-Attribute Profiles (and/or other factors) that may define Neighborhood A (as described in the foregoing). In addition, some such information that may be flowed to and/or from Nodes 1 and 2 as result of their inclusion in Neighborhood A may also be influenced by and/or modified by and/or may be formatted differently for Node 1 and for Node 2 due to differences that may be represented in one or more elements of one or more Integrated profile Set(s) that may be associated with those Nodes, and or by other factors such as (but not limited to) user options. One such example may be that web search results (as described in the foregoing) related to any and/or all related activities may be different for Nodes 1 and 2 in that the “seeds' may have one or more Nodal-derived elements that may differ.

In this illustrative example of an embodiment of a “taste”-related Neighborhood within a Network (again referencing FIG. 37), Nodes 2, 4 and 5 may be considered part of Neighborhood B, while Nodes 2, 3 and 4 may be considered part of Neighborhood C. Note here that, in this example, there may be “overlap” in that Node 2 may be considered part of all three Neighborhoods in this example, but that Node 1 and Node 3 are only part of Neighborhoods A and C respectively. Thus, since inclusion within a Neighborhood may be based on one or more elements within one or more Nodal (and/or user) Integrated Profile Sets that may be associated with a given Node (and or groups of Nodes), at least one element of such elements that may be factored into inclusion calculations may be based on and/or may be derived and/or may result from operations related to one or more elements in one or more relevant Normative Relational Sets. But since one or more elements within these Relational Sets may measures the “distance” (as described in the foregoing) of one or more elements of one or Nodal (and/or user) Integrated Profile Sets to one or more Neighborhood Meta-Profiles, it is possible that a Node may be included in and/or “bound to” a given Neighborhood with various “levels of strength”. Note, however, that one or more criteria that may be used to define these associations may be dynamic, and may change and/or may be modified at any time.

Thus, in the present example, Node 2 may be strongly associated with Neighborhood A, and less strongly associated with Neighborhood B. The strength of these associations may, in turn, become a factor in any and/or all of the operations related to information flow to and from that Node and/or in the manner such information may be presented, as described. But note that in other embodiments, one or more external factors may be used to “reinforce” and/or “strengthen” such bindings, and further, that such modifications may be temporary and/or may, in some cases, be germane to one or more transitory events and/or conditions.

In this manner, “taste”-related elements may be considered part of the Adaptive Layer of the Network and embodiments may reflect the “self-organization” of such these Neighborhoods and sub-nets. Note that any and/or all of the methods associated with derivation of Attribute Matrices may be applied to these embodiments including (but limited to) “chained” derivation of Data Objects used in conjunction with these methods (as described). Note further that Nodes may participate in Neighborhood-related functions regardless of the Mode (Standalone and/or Hybrid and/or Pure) and/or in any state of enablement (as described) and may be included in the Neighborhoods in any and/or all of these states and/or Modes variously and/or at any time. Finally, note that methods and/or Data Objects that may be associated with and/or which may be modified by any and/or all Neighborhood functions may exist at the Node-Specific and/or Node-Relational and/or the Network-Control Levels.

But note further that, as stated in the foregoing, the inclusion of Nodes in such Neighborhoods (and/or any/or all information-control processes and/or related Data Objects that may be used to calculate such inclusion) may be additionally and/or exclusively be controlled by factors other than those that may be derived from elements within Normative Relational Sets. One such factor may be user input, as mentioned in the foregoing, but other factors may be related to a requirement to address portions of Neighborhoods in a manner related to sub-netting within Neighborhoods (as described above) but wherein the criteria may be unrelated to and/or which may supercede and/or which may be adjunctive to and/or which may supplement the factors that may be used to create Relational-derived Neighborhoods. Thus, in some embodiments, Relational-derived Neighborhoods may be supplemented and/or replaced by non-Relational-derived Neighborhoods, and in some embodiments, Relational-derived Neighborhoods may not exist at all and/or may be disabled and/or partially enabled variously and at any time in response to any condition and/or in response to one or more events that may exist within the Network.

Note also that sub-nets and/or Neighborhoods, however they may be created and/or maintained and/or modified, may also, in some embodiments be inter-locked with and/or may be otherwise associated with “community-building” mechanisms and/or processes and/or activities that may be offered by other services. In such embodiments, one or more processes within the Network may instantiate such inter-operability, and any and/or all of the methods described herein may be included in such inter-operability.

In one example implementation, any or all of the activity related to “taste”-related functions may be monitored and/or recorded by one or more Nodes in the Network. Such records may be analyzed using commonly available techniques to determine ways in which methods and/or Data Objects (where such Objects may include one or more Integrated Profile Sets that may be associated with Nodes and/or with groups of Nodes) may be modified and/or conditioned and/or otherwise changed to optimize any and/or all the operations of the Network, including (but limited to) those cited herein (and those variations that may be obvious to those skilled in the art).

One example of such an embodiment may include one or more “Taste Servers” which may aggregate activity-related information within the Network and, based upon one or more processes that may analyze this information, may, as result of this analysis (and/or based on any other factors) dynamically re-configure one or more sub-nets and/or Neighborhoods, as described above, and/or may condition and/or influence and/or may modify and/or may augment information and/or may create additional information that may flow to and/or from and/or between such Nodes. Further, note, however, that in some embodiments, one or more processes associated with this functionality may be co-located with and/or may interoperate with one or more processes that may be instantiate in one or more Nodes within the Network.

Such aggregated activity-related information may be recorded and/or compiled and may be used by one or more processes to create reports and/or data which may be used as a factor to influence the flow of information within the Network and/or to and/or from and/or between Nodes.

Such embodiments may also create additional Data Objects and/or may modify and/or maintain such Objects in manner that is targets such Objects to flow to and/or from and/or between Nodes. These Data Objects may be called “Taste Channels” and may embed one or more “fields” that may be composed of information that may be dynamically assembled based on one or more Attribute Files and/or one or more Relational Matrices. In some case, however, some or all of the information that may be included within such “Taste Channels” may not be related to Attribute Files and/or to Relational Matrices.

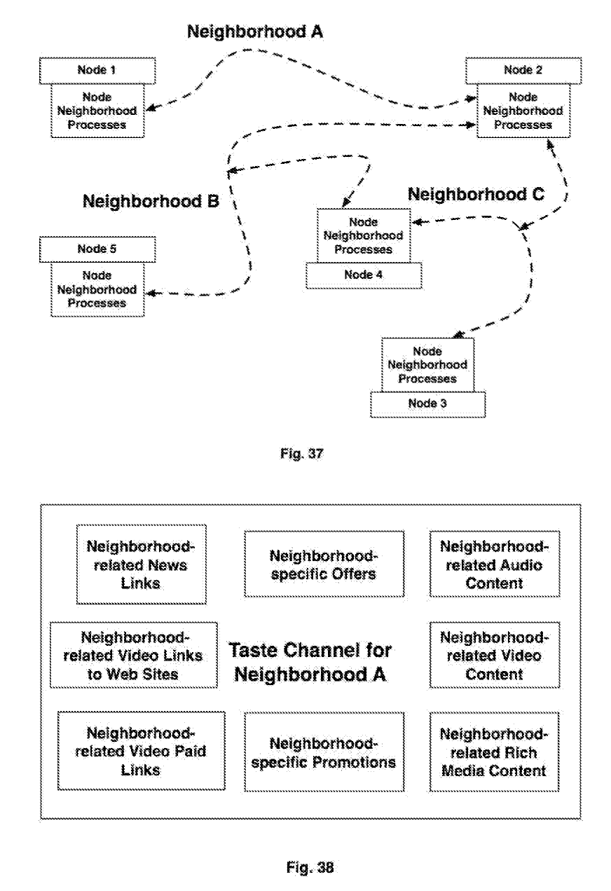

FIG. 38 shows one example of a “Taste Channel” created for Neighborhood A. Note that this is one example and that such Channels may embed and/or reference and/or may otherwise link and/or may be associated with any information and/or links to information and/or links to processes that may be instantiated within a Node and/or which may be instantiated either within and/or outside the Network.

The fields within a Channel may include any type of information, and may be represented in any format and may include Data Objects of any type including (but not limited to) word processing documents, HTML files, hyperlinks, RSS feeds, Powerpoint documents (and similar presentation documents that may include one or more information formats (including, but not limited to text, photographs, images, graphical representations and such items as may be typically included in such presentation documents), video (encoded by means of any number of processes and into any format such as MPEG2, MPEG4, .avi, QuickTime, WMV, Real and so on), audio (encoded by means of any number of processes and into any format including MP3, AAC, WMA, OGG and so on), graphical representations (such as, but not limited to, GIFs, Graffles and so on), software executables (including but limited to consumer and professional computer programs, computer games).

Thus, in one embodiment one or more Taste Servers may create such Channels and these Channels may be instantiated as Data Objects and may have one or more Attribute Files and/or one or more Relational Matrices associated with them, as above. Such Channels and/or the associated Attribute Files and/or Relational Matrices may be created and/or maintained and/or modified and/or otherwise changed by processes that may be subsumed in a “Taste Channel Builder”.

In some embodiments, one or more of the processes that compose a “Taste Channel Builder” may be instantiated in any Node such that one or more associated processes may be made available to individual users such that Network participants may create and/or maintain and/or modify and/or otherwise change such objects.

In some embodiments of the “Taste Channel Builder”, one or more of the constituent processes may reside at one or more Taste Servers. In some of these implementations, Channels and/or the embedded information (as above) within Channels and/or Channel-affiliated Data Objects (such as might include (but may not be limited to) one or more Attribute Files and/or one or more Relational Matrices) may be managed by processes that may monitor and/or record and/or compile Network and/or Node-Relational and/or Node-Specific activities.

Thus, in one example implementation, a Taste Channel Builder may be linked to activity that monitors how Nodes within the Network respond to specific elements included in one or more Channels. Such linkage may also include a “feedback” loop associated with processes that may change and/or otherwise modify and/or augment and/or delete and/or enhance and/or re-format any and/or all “fields” within a Channel and/or Channel-affiliated Data Objects (such as might include one or more Attribute Files and/or one or more Relational Matrices). Moreover, some such embodiments of a Taste Server may change and/or modify and/or augment and/or delete and/or enhance and/or re-format any and/or all of the Neighborhood Meta-Attribute Files and/or Relational Matrices and/or criteria that may be used in Neighborhood and/or sub-netting processes.

In some implementations, a node within the Network may connect to one or more mobile and/or portable devices and may, by virtue of processes that exist within one or more Nodes within the Network, may extend any and/or all of the capabilities within the Network to those devices. Thus, for example, some or all of the elements and/or functionality that may compose an embodiment of the NRM system within the Network (as previously described) may be extended to mobile and/or portable devices to control the disposition of Data Objects (such as music and video) by means of one or more control documents associated with those Objects.

One such function may allow a user to remotely connect to one or more Nodes from a mobile device that supports communication with such a Node (as through a wireless Internet connection, for example) such that this user may access Data Objects within the Network. In one example, the user may wish to stream audio and/or video Objects to that mobile device, and/or otherwise may engage in other activities related to those Objects. To the degree that such activities may be subject to terms of use (wherein such control may be embedded in one or more service-provided control documents and/or one or more supplemental control documents, (as described in the foregoing), these Objects may be made accessible to the user.

In this sense, as illustrated in the present example, the mobile and/or portable device may be considered a partially-enabled Node in that it may embed one or more Network-based processes. Thus, in some embodiments, one or more mobile and/or portable devices may connect to one or more Nodes in the Network where such connection may through any means (wired and/or wireless) through any hardware mechanisms (such as IEEE 1394 or USB) and through any connection protocol (such as IP), and by virtue of this connection and by virtue of one or more processes that may reside on such devices, the devices may be considered Nodes within the Network

In another example implementation, a user may connect to the Network, as above, by means of a portable and/or mobile device, and may, if the device embeds an FM radio, initiate a process that may reside on the device that “marks” one or more track. Based on this “marking, the user may connect to the Network and may request that other songs with Attribute Matrices similar to that of the “marked” song(s) be downloaded to one or more Nodes for later consumption. In another example, the user may request that one or more songs with Attribute Matrices similar to that of the “marked” song(s) be streamed to that device. In another example of such interconnection, the user may request that one or more elements of their Integrated Profile Set be routed to a service (that may be partially enabled with the ability to interpret such elements of such Sets) to recommend appropriate destinations based on that the information within that profile. Thus, in this example, a user may, from a portable and/or mobile device, request the location of music clubs that feature entertainment consistent with one or more elements of their Profile.

In this sense, suitably enabled mobile and/or portable devices may be viewed as specialized Nodes in that, by virtue of features unique to that hardware—such as, for example, being portable—may supplement those inherent features and/or characteristics with one or more processes within the Network.

It will be appreciated that the methods and procedures described above may be realized in hardware, software, or any combination of these suitable for the networking, content distribution and information management techniques described herein. The processes may be realized in one or more microprocessors, microcontrollers, embedded microcontrollers, programmable digital signal processors or other programmable device, along with internal and/or external memory. The processes may also, or instead, include an application specific integrated circuit, a programmable gate array, programmable array logic, or any other device that may be configured to process electronic signals. It will further be appreciated that the processes may be realized as computer executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. At the same time, processing may be distributed across Nodes and other devices in a number of ways, or all of the functionality may be integrated into a single device. All such permutations and combinations are intended to fall within the scope of the present disclosure.

While the invention has been disclosed in connection with certain preferred embodiments, other embodiments will be recognized by those of ordinary skill in the art, and all such variations, modifications, and substitutions are intended to fall within the scope of this disclosure. Thus, the invention is to be understood with reference to the following claims, which are to be interpreted in the broadest sense allowable by law.

What is claimed is:

1. A system comprising:
a plurality of clients interconnected in a peer-to-peer network;
a plurality of files distributed among the plurality of clients, each file including one or more trading rules, an encrypted version of an audio segment, and a degraded quality, unencrypted version of the audio segment; and
a server coordinating operation of the peer-to-peer network, the server responding to a purchase request for a selected audio segment from one of the clients by analyzing the one or more trading rules associated with the selected audio segment, determining a payment, processing the payment from the one of the clients, and providing a certificate to the one of the clients for rendering the selected audio segment.

2. The system of claim 1 wherein the trading rules for each file specify a duration of use of the associated audio segment, the certificate limiting rendering of the audio segment to the duration.

3. A method, comprising:
providing a peer-to-peer media content user interface wherein a user may search for media content associated with a peer-to-peer network; and
presenting, in the same peer-to-peer media content user interface, results retrieved from an Internet search engine, wherein the Internet search engine results are based on the user's interactions with the peer-to-peer media content user interface.

4. A system comprising:
a data network interconnecting a plurality of nodes, at least two of the plurality of nodes including a client device operated by a user having a profile;
a content library including a plurality of files, the content library residing on one or more of the nodes, the plurality of files including one or more of a sampler file comprising one or more trading rules, an encrypted version of a first audio segment, and a degraded quality, unencrypted version of the first audio segment, a purchase-only track comprising an encrypted version of a second audio segment and a free sample of the second audio segment, a try-before-you buy sampler file, a Sampler file, a limited functionality file, a degraded quality file, a file having an associated transactional rule, and a media file;
a classification scheme derived from at least one of a functional characteristic, an audio characteristic, a visual characteristic, and an objective characteristic of each one of the plurality of files, or from a knowledge representation scheme;
a subnetting infrastructure supported by at least one server coupled to the data network for addressing a subset of the plurality of nodes as a neighborhood, each neighborhood including a plurality of the client devices, and each neighborhood characterized by a metaprofile of the plurality of client devices;
a taste infrastructure supported by at least one server coupled to the data network for interrelating one or more of metaprofiles, profiles, and files according to one or more of the classification scheme, attributes of content of the files, user file consumption patterns, user searches, user file acquisition, user membership in neighborhoods, and explicit user input;
a search infrastructure supported by at least one server coupled to the data network for providing at least one search result in response to a search request from one of the client devices, the search infrastructure supporting at least one of a peer search, a web search, and an explore mode, the peer search initiating a local search at one or more of the plurality of nodes according to one or more attributes of audio content including at least one of a musical feature setting, an editorial setting, and a seed track of audio content for comparison to local content using the taste infrastructure, and the web search forwarding one or more search parameters to a search service that augments data in the search request and returns the search request to the client in a form for presentation to one or more commercial search engines, the explore mode for locating one or more additional files according to a peer search seeded with the at least one result; and
a rights management infrastructure supported by at least one server coupled to the data network, the rights management infrastructure providing one or more of a certificate system for controlling rendering of one or more of the plurality of files including decryption of encrypted content, a rights management integration system for providing additional rights management functions to one or more third-party rights management systems that deliver files through the rights management infrastructure; a fingerprinting technology for providing unique fingerprints for one or more of the plurality of files according to one or more characteristics of the files and for identifying files according to a fingerprint associated therewith, a payment system for executing financial transactions associated with access to one or more of the files, a customer tracking system for tracking consumption behavior of the one or more client devices, and a network activity monitoring system for monitoring one or more of acquisition of files, use of files, and search for files.

5. The system of claim 4 wherein the data network includes a media network for communicating content.

6. The system of claim 4 wherein the data network includes a mobile network for communicating.

7. The system of claim 4 wherein the plurality of nodes include at least one mobile device.

8. The system of claim 4 wherein the data network includes a peer-to-peer network.

9. The system of claim 4 wherein each node can operate in one or more of a peer-to-peer mode in which it interacts with other like enabled modes, a hybrid mode in which it interacts with other nodes that are at least one of partially enabled and disabled, and a stand-alone mode in which the node is disconnected from other nodes.

10. The system of claim 4 wherein each node can operate in one or more of a node-specific mode related exclusively to that node, a node-relational mode related to at least one other one of the nodes, and a network control mode in which the node operates in a client-server relationship with at least one other one of the nodes.

11. The system of claim 4 wherein the plurality of nodes are self-organizing according to at least one of the taste infrastructure and the classification scheme.

12. The system of claim 4 wherein the subnetting infrastructure dynamically restructures the neighborhoods.

13. The system of claim 4 wherein the nodes adapt behavior according to one or more of user profiles and metaprofiles.

14. The system of claim 4 wherein each node operates in one or more of an enabled mode, a disabled mode, a non-enabled mode, and a partially enabled mode.

15. The system of claim 4 wherein one or more nodes operates to attract one or more of the plurality of files according to at least one of the subnetting infrastructure and the taste infrastructure.

16. The system of claim 4 wherein one of the plurality of nodes communicates with one or more other ones of the plurality of nodes through one or more of a fixed layer and an adaptive layer, the adaptive layer including a process that is modified according to one or more of the taste infrastructure or the subnetting infrastructure.

17. The system of claim 4 wherein the explore mode is automatically invoked in response to one or more of playing a content object, viewing a content object, entering a query, searching a library of content objects, viewing a playlist of content objects, and viewing a set of search results.

18. The system of claim 4 wherein the rights management infrastructure provides a redirected download function wherein the infrastructure responds to a download request from a first one of the plurality of nodes for a track with no control documents by transferring the track to a second one of the plurality of nodes, fingerprinting the track, deriving one or more control documents for the track, and providing the one or more control documents to the first one of the plurality of nodes.

19. The system of claim 18 wherein the first one of the plurality of nodes uses the one or more control documents to obtain a local copy of the track.

20. The system of claim 4 wherein the rights management infrastructure provides an http redirect function wherein the infrastructure responds to a download request for a track from one of the plurality of nodes by redirecting the download request to a related file.
